(19) United States
(12) Patent Application Publication
(10) Pub. No.: US 2026/0160674 A1
(43) Pub. Date: Jun. 11, 2026

(54) Handheld Spectrometer and Neural Network Model for Chemical and Biological Point Detection

(71) Applicant: Forward Edge-Al, Inc., San Antonio, TX (US)

(72) Inventors: Eric Adolphe, San Antonio, TX (US); Jonathan McGraw, Ocean Shores, WA (US); Thomas Summe, South Bend, IN (US); Joey Bosarge, Saint Johns, FL (US)

(21) Appl. No.: 19/400,671

(22) Filed: Nov. 25, 2025

Related U.S. Application Data
(60) Provisional application No. 63/728,896, filed on Dec. 6, 2024.

(51) Int. Cl. G01N 21/25; G01N 21/31

(52) U.S. Cl. CPC G01N 21/255; G01N 21/31; G01N 2201/0221; G01N 2201/125

(57) ABSTRACT

A handheld spectrometer apparatus and system for testing and characterizing samples. The spectrometer is connected to a mobile computing device and can be used to perform chemical analyses in the field. In one example, the spectrometer includes an optical system with a dichroic beamsplitter and a collection lens. The collection lens can be oriented along a first axis, and the dichroic beamsplitter oriented along a second axis that is at a 45-degree angle relative to the first axis. A photoreceptor of the spectrometer can capture image data as light passes through the optical system. The image data can be passed to a deep neural network (DNN) model on the mobile computing device that is trained to detect and quantify one or more contaminants.

### TECHNICAL FIELD

The present disclosure relates to a handheld spectrometer apparatus for performing chemical analyses in the field. In particular, the disclosure relates to a portable spectrometer apparatus that is connected to a mobile computing device to characterize chemicals and detect contaminants.

### BACKGROUND

There are many factors contributing to fuel contamination. Hydraulic and Polyalphaolefin (PAO) fluids are two of the most prevalent and costly contaminants. Specifically, hydraulic and PAO fluid contamination requires defueling of the aircraft, a 30-45-day loss of mission-critical assets, and over 80 man-hours per contaminated fuel incident. Failure to detect contamination can result in Class A mishaps, fouling of small moving aircraft engine parts, excessive deposits/gums on aircraft engine components, reduced service life, and increased sustainment costs. Additionally, defuel carts cost $81,000 per unit, and collection and testing systems range from $80 to $450, with lab tests ranging from $300 to $3,200. Thus, within the U.S. Air Force, defueling high performance jets or other assets is significantly more complex and costly. Within the commercial sector, biofuels, or Sustainable Aviation Fuel (SAF) may introduce new and unknown contaminants including microbes and fungi that my impact aircraft performance. Reducing sustainment costs of aircraft and other fuel-powered equipment offers several operational benefits. For example, lower sustainment costs enhance the affordability of aircraft fleets, allowing for broader deployment and extended service life, which are crucial for maintaining air superiority, while also increasing aircraft availability and mission readiness. Yet there are no existing analytical instruments to detect and quantify the level of contamination in a field setting.

It can thereby be appreciated that a capability to detect and quantify contaminants in jet fuel, as well as other samples, would meet a critical need in the industry. Beyond aircraft, such a capability offers advantages in any remote or limited environment (e.g., medical examination rooms, hospitals, in the field, etc. to detect, classify, and quantify microbes, etc.).

There is a need in the art for a system and method that addresses the shortcomings discussed above.

### SUMMARY

In one aspect, a man-portable apparatus for identification of compounds is disclosed. The apparatus can include: (a) a housing including a first compartment and a second compartment; (b) a light source that directs light into the first compartment; and (c) an optical system including a dichroic beamsplitter and a collection lens, wherein the collection lens is oriented along a first axis, and the dichroic beamsplitter is oriented along a second axis that is at a 45-degree angle relative to the first axis.

In another aspect, a method of detecting contaminants in a chemical sample is disclosed. The method includes a first step of sending, from a chemical analysis application (“app”) installed on a mobile computing device, a control signal to a handheld spectrometer apparatus connected to the mobile computing device that causes the spectrometer apparatus to perform a first test cycle involving a first sample. A second step includes receiving, at the app and from the spectrometer apparatus, first image data captured by a photoreceptor of the spectrometer apparatus, the first image data including spectral data for the first sample. In a third step, the method includes passing the first image data to a deep neural network (DNN) model that is trained to detect and quantify, in spectral data, one or more contaminants of a plurality of potential contaminants. In different embodiments, these potential contaminants can include Polyalphaolefin (PAO), sulfur compound(s), synthetic fuel additive(s), hydraulic fluid(s), and microbial compound(s). A fourth step includes determining, via the DNN model and based on the first image data, the first sample includes a first contaminant, and a fifth step includes presenting, via a graphical user interface (GUI) for the app, a notification indicating the first sample includes the first contaminant.

In yet another aspect, embodiments include a system for detecting contaminants in a chemical sample that includes a processor and machine-readable media including instructions which, when executed by the processor, cause the processor to: (1) send, from a chemical analysis application (“app”) installed on a mobile computing device, a control signal to a handheld spectrometer apparatus connected to the mobile computing device that causes the spectrometer apparatus to perform a first test cycle involving a first sample; (2) receive, at the app and from the spectrometer apparatus, first image data captured by a photoreceptor of the spectrometer apparatus, the first image data including spectral data for the first sample; (3) pass the first image data to a deep neural network (DNN) model that is trained to detect and quantify, in spectral data, one or more contaminants of a plurality of potential contaminants that include Polyalphaolefin (PAO), sulfur compound(s), synthetic fuel additive(s), hydraulic fluid(s), and microbial compound(s); (4) determine, via the DNN model and based on the first image data, the first sample includes a first contaminant; and (5) present, via a graphical user interface (GUI) for the app, a notification indicating the first sample includes the first contaminant.

Other systems, methods, features, and advantages of the embodiments will be, or will become, apparent to one of ordinary skill in the art upon examination of the following figures and detailed description. It is intended that all such additional systems, methods, features, and advantages be included within this description and this summary, be within the scope of the embodiments, and be protected by the following claims.

### BRIEF DESCRIPTION OF THE DRAWINGS

The embodiments can be better understood with reference to the following drawings and description. The components in the figures are not necessarily to scale, emphasis instead being placed upon illustrating the principles of the embodiments. Moreover, in the figures, like reference numerals designate corresponding parts throughout the different views.

FIG. 1 is a schematic view of a man-portable container in which a chemical analyses kit is stored, the kit including at least a handheld spectrometer apparatus, a mobile computing device, vial(s), and microfluidic slide(s), according to an embodiment;

FIG. 2 is a schematic view of the spectrometer apparatus, mobile computing device, vial, and slides removed from the container, according to an embodiment;

FIG. 3 is a schematic view of the spectrometer apparatus connected to the mobile computing device, according to an embodiment;

FIG. 4 is a schematic view of a vial inserted into a receptacle provided for receiving samples formed in the spectrometer apparatus, according to an embodiment;

FIG. 5 is a schematic view of a microfluidic slide prepared for insertion into a slot provided in the spectrometer apparatus, according to an embodiment;

FIG. 6 shows a magnified view of the microfluidic slide, according to an embodiment;

FIGS. 7A and 7B show a sequence depicting the microfluidic slide as it is inserted into the slot, according to an embodiment;

FIG. 8A is a schematic view of an alternate embodiment of a handheld spectrometer apparatus, according to an embodiment;

FIG. 8B is a schematic view of a sample placed adjacent to a collection lens of the spectrometer apparatus, according to an embodiment;

FIG. 9 is a schematic perspective view of components of the spectrometer apparatus, according to an embodiment;

FIG. 10 is a top-down schematic flow diagram of the pathway of light traveling through the spectrometer apparatus when a test cycle is initiated, according to an embodiment;

FIG. 11 is a schematic view of another embodiment of a handheld spectrometer apparatus, according to an embodiment;

FIG. 12 is a schematic view of a modular sample holder being connected to the spectrometer apparatus and a vial with a sample being inserted into its receptacle, according to an embodiment;

FIG. 13 shows an example scenario of a test cycle using a spectrometer apparatus and a chemical analysis app installed on the mobile computing device, according to an embodiment;

FIGS. 14-18 present a set of graphical user interfaces (GUIs) that can be provided by the chemical analysis app, according to an embodiment;

FIG. 19 is a schematic diagram depicting an example of a federated learning system for use with the proposed spectrometer apparatuses and neural network models, according to an embodiment;

FIG. 20A illustrates another, alternate embodiment of a spectrometer apparatus that includes an on-axis dispersion unit comprising a plurality of metasurfaces, according to an embodiment;

FIG. 20B illustrates the spectrometer apparatus of FIG. 20A without its outer housing, according to an embodiment;

FIG. 21 is a perspective view of the spectrometer device introduced in FIGS. 20A and 20B where a portion of the chassis has been removed, according to an embodiment;

FIG. 22 is a perspective view of the inner components installed in the chassis forming an assembly, according to an embodiment;

FIG. 23A is a view of the assembly from a first end, FIG. 23B is a view of the assembly from a second end, and FIG. 23C depicts a view of the assembly from a top-down view and a side view, according to an embodiment;

FIG. 24A presents an isolated view of the optical compartment and metasurfaces, and FIG. 24B presents additional detail of a first metasurface, according to an embodiment;

FIGS. 25A and 25B are a schematic diagram illustrating a process by which speckle patterns can be generated, according to an embodiment;

FIG. 26 depicts, in isolation, a plurality of frames with their respective plurality of lenses, according to an embodiment;

FIG. 27 shows a schematic view of a first plurality of modules that can be installed or secured into the chassis, where each module includes two discrete pieces, according to an embodiment;

FIG. 28 shows a schematic view of a second plurality of modules that can be installed or secured into the chassis, where each module is made of a single, continuous material (monolithic), according to an embodiment;

FIG. 29 shows an example of an assembly in which the second plurality of modules have been installed, according to an embodiment;

FIG. 30 presents some use-cases in which the spectrometer can be deployed, according to an embodiment;

FIG. 31 is a flow chart depicting a process of detecting contaminants in a chemical sample, according to an embodiment; and

FIG. 32 is a flow chart depicting a process for refining a global neural network model for performing chemical analyses of spectral data, according to an embodiment.

### DETAILED DESCRIPTION

In different embodiments, the apparatus described herein provides a spectrometer instrument capable of detection and quantification of chemical contaminants in test samples while in remote, limited environments (e.g., in situ, on site, at the location, at a bar, in a medical examination room, in a hospital, etc.). The instrument is a low-cost and robust yet highly sensitive device that is configured to function as a smartphone-based accessory (“dongle”). An Artificial Intelligence (AI) neural network can receive and analyze the data captured by the instrument and generate, in the field, results, simulations, and predictions pertaining to the sample. These tests can be performed in the field in mere minutes.

As will be described in greater detail below, this durable, low-cost, man-portable (can be readily carried by a single person without assistance) and handheld (designed to be operated while held in a human hand) spectrometer apparatus for use with mobile computing devices offers a significant shift forward in monitoring and protecting assets from the effects of fuel or other contamination. In addition, the spectrometer apparatus can be understood to be “field portable”. For purposes of this application, field portable refers to a handheld device or instrument that is designed to be easily transported and used in outdoor or on-site environments, like a field, factory, airplane hangar, etc., allowing for analysis of samples directly where they are collected, rather than needing to be taken back to a laboratory. The proposed devices and systems are compact, battery-powered, and rugged enough to withstand harsh conditions.

Furthermore, in different embodiments, the proposed systems and methods incorporate processing and analysis based on a trained Deep Neural Network (DNN) to classify different levels of fuel or other types of contamination with high accuracy, often at a rate greater than 0.125%, as well as a high degree of sensitivity and specificity of microbial detection. Furthermore, as will be discussed below, the system employs a powerful Federated Learning (FL) platform and specifically addresses and overcomes challenges such as user data privacy, management of deep neural network (DNN) model updates, and performing calibrations (e.g., using a Mercury-Argon laser) due to the strong, isolated peaks in spectra within the mobile apparatus.

Spectroscopy is an analytical technique that studies the interaction between electromagnetic radiation and matter. The interactions give rise to electronic excitations, molecular vibrations or nuclear spin orientations, which can then be analyzed with different spectroscopic instrumentation. There are numerous spectroscopy techniques available, including mass, infrared, near infrared (NIR), Raman, gas chromatography (GC), Fourier-Transform Infrared (FTIR), nuclear magnetic resonance (NMR), ultraviolet (UV), and visible spectroscopy.

Traditional GC remains a gold standard in laboratory settings due to its precision in separating complex hydrocarbon mixtures. However, its field deployment is impractical due to the size of the equipment, extended sample preparation times, and the need for controlled environmental conditions. Conventional GC instruments, for example, offer high sensitivity, but are unsuitable for real-time, on-site applications where rapid results are necessary. Furthermore, conventional liquid chromatography methods such as Gel Permeation Chromatography (GPC) have been explored, but their reliance on UV detectors and requirement for consumable solvents make them less feasible for real-world logistics. Other portable solutions have shown promise for field analysis, but still face challenges related to accuracy, sensitivity, and operational complexity when applied to dynamic fuel testing scenarios.

In addition, NIR spectroscopy, which has been investigated for fuel property analysis, struggles with overlapping absorption bands, making it difficult to distinguish specific fuel components. Similarly, FTIR spectroscopy experiences interference from atmospheric water vapor and carbon dioxide, significantly limiting its effectiveness in outdoor field settings. Traditional distillation-based methods, while reliable in laboratory applications, are unsuitable for rapid field deployment due to their time-intensive processes and large equipment footprint. Furthermore, mass spectrometry relies on a large and very expensive instrument that is not suitable for field use.

As such, Raman spectroscopy is usually preferred for examination of subjects in the field. In general, Raman spectroscopy and infrared (IR) spectroscopy are both techniques that allow for the investigation of bonds within molecules, or vibrational spectroscopy. These techniques provide information not only about molecules through the identification of functional groups and spectral analysis of so-called “fingerprints”, but also allow for the qualitative and quantitative analyses of chemical substances in the sample.

While IR works with the infrared region of the electromagnetic spectrum, measuring how much light is absorbed by the bonds of a vibrating molecule, Raman spectroscopy works by the detection of inelastic scattering, also known as Raman scattering, of monochromatic light from a laser, usually in visible, near infrared or near ultraviolet range. To make a transition Raman active, the polarizability of the molecule during the vibration and the electron cloud of the molecule must change positionally. For an IR detectable transition, the molecule must have a dipole moment change during vibration. The spectra also differ, with IR showing irregular absorbance lines and Raman showing a scattered Rayleigh line and the Stoke/anti-Stoke lines.

In general, with IR, the detector compares the frequencies of light entering the sample with the frequencies of light leaving the sample. The ‘missing’ frequencies correspond to energy absorption by the molecule (or by bonds in the molecule), allowing for identification of the presence of specific chemical entities. On the other hand, Raman spectroscopy typically uses a laser in the near-IR (NIR) or visible region of the electromagnetic spectrum that emits a specific single wavelength of light. Rather than being based on radiation absorbance, Raman spectroscopy is based upon radiation scattering (in this case, light). When light hits the molecule, or a bond in the molecule, it is scattered, which changes the light's energy. The difference in the energy of the light entering the sample and the energy of the light leaving the sample can be measured, giving a ‘Raman shift’. The Raman shift depends upon the frequency of natural vibrations within the bond or molecule, with the frequency of vibration affected by the mass of a molecule or atom (when considering a bond).

The interaction of light with a bond can also be affected by the polarizability of the electron cloud. If a bond in a molecule has a large, diffuse, electron cloud it will scatter radiation more readily, giving a stronger signal. The scattered light is then collected at a detector, and the frequency difference between the incoming light and scattered light determined.

When a transparent (or substantially transparent) liquid, gas, or crystal sample is illuminated with a beam of monochromatic light (e.g., wavenumber zero), most of the incident light is transmitted without change, while a small portion of it is scattered within the whole solid angle. Spectral analysis of the scattered light shows that, in addition to scattering without change of wavenumber of the incident light (“Rayleigh scattering”), it further contains discrete components of altered wavenumber.

In general, there are pairs of new lines appearing in the spectrum at wavelengths positioned symmetrically with respect to the excitation wavelength, where the wavenumbers correspond to transitions between rotational or vibrational energy levels of molecular systems. The appearance of altered frequencies (wavenumbers) in scattered light is called the Raman effect or Raman scattering. While Raman scattering in itself is a relatively weak effect, it is always accompanied with Rayleigh scattering with an intensity usually 3-5 orders of magnitude greater. The new components appearing in the spectrum of the scattered radiation at shifted wavelengths are termed Raman lines or Raman bands, and collectively they are referred to as the Raman spectrum. The Raman bands at wavelengths less than the exciting wavelength are referred to as anti-Stokes lines, whereas those appearing at higher wavelengths as Stokes lines.

In different embodiments, the proposed system can be employed to perform Raman Spectroscopy and GC molecular identification testing in the field, allowing for non-destructive, rapid spectral analysis of fuel or other bio-chemical samples. The proposed instrument's ability to detect molecular vibrations will enable the identification of chemical contaminants, such as but not limited to sulfur compounds, synthetic fuel additives, and water contamination, with high specificity. Raman spectroscopy's speed and minimal sample preparation requirements make it ideal for field-based fuel screening, offering real-time qualitative assessments before further in-depth analysis. To further enhance sensitivity, the system incorporates specialized microfluidic chips configured to amplify weak Raman signals, enabling the detection of trace-level contaminants.

In some embodiments, complementing Raman Spectroscopy, GC testing can serve as a quantitative validation mechanism, allowing for hydrocarbon separation and precise fuel composition analysis. A free induction decay (FID) can also be integrated to provide sensitive and accurate quantification of volatile organic compounds and fuel stability indicators. While GC traditionally requires extended processing times, optimizations in sample preparation and injection efficiency will be implemented to enable faster turnaround times suitable for field deployment.

In different embodiments, to enhance the integration of Raman and GC data, Continuous Wavelet Transform (CWT) signal processing can be employed to refine spectral and chromatographic outputs. CWT can perform a critical role in reducing environmental noise, improving spectral resolution, and detecting transient anomalies within fuel samples. By fusing Raman spectral data with GC chromatograms, CWT can create a multi-dimensional analytical profile, significantly improving the system's capability to detect fuel degradation, contamination events, and deviations from performance specifications.

Furthermore, in different embodiments, the sensor fusion framework described herein can be powered by AI-driven ML models, and trained on combined Raman-GC-CWT datasets to enhance predictive accuracy. These models can be used to correlate spectral and chromatographic features with critical fuel properties, such as but not limited to cetane index, sulfur content, viscosity, and flash point, ensuring a comprehensive and data-driven approach to fuel quality assessment. The fusion of Raman and GC data will enable the system to detect anomalies that might otherwise go unnoticed if a single analytical method were used in isolation.

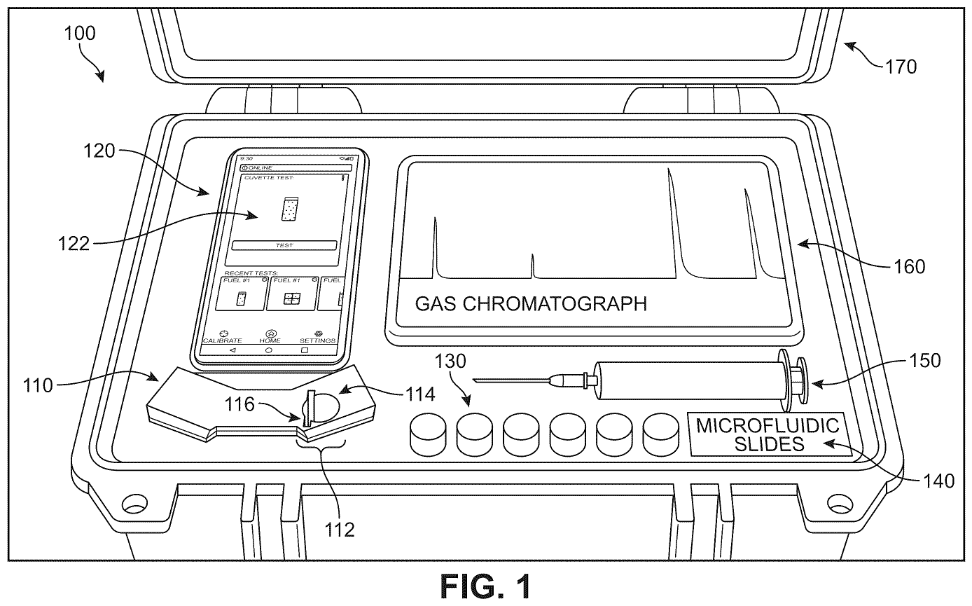

Details regarding an embodiment of a mobile spectrometer system are now discussed, with reference to FIGS. 1-7. Referring to FIG. 1, an embodiment of a spectrometer kit of parts (“kit”) 100 is illustrated, disposed in a man-portable storage container (“container”) 170 for easy transport. The kit 100 can include one or more hardware components and/or devices, as well as software algorithms to provide a unified field portable bio-chemical (e.g., fuel and propellant) real-time analysis system. In this example, the kit 100 includes a first spectrometer apparatus (“first spectrometer”) 110 with a substantially compact and ruggedized form factor optimized for field deployment. In one example, the hardware is configured to meet or exceed MIL-STD-810 standards, ensuring functional integrity under extreme environmental conditions, such as high vibration, temperature shifts, and humidity. This durability will support long-term field applications while minimizing maintenance requirements. Furthermore, its compact and ergonomic design will facilitate deployment in diverse operational settings without compromising analytical performance.

In different embodiments, the kit 100 further includes one or more sample bottles, cuvettes, or vials (“vials”) 130, one or more microfluidic chip slides (“slides”) 140, and optionally a sample syringe 150 and a miniature GC module 160 incorporating micro-FID (e.g., to measure hydrocarbon profiles). In some embodiments, the first spectrometer 110 can include a sample insertion receptacle (“slot”) 112. In some embodiments, the receptacle 112 can be sized and dimensioned to receive a sample held in one of the vials 130, and/or can be sized and dimensioned to receive a sample based on one of the slides 140. In the examples illustrated in the drawings, the receptacle 112 is configured with two adjacent receiving chambers in fluid communication with one another, including a first test chamber 114 sized and configured to receive a substantially cylindrical vial, and a second test chamber 116 sized and configured as a slot to receive a substantially elongated and planar slide. Thus, the opening for the first test chamber 114 can be substantially round and include a cylindrical three-dimensional shape extending through a depth of the holder, while the opening for the second test chamber 116 can be substantially slit-shaped, each opening supporting a snug, secure fit for their respective sample holders. In other embodiments, the first spectrometer 110 can include two separate receptacles configured to receive each type of sample holder, rather than one receptacle with two merged chambers depicted in FIG. 1.

In some embodiments, the kit 100 can further include a mobile computing device (“mobile device”) 120 such as a standard smartphone that can be connected to the first spectrometer 110 (e.g., via a USB or micro-USB cable). In other words, the spectrometers described herein can be configured as a phone accessory or phone-compatible dongle. In some embodiments, the mobile device 120 includes a spectral device manager and analysis app (“app”) 122 configured to communicate with the first spectrometer 110 and perform sensor fusion analysis and feature extraction to detect (for example) contaminants such as sulfur compounds, and/or synthetic fuel additives, as well as instances where water is present by its effect on another chemical in the sample. In some embodiments, the app's chemometric algorithms can then correlate these features with key fuel properties such as cetane index, sulfur content, viscosity, and flash point, for example to ensure compliance with DoD and ASTM fuel standards. In different embodiments, the app 122 can provide a user interface (UI) that can present user-friendly features generated by an onboard AI-powered recommendation engine, guiding operators through the analysis workflow while highlighting potential contaminants and/or deviations from regulatory standards.

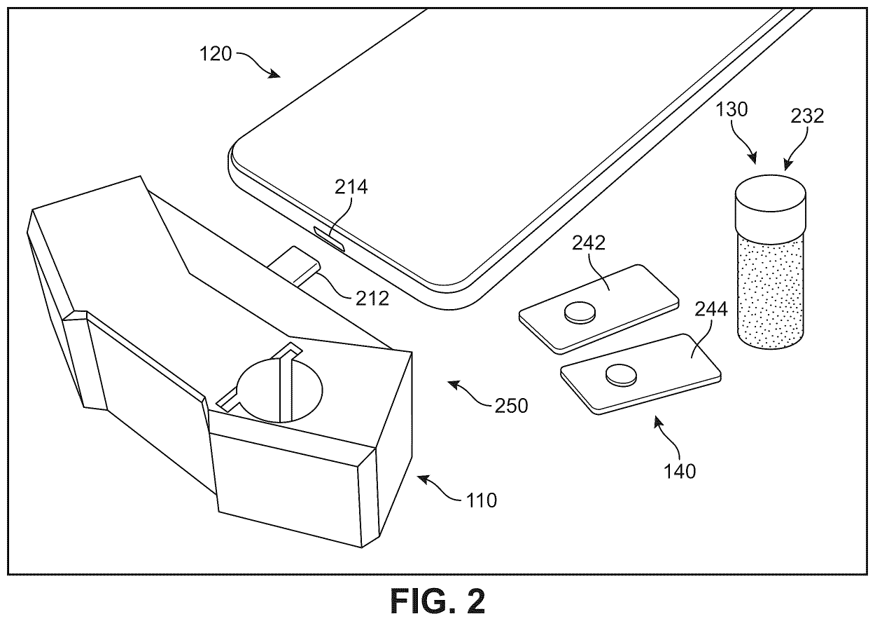

Moving to FIG. 2, some of the parts of kit 100 are shown outside of or removed from container 170, including mobile device 120, first spectrometer 110, a first vial 232 of vials 130, and a first slide 242 and a second slide 244 of slides 140. At this time, the first spectrometer 110 is in its disengaged configuration 250, not yet connected to a computing device. It can be observed that the spectrometer includes a forward-facing peripheral side along with a protruding (e.g., male prong/pin) connector element(s) 212. The connector element(s) 212 can be configured to slide into or otherwise be received snugly by a (e.g., female receptacle/socket) corresponding connector port 214 provided on the mobile device 120 (e.g., a standard device data / power transfer port).

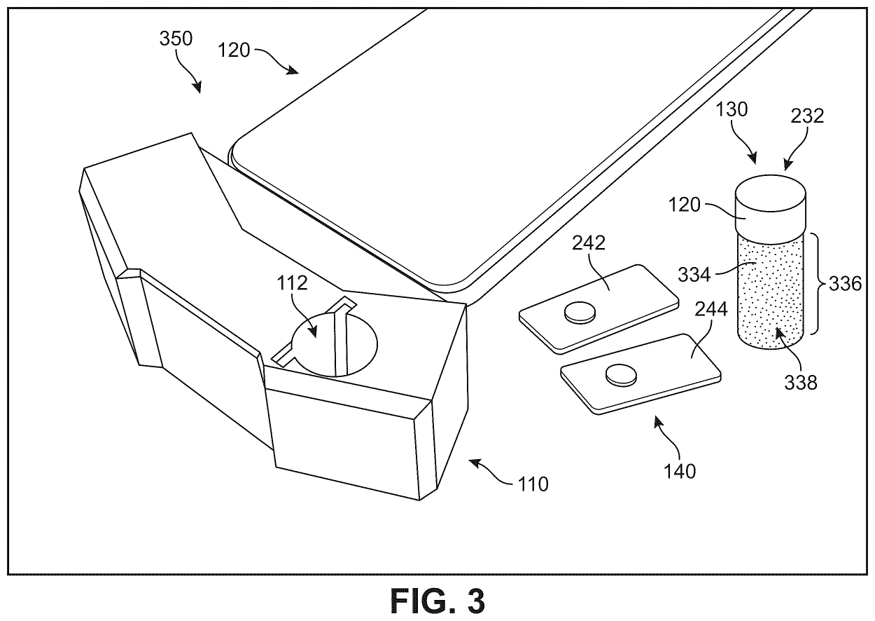

As shown in FIG. 3, in different embodiments, the first spectrometer 110 can be connected to or mounted on a mobile computing device such as a smartphone (e.g., Apple iPhone® or iPad®, phones or tablets employing Android®, etc.), in its engaged configuration 350, which serves to convert or augment the smartphone's capabilities with the tools needed to perform spectroscopy. Once the two components are attached to or connected to one another, a mobile spectroscopy scanner system (“scanner”) becomes available for use. In FIG. 3, the pre-prepared first vial 232 can be understood to contain a first sample 338 for analysis, held within an interior translucent or transparent body portion 334 (e.g., or other material through which light can pass), that can be optionally secured or sealed closed with a cap, stopper, or lid portion 332 on its open end. For purposes of reference, the body portion 334 can be seen to have a first length 336. First sample 338 can comprise of a solid, liquid, gas, or any other substance or chemical compound.

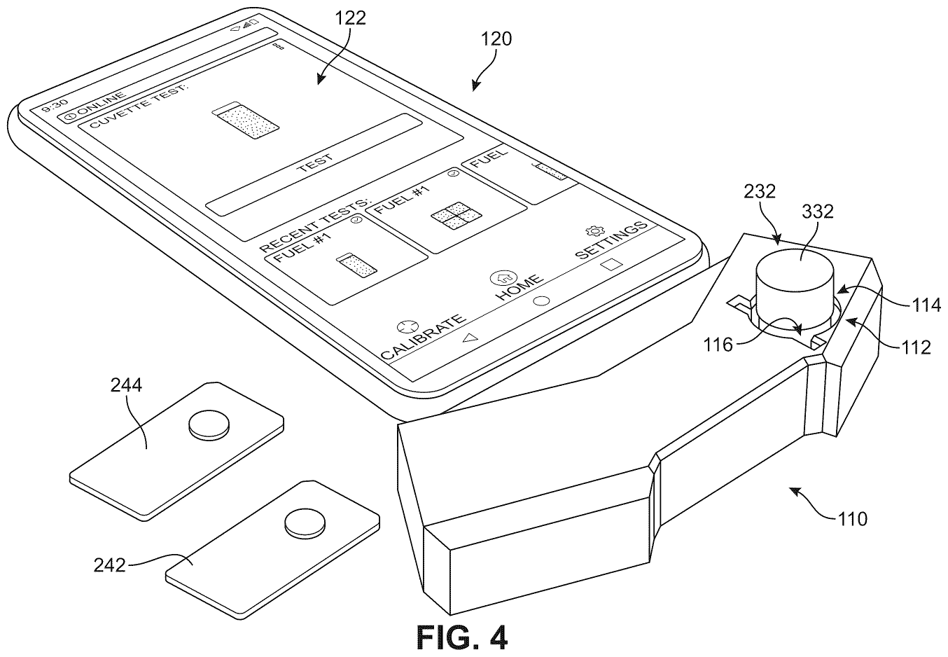

In FIG. 4, the body portion 334 has been inserted or deposited into the first test chamber 114. In different embodiments, the depth of the first test chamber 114 can be sized to correspond to or extend a distance that is at least half of the first length 336 (see FIG. 3) of the body portion 334 in which the sample is stored in order to ensure the sample is fully visible to the scanning equipment within the first spectrometer 110. Similarly, in different embodiments, a diameter of the first test chamber 114 can be sized and dimensioned to snugly receive the body portion 334 in order to improve stability of the scan and better protect the vial and its contents. Once the body portion 334 is slid into the chamber, in some embodiments, the first spectrometer 110 can be configured to detect its presence and automatically trigger the pre-installed app 122 to begin to collect data via the first spectrometer 110. In other embodiments, the user can manually trigger data collection via the app 122 at this time. Upon completion of the scan(s), the first vial 232 can be removed from the first test chamber 114 and set aside.

In different embodiments, the sample may be alternatively presented for testing via other substrates. For example, the proposed embodiments can also incorporate and are configured to work with Surface Enhanced Raman Scattering (SERS) Substrates and Microfluidic Chips. SERS is a technique that can enhance the Raman scattering of a sample by orders of magnitude, enabling detection of trace molecules, by using a metal surface as a sample substrate. In some embodiments, the SERS substrate can be made from a textured fused quartz substrate with gold deposited on the surface, creating plasmonic nanostructures that enable sensitivity down to parts per billion. Because Raman scattering itself is a rather rare event and occurs for only about 1 in 1 million exciting photons, it is often necessary to excite the sample with a high-power light source. Thus, the SERS technique enhances Raman scattering of a sample by, for example, using a metal surface or other SERS materials as a sample substrate.

There are two primary mechanisms that cause this enhancement. The first is an electric field enhancement, which is created by the excitation of localized surface plasmons. When molecules under interrogation are within the presence of this electric field, the probability of Raman scattering increases greatly. The second mechanism is a chemical enhancement due to inter-and intra-molecular charge transfer between the metal and molecule of interest. This makes SERS a non-destructive, highly sensitive technique that can be used to measure extremely low sample concentrations with significantly lower incident laser power in comparison to a standard Raman measurement.

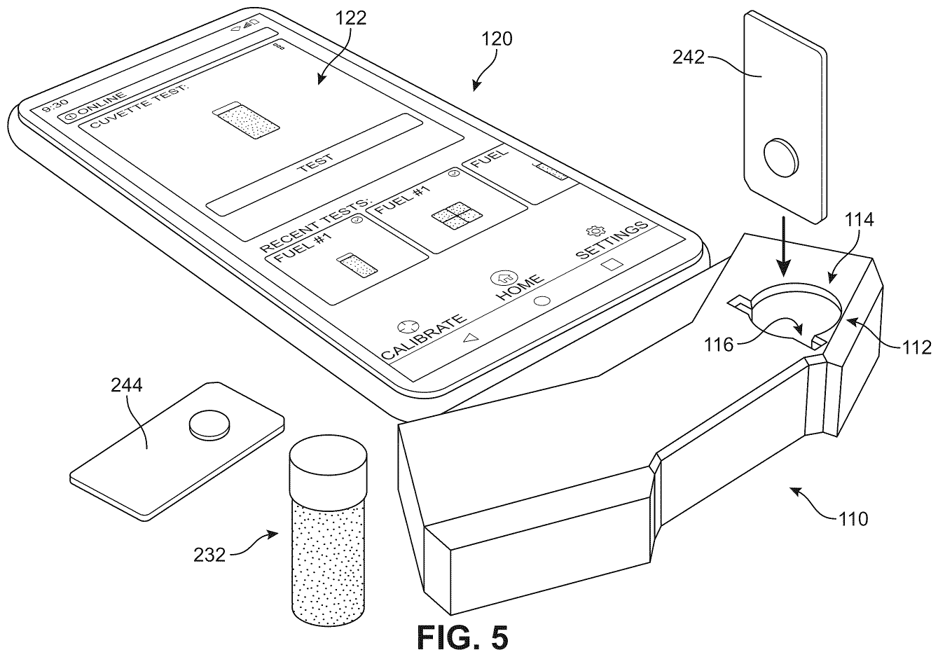

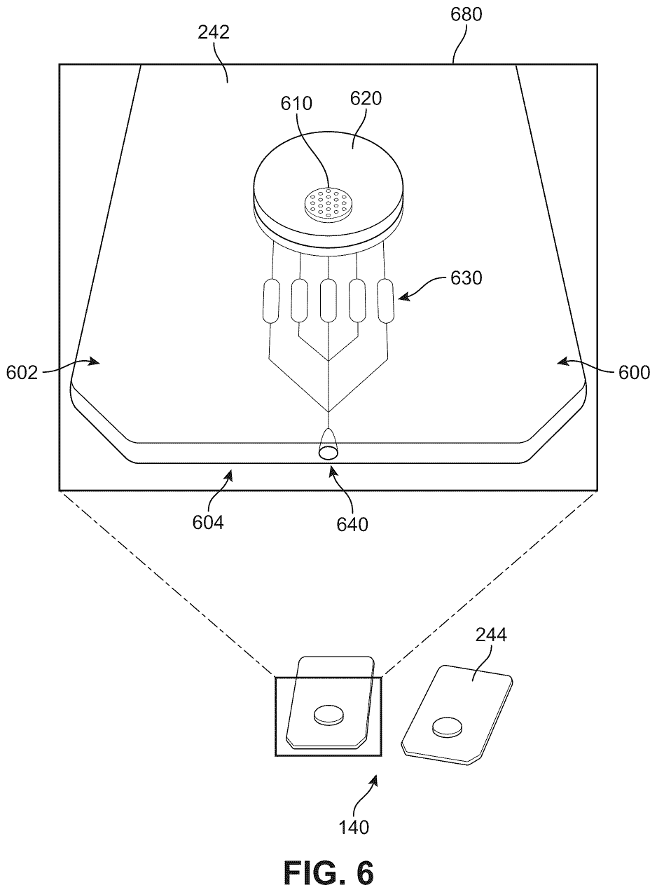

One example of this alternate mechanism by which samples can be received and scanned by the spectrometer involving a microfluidic chip is depicted in FIGS. 5, 6, and 7A and 7B. In FIG. 5, the first slide 242 is shown above the first spectrometer 110 as it is about to be inserted into the slit corresponding to second test chamber 116. For purposes of clarity, an embodiment of the first slide 242, carrying a sample, is illustrated in a magnified view 680 in FIG. 6, better showcasing its microfluidic components. As a general matter, microfluidics refers to a system that manipulates a small amount of fluid using small channels with sizes between ten to hundreds of micrometers. It involves a multidisciplinary field that relies on molecular analysis, molecular biology, and microelectronics. Microfluidic chips are therefore often referred to as “lab-on-a-chip” devices, and can serve as miniature platforms that manipulate and analyze small volumes of fluids. These chips, which feature molded or patterned micro-channels, integrate various functions, such as mixing, pumping, and sensing, onto a compact substrate, enabling precise control over minute amounts of liquids.

In FIG. 6, the first slide 242 includes a substantially planar base portion (“substrate”) 600 with a first side 602 and an opposite-facing second side 604. In some embodiments, the base portion 600 can include a substantially rectangular outer shape, though in other embodiments the shape can differ. In some embodiments, a lower periphery of the base portion 600 can include cuts or tapered edges to facilitate insertion into the slit for testing.

In addition, the first slide 242 includes an optical window 620 which is configured to facilitate efficient Raman signal acquisition while maintaining the chip's structural integrity. The optical window 620 embedded into the microfluidic chip is configured to enhance the Raman signal for clarity in trace chemical detection. In different embodiments, the optical window 620 comprises materials such as quartz, which are ideal due to their high optical transparency and low Raman background interference. Quartz microfluidic chips have been successfully utilized for Raman spectroscopy, offering clear optical paths and minimal signal distortion. In other embodiments, materials can include glass, silicon or polymer such as PolyDimethylSiloxane (PDS), etc.

In different embodiments, the optical window 620 can be disposed or arranged in a central region of a lower half of the base portion 600 to ensure that the optical window 620 aligns precisely with the spectrometer's focal point when the microfluidic slide is inserted into the slot to the slot's full depth, allowing for accurate and reproducible measurements. In some embodiments, one or more filter(s) 610 with micrometer-sized holes are often used as part of the optical window 620 as a passive means by which to sort particles or cells based on sizes of the holes.

In different embodiments, the proposed microfluidic slides leverage microfluidic systems as a low-cost, consumable alternative to Surface Enhanced Raman Scattering (SERS) substrates. In some embodiments, these microfluidic slides can incorporate reaction chambers or reaction wells 630 containing colorimetric compounds, thereby enhancing the system's ability to detect components like water content and trace impurities.

In different embodiments, the microfluidic slide can include inlet and/or outlet ports (“sample port”) 640 that are in fluid communication with the reaction wells 630 that allow the network to connect to the external environment. Liquids or gases can be injected, managed, and removed from the microfluidic chip through passive or active methods. For example, some of these techniques can involve pressure/flow controllers, syringe pumps, or peristaltic pumps. The microscale fluidic chip's channels may have varying inner diameters, typically ranging from 5 to 500 μm, with modern fabrication techniques enabling formation of structures with sub-micrometer precision. The channel network is specifically designed for the desired application and analysis (cell culture, organ-on-a-chip, DNA analysis, lab-on-a-chip, microfluidic droplets, spectroscopy, etc.). In some embodiments, the sample port 640 is a small opening or inlet designed specifically to introduce a liquid sample into the chip's microchannels, allowing for precise manipulation and analysis of tiny volumes of fluid within the device. In some embodiments, the reaction wells 630 extend down toward the sample port 640 as individual channels before merging and connecting (fluid communication) to the sample port 640.

Furthermore, in some embodiments, the proposed microfluidic slides can also be used to preprocess samples to improve Raman signal clarity, removing noise and stabilizing the analytical environment. The reaction wells 630 can further complement Raman spectroscopy by enabling additional chemical interactions that provide unique optical or spectral changes for advanced detection.

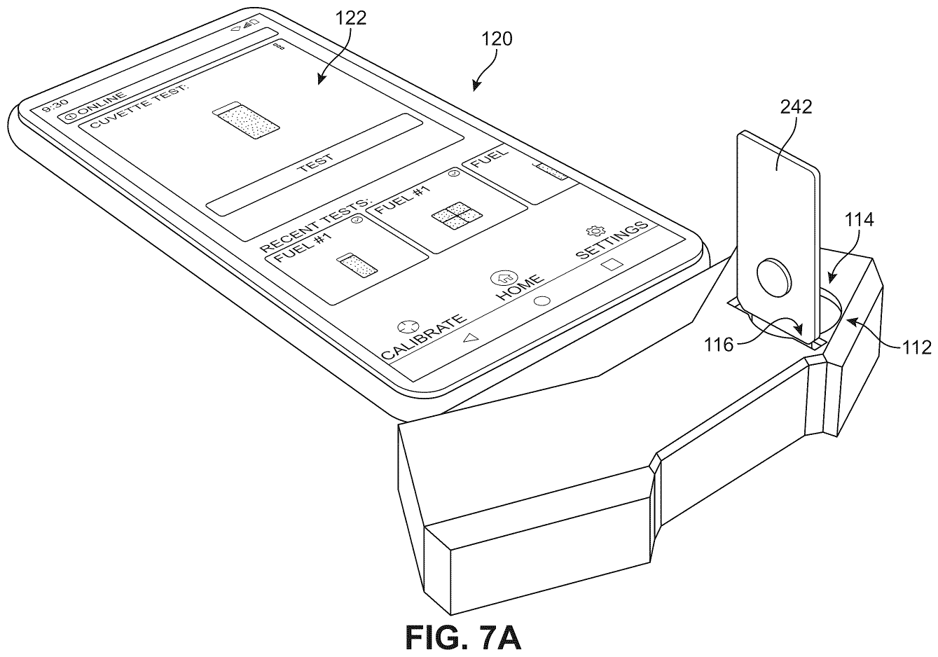

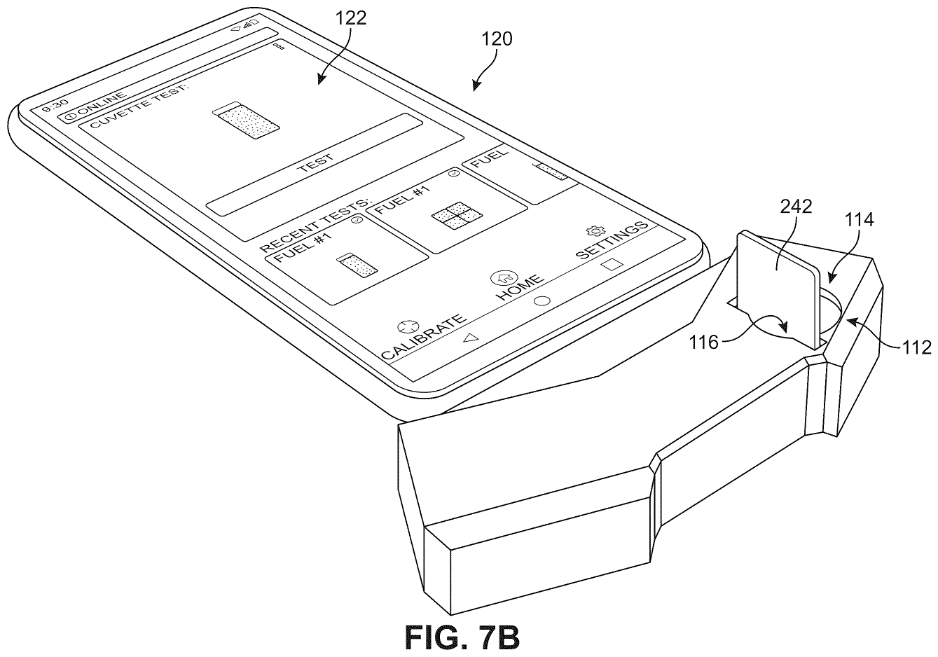

Moving to FIG. 7A, the first slide 242 is shown as it enters the opening associated with the slitted second test chamber 116, and fully inserted or secured in FIG. 7B. In FIG. 7B, the optical window is now fully immersed or disposed within the testing chamber, and no longer visible to the viewer. At this time, the first spectrometer 110 can be configured to detect its presence and automatically trigger the pre-installed app 122 to begin to collect data via the first spectrometer 110. In other embodiments, the user can manually trigger data collection via the app 122 at this time. Upon completion of the scan(s), the first slide 242 can be removed from the second test chamber 114 and set aside.

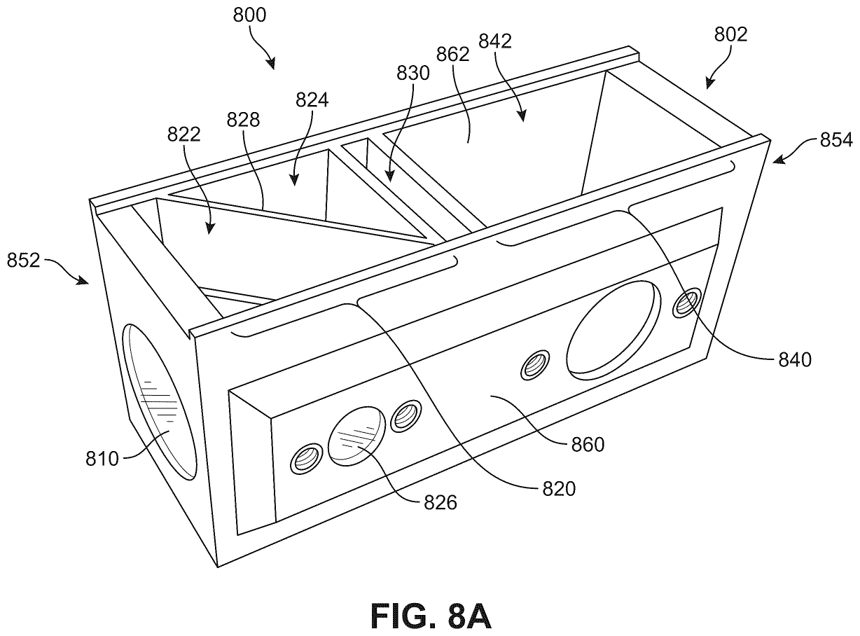

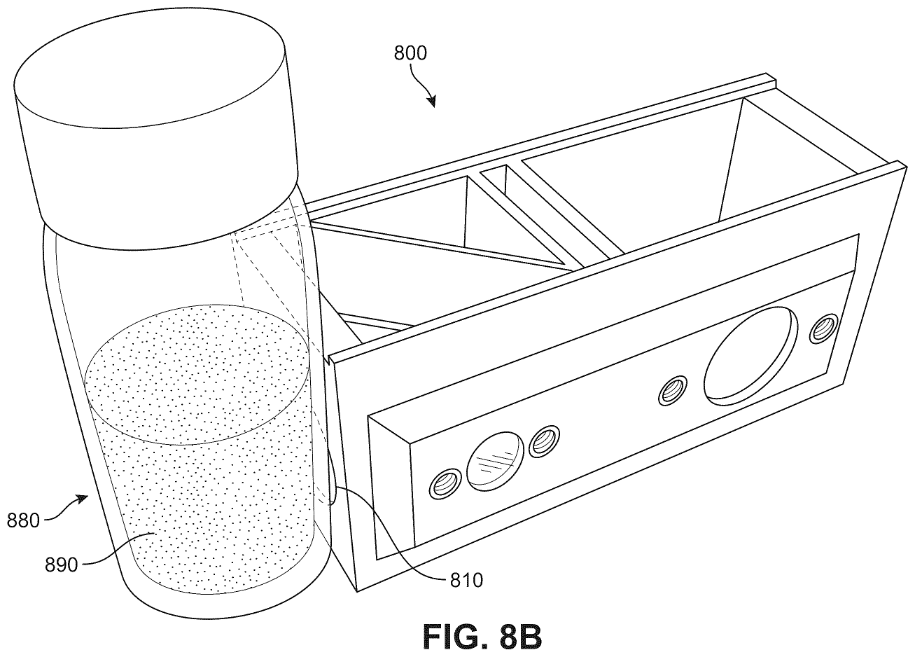

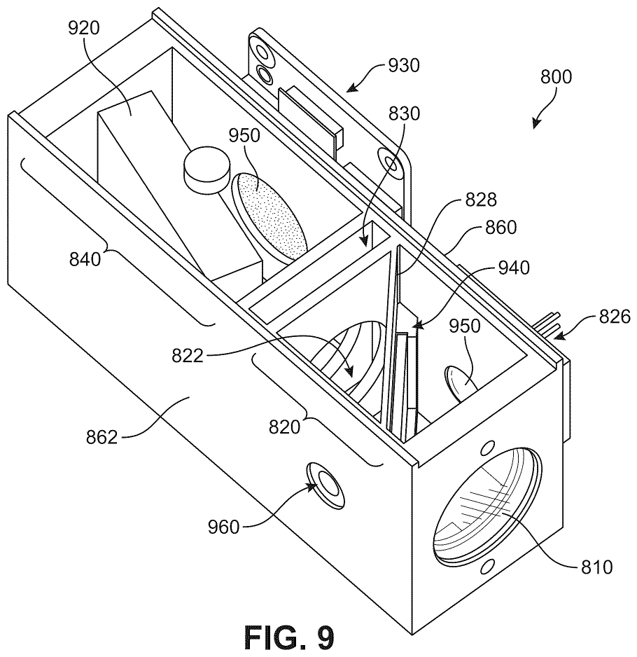

In different embodiments, embodiments of the proposed spectrometer can include an optimized internal geometric configuration and components assembly to streamline the device and enhance its performance. For purposes of illustration, one embodiment of this optimized configuration is presented in FIGS. 8A, 8B, 9, and 10. In FIGS. 8A and 8B, an exposed view, without an exterior casing, of a second spectrometer apparatus (“second spectrometer”) 800 is depicted by way of offering the reader an introduction to the instrument's internal components and arrangement. For example, the second spectrometer 800 includes a housing unit 802, which in this example has a substantially rectangular prism shape extending between a first end 852 and a second end 854. At the first end 852 of the housing unit 802, a collection lens 810 is mounted, which has a first side that faces outward or away from the interior of the second spectrometer 800, and a second side that faces inward into a first compartment 820 of the second spectrometer. In different embodiments, the proposed collection lens 810 is selected to achieve peak performance while maintaining a minimal footprint, ensuring optimal focusing and light collection crucial for high-quality measurements. FIG. 8A shows the second spectrometer 800 in isolation/inactive mode, and FIG. 8B shows the second spectrometer 800 in scanning mode, as a vial 880 containing a sample 890 is positioned directly next to the collection lens 810 and data collection is begun.

In this example, the first compartment 820 can be seen to include a lens setup/optical configuration where a beamsplitter panel 828 is on which a dichroic beamsplitter (filter) is mounted (e.g., see FIG. 9) is oriented at 45 degrees relative to both a first sidewall 860 and the first end 852 in which the collection lens 810 is installed. In different embodiments, plate beamsplitters can include a thin, flat glass plate that has been coated on the first surface of the substrate, and typically feature an anti-reflection coating on the second surface to remove unwanted Fresnel reflections. Plate beamsplitters are often designed for a 45° angle of incidence.

As shown in FIGS. 8A and 8B, the beamsplitter panel 828 separates the volume of the first compartment 820 into a first region 822 and a second region 824. This angle is selected to offer the system a critical benefit of eliminating unnecessary lenses, thereby reducing complexity and cost, while at the same time improving ease of maintenance and overall reliability and performance. In other words, the 45-degree excitation angle was selected to decrease the number of parts, as this orientation would place the laser-PCB (printed circuit board) directly on top of the main-PCB, and still provided a desirable decrease in excitation relative to scattered radiation. Thus, in some embodiments, a Raleigh filter with an optical-chamber-integrated 180-degree co-linear setup is used for the second spectrometer 800. It can be appreciated that the use of fewer lenses streamlines the system, reducing potential optical losses and misalignments.

In some embodiments, as a result of the experientially-determined curated angle selection whereby the beamsplitter panel 828 extends diagonally from a first corner of the first compartment 820 to an opposite and diagonal second corner (“kitty corner”) of the first compartment 820, each of the two regions can have a substantially triangular cross-sectional shape (i.e., isosceles triangle 90-45-45 degrees) across the horizontal plane, and/or an overall triangular prism three-dimensional shape. Along the first sidewall 860 that is adjacent to the first end 852 and extends across the length of both compartments, a laser diode module 826 can be mounted on the portion of the first sidewall 860 that extends along one side of the first compartment 820. The housing 802 further includes a second sidewall 862 runs parallel to the first sidewall 860 and/or provides another wall that encloses the compartments provided within the spectrometer.

In different embodiments, a laser printed circuit board incorporated into the apparatus is capable of turning the laser on, off, and adjusting the power of the laser, allowing advanced users to fine-tune operational settings for their own purposes. In addition, in contrast to conventional Raman spectrometers that have incorporated diodes of lower excitation wavelength (e.g., a 785 nm 15 mW diode), in different embodiments, a more powerful and efficient 808 nm, 300 mW or 350 mW VCSEL diode can be incorporated in the present instrument. Modifying the excitation wavelength to a more powerful and efficient 808 nm 300 mW or 350 mW Vertical-Cavity Surface-Emitting Laser (VCSEL) diode enhances cost efficiency and signal quality. This diode has significant increases in performance, and decrease in cost, when compared to traditional diodes. In one embodiment, an 808nm wavelength allows the benefits of a higher wavelength while still remaining low enough for use as a traditional silicon detector. In some embodiments, the optical hardware can be calibrated with a Mercury-Argon laser.

In one preferred embodiment, the device can alternatively or also include an 804 nm 250 mW CWL laser. This type laser can provide a central point of emittance rather than being configured in an array that can in some cases result in an erratically focused laser. Similarly, in some embodiments where a VCSEL is used, it can also be configured as a focused emitter rather than an array.

Returning to the larger housing 802, it can be observed that the other end of the first compartment 820 is disposed directly adjacent to a slit portion 830. On the other (opposing) side of the slit portion 830 is a second compartment 840. Thus, the first compartment 820 and second compartment 840 are spaced apart but also joined, connected, or bridged together via the slit portion 830.

In different embodiments, the second compartment 840 includes an interior space 842 in which a transmission grating can be installed, and where the output of the scan is directed, toward the portion of first sidewall 860 that is associated with/encloses the second compartment 840 (adjacent the laser diode module 826). Moving now to the view of FIG. 9, grating 920 is shown installed in the second compartment 840. In some embodiments, this grating 920 can include a reflective diffraction grating, rather than a transmission grating to provide better efficiency and durability than more conventional reflection gratings. In some embodiments, the grating is a transmission grating that is adjustable, for example via a micro step-motor and/or worm gear.

FIG. 9 also provides a view of dichroic beamsplitter 940 mounted on/in the beamsplitter panel 828. In different embodiments, the beamsplitter is oriented diagonally across the compartment so that an angle A1 is substantially equal to angle A2. In some embodiments, angle A1 is 45 degrees and angle A2 is 45 degrees. In addition, angle A1 and angle A3 can be substantially equal. In some embodiments, angle A1 is 45 degrees and angle A3 is 45 degrees. Thus, it can be understood that in different embodiments, the dichroic beamsplitter is oriented along a second axis 982 that is diagonal, at a 45-degree angle, relative to a first axis 984 along which the collection lens is oriented (e.g., the lateral direction). The second axis 982 associated with the dichroic beamsplitter is also diagonal, at a 45-degree angle, relative to a third axis 986 along with the laser diode is aligned (e.g., the longitudinal direction).

In some embodiments, either or both of the adjustable transmission grating and dichroic beamsplitter are modular. Such a feature allows the user to readily remove and replace, and/or adjust either or both of the transmission grating and dichroic beamsplitter in cases where a lower or higher wavelength laser is desirable. For example, pockets or receiving slots or openings can be provided in the housing that can be left open for part retainers. These retaining structures can be configured to slide into the pocket securely, while the interior of the retainer would be customized for the particular component that is being added or swapped. These pockets could, in different embodiments, either be accessible after removing a screw from a faceplate, or a whole-body sleeve, that keeps the retainers in place, to ensure ready access to portions of the device where component access is more desirable.

Behind the dichroic beamsplitter 940, on the second sidewall 862 opposite to laser diode module 826, a laser dump (not shown) can be provided at a dump site 960. In some embodiments, the dump site 960 can also couple as a port for a calibration laser.

FIG. 9 also illustrates an example of a camera and PCB module (“camera”) 930 that is connected or mounted to face toward the first sidewall 860. In some embodiments, the camera 930 is positioned and oriented to captured the output of a filter 950 installed on first sidewall 860, substantially facing the grating 920. In different embodiments, filter 950 comprises a small Raleigh filter that is incorporated between the grating 920 and photodetector (camera 930) to ensure precise photon placement and enhance signal quality by filtering out visible and excitation wavelengths. This allows the instrument to operate with a smaller filter, thus decreasing costs. The design parameters described herein—including angle adjustment, lens optimization, wavelength adjustment, grating enhancement, and filter integration—have shown markedly higher device efficiency, lowered costs, and enhanced data quality, resulting in a more robust and cost-effective system. The overall arrangement and reduction in components in the disclosed lens design also enable the correct alignment of the parts to be maintained even when the instrument is being “disturbed” significantly (bumped, jostled, dropped, hit, etc.) in contrast to conventional spectrometer instruments, which are highly sensitive to jarring motions.

Once the signal passes through the Raleigh filter 950, the camera 930 can communicate its captured data (e.g., imagery) to the mobile device, for example through a USB-C connection, lighting port, or other data transmission port. in some embodiments, the camera 930 works in conjunction with a raspberry pi server, while communicating through the USB-C or lightning port or other charging, data transfer, and communication port provided with the selected mobile device.

As will be discussed further below, it should be understood that at the time a sample is taken using the proposed instrument, the Raman scattering may not be displayed or otherwise presented for the human eye to see. Instead, in different embodiments, the information that is collected is captured by the onboard instrument camera 930, which is configured to translate the signal peaks and troughs through RAW data image processing. This is possible because the grating angle is calibrated with a known spectrum. Using these optical pieces in the configuration illustrated herein provides the average angle of the grating with the highest efficiency possible. While other angles are possible, the current embodiment utilizes the highest efficiency angles based on the blaze wavelength of the grating. The calibration laser (which emits very specific wavelengths across the spectrum) can be used to calibrate where these wavelengths are landing, which will allow the instrument to accurately report where the peaks in measured samples are actually landing.

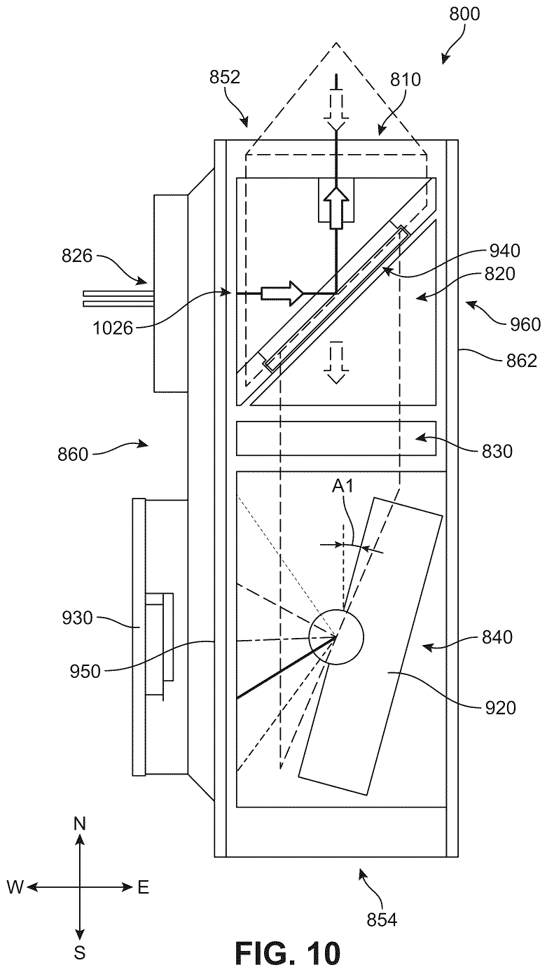

From the perspective of FIG. 9, the route that light can travel through the second spectrometer 800 is more readily discernable. For purposes of clarity to the reader, an example of this pathway is schematically illustrated in FIG. 10 by reference to a top-down view of second spectrometer 800. It can be appreciated that this pathway represents a flow of the general operational path for the proposed apparatus.

In different embodiments, the user can initiate testing by use a bottle/vial/substrate/slide to collect a sample (e.g., fuel or other bio/chemical compound), and fill to the desired sample level. In some alternate embodiments (not shown here), the bottle cap can be a consumable incorporating a filter or a SERS substrate. In such cases, the user can hold the bottle upside-down for a few seconds to wet the bottle cap, and then remove the bottle cap from the bottle and insert it into the Raman instrument's sample holder for analysis. The cap can further include a barcode for easy identification.

As noted earlier, laser diode module 826, for example including a laser diode or DPSS (diode pumped solid state) laser can be used to provide the light source. A diode-pumped solid-state (DPSS) laser is a type of solid-state laser that uses a laser diode to pump a solid gain medium, while a laser diode is a type of laser that uses electrical bias to inject charge carriers into a depletion region. In different embodiments, two or more laser diodes can be “stacked” to allow the user to select a different beam type. Dichroic filters could be selected, and corresponding laser wavelengths, and screw them (stacking multiple, if desired), onto the side of the housing with the laser dump. The light beam when activated or switched on can travel into the housing of the instrument where it can pass through a laser focusing lens.

As depicted by the red line emerging from a laser focusing lens 1026 in FIG. 10, extending in an “Easternly” direction, the focused laser beam can then arrive at the dichroic beamsplitter 940 or filter (e.g., interference filter) that selectively permits light of a smaller range of colors to pass while reflecting other colors. As the dichroic filter is oriented at 45 degrees relative to both the laser's axis of output and the collection lens, the filtered light is routed or “bounced” at a substantially right angle toward the collection lens 810 (e.g., as represented by the continuation of the red line moving from the filter in a “Northern” direction). In addition, the relative positioning of dichroic beamsplitter 940 and laser diode module 826 allows for the incorporation of effectively situated laser dump (e.g., installed at dump site 960). Thus, spurious emissions that were removed/passed by the filter can continue to travel forward (“East”) and be harmlessly dissipated via a laser dump provided in the housing directly opposite to the laser diode module 826. In some embodiments, a mirror and/or a fiber optic input can be installed where the laser dump is located.

In different embodiments, the collection lens 810 comprises a physical component with an “electronic eyeball” that is able to see more colors than the human eye can, and is able to distinguish individual colors very precisely. The lens can direct and strike a sample with a beam of light, and receive a visual answer from the sample that is at a distance D1 from the collection lens.

In different embodiments, the collection lens 810 is positioned so that a sample carried by a vial inserted into the adjacent holder (e.g., see FIGS. 4 and 7B) is consistently at a 20 mm distance (as D1) from the collection lens 810. In different embodiments, the distance could be correlated to the focal length of the collection lens which could be 15 mm diameter, 20 mm focal length, and comprising an uncoated double concave lens. In other embodiments, the center of the vial (in which a sample can be held) when inserted into the receptacle can be between 15 mm and 25 mm from the collection lens 810. It should be appreciated that the importance of the focal length can directly correlate to the signal acquisition: for example, the smaller (more focused) the laser is on the sample, the more Raman signal from the sample will make it back to the detector. Furthermore, with respect to the vial, it can be placed in the vial-holder so that the focal point will be relatively in the middle or center of the vial, thereby providing a degree of variability in the focal point that can help accommodate the effect of aberrations in the material of the vial itself on the readings. The Raman signal can then follow the inverse pathway back to the optical components. Thus, the use of a vial holder can offer the user more security and repeatability than a “point-and-shoot” method, which allows for greater flexibility, but which also requires the user to accurately place the spectrometer the correct distance away from the sample. In some embodiments, the device can be part of a kit of parts that includes multiple types of vial-holders that can be of varying lengths so the user can swap out one holder for another to adjust the relative position of the vial from the optical elements, as desired.

Once the visual response is detected at the collection lens 810, it can be reflected backwards (to the “South”), unaffected as it passes through the dichroic beamsplitter 940, and travel through a slit (e.g., one or more apertures through which the beam passes) in slit portion 830, until arriving into the second compartment 840 in which grating 920 is provided. In some embodiments, the grating 920 can be slotted or inserted into the chamber and/or removed when desired (i.e., modular gratings).

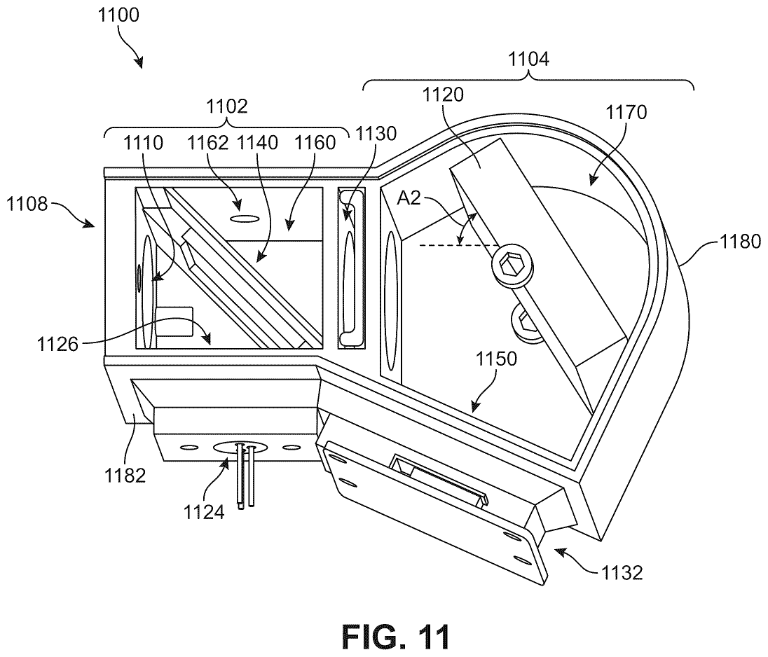

In different embodiments, the second compartment 840 can be angled to take advantage of the blaze angle that is unique to each grating. Though the drawings depict the second compartment 840 in this case as being substantially rectangular, other embodiments (e.g., see FIG. 11) can include a rounded outer sidewall. Upon striking the grating 920, the light can be divided into a spectrum of spatially separated wavelength components that are directed through Raleigh filter 950 and to the apparatus' photodetector/camera 930 (shown installed on the “Western” side of the housing). This visual data is captured as a JPEG or other image data that is then transferred over a wired or wireless connection to the mobile computing device, where it is received at the associated processing application for analysis. Alternatively, raw data from the photodetector can be transmitted to the phone and translated into any image format desired.

It should be understood that the use of directional terms “North” or (N), “East” or (E), “West” or (W), and “South” or(S) are simply for purposes of ease-of-reference for the drawing as presented, and are not intended to restrict the embodiments in any way. In other words, in other embodiments, the components can be arranged at locations relative to one another that permit variations from these terms.

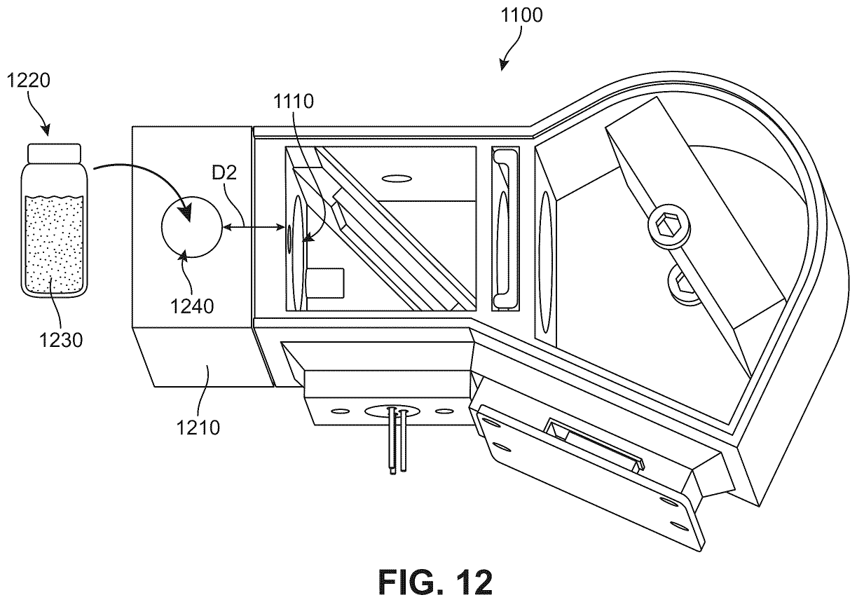

For purposes of illustration, an alternate embodiment is shown in FIGS. 11 and 12. In FIG. 11, a third spectrometer apparatus (“third spectrometer”) 1100 with the same scanning components described with reference to second spectrometer 800 in FIG. 8A is depicted, but installed in a housing 1108 that differs in geometry from the housing 810 of the second spectrometer 800. More specifically, it can be observed that while a first compartment 1160 of the third spectrometer 1100 remains substantially rectangular prism-shaped, the shape and size of a second compartment 1170 has been modified to permit variation in the orientation of a grating 1120 relative to both slit portion 1130 and Raleigh filter 1150.

As described earlier with respect to FIG. 9, when a scan is initiated, a laser diode module 1124 of the third spectrometer 1100 can emit a focused laser beam, which strikes a dichroic beamsplitter 1140 that selectively permits light of a smaller range of colors to pass while reflecting other colors. The dichroic beamsplitter 1140 is also oriented at 45 degrees relative to both the laser's axis of output and collection lens 1110, so that the filtered light will be routed or “bounced” at a substantially right angle toward the collection lens 1110. In addition, the relative positioning of dichroic beamsplitter 1140 and laser diode module 1124 allows for the incorporation of effectively situated laser dump (e.g., installed at a dump site 1162). Thus, spurious emissions that were removed/passed by the filter can continue to travel forward (“East”) and be harmlessly dissipated via a laser dump provided in the housing directly opposite to the laser diode module 1124. In some embodiments, a mirror and/or a fiber optic input can alternatively or additionally be installed where the laser dump is located.

Referring briefly to FIG. 12, in different embodiments, the collection lens 1110 can be positioned so that a sample 1230 carried by a vial 1220 snugly inserted into a receiving receptacle 1240 of a modular sample holder 1210 is consistently at a distance D2 from the collection lens 1110. The modular sample holder 1210 can be connected and disconnected from the exterior surface of the third spectrometer 1100, for example via rails, sliding guides, slots and hooks, screws, magnets, etc. that when connected ensures the relative position of the two devices is consistently achieved when one sample holder is swapped out for a different sample holder (e.g., with a different receptacle or slot for holding other substrates/samples). In different embodiments, the distance between the sample and the collections lens when the sample holder is connected could be correlated to the focal length of the collection lens which could be 15 mm diameter, 20 mm focal length, and comprising an uncoated double concave lens.

Returning to FIG. 11, once a visual response is detected at the collection lens 1110, it can be reflected backwards (to the “South”), unaffected as it passes through the dichroic beamsplitter 1140, and travel through slit(s) (e.g., one or more apertures through which the beam passes) in slit portion 1130, until arriving into the second compartment 1170 in which grating 1120 is provided.

As noted earlier, in different embodiments, the second compartment 1170 can be angled to take advantage of the blaze angle that is unique to each grating, including a rounded exterior wall that increases the interior space available within the compartment. More specifically, a first sidewall 1182 is now bent distally outward from the center of the device rather than remaining substantially linear/planar. Furthermore, a second sidewall 1180 balloons outward. Thus, the second sidewall 1180 can include a planar portion 1102 that extends between the first compartment 1160 and the slit portion 1130, before continuing in a curved direction to provide a bulging portion 1104 that wraps around the second compartment 1170 until arriving at the first sidewall 1182.

In this way, the grating's orientation and position relative to the other components can be significantly adjusted to improve performance. For example, while in FIG. 10 the grating 920 was oriented at a relatively narrow first angle A1 relative to the slit portion 830, in FIG. 11, the grating 1120 is oriented at a relatively larger second angle A2 that receives a broader array of light as it arrives and better distributes and reflects the light as it is reflected to the Raleigh filter 1150. In some embodiments, the first angle A 1 is less than 45 degrees, and the second angle A2 is greater than 45 degrees. In different embodiments, the visual data received at the Raleigh filter 1150 can then be captured by a camera module 1132 as a JPEG or other image data that is then transferred over a wired or wireless connection to the mobile computing device, where it is received at the associated processing application for analysis. Alternatively, raw data from the photodetector can be transmitted to the phone and translated into any image format desired.

For purposes of reference, in different embodiments, each of the proposed spectrometer apparatuses described herein can comprise scanning components/devices associated with the following material specifications:
(A) Laser: 808 nm wavelength, 804 nm wavelength, 785 nm wavelength, 180-degree co-linear excitation angle. As conventional designs required precise alignment in a controlled lab environment and were prone to disturbances (thereby making them unreliable for field use), the disclosed embodiments incorporate a co-linear setup that is far more robust and resistant to disturbances, allowing multiple points along the laser path within the sample to be used for signal collection. This flexibility substantially enhances reliability and performance across a wide range of rugged environments. The co-linear setup allows the device to take advantage of the surrounding structures of the spectrometer for mounting purposes. Any disturbance that occurs to the surrounding structure will result in the same disturbance to the laser and optical pathway, allowing them to remain parallel. In other setups where the laser is not on the same optical pathway, any vibrations through the device would result in a much more exaggerated divergence of the laser from the focal point of the collection lens. This angle uses the same pathway of excitation and collection, which results in an exponential increase in signal collection. A 0 degree or 180-degree would use this pathway. Any other angle would result in only a single point of the laser that would encounter the focal point of the collection lens.
(B) Modular Grating: Robust ruled reflection grating with 1200 lines/mm and a 900 nm blaze wavelength can be provided. 1200 lines/mm is one of the higher typical specifications in for gratins, and the higher the number the greater optical resolution of the diffracted wavelengths. The 900 nm blaze angle corresponds to the average wavelengths that we are interested in measuring, and this number typically results in a higher optical efficiency. This results in a much more efficient setup than a grating with a higher, or lower, blaze angle. Conventional gratings are lightweight but fragile, unsuitable for demanding environments. The proposed apparatus' inclusion of ruled reflection grating is durable and optimized for high-stress (e.g., military) use, capable of withstanding structural stress while maintaining high diffraction efficiency in the NIR range. In some embodiments, the grating is readily replaceable for users desiring to modulate their diffraction targets, whereby a first grating can be slid out of its slot in the housing and a different, second grating slid back into the same slot.
(C) Lenses: The collection lens is expanded to allow for a 15 mm beam, enhancing signal strength significantly. The lens could be 15 mm diameter, 20 mm back and front focal length, double concave lens. Every point of the laser, from the collection lens to the focal point (20 mm), will result in a point of radiation that can be collected. The greater the lens diameter, the more radiation that can be collected, which will result in a greater Raman signal. Most Raman analyzers will utilize a collection lens, and subsequent beam size, of <6 mm. This size is larger than those provided in conventional instruments and ensures improved signal collection. The proposed lenses are made of robust glass, providing superior optical clarity, durability, and resistance to environmental stress. In contrast to conventional lenses, that limit performance and durability, the larger lens support rugged and precise applications.
(D) Filtering: Bandpass filtering can be provided via two filters—one for reflecting the excitation laser (˜90% reflection efficiency) and an RG850 filter directly before the optical detector, with preliminary results showing detectability ˜150 cm^−1. The proposed setup significantly reduces interference from the 808nm excitation laser, improving signal isolation and overall performance. 1 in a million interactions of the excitation laser could result in a photon corresponding to Raman radiation. As a result, the amount of light hitting the photodetector without filtering could result in the majority being the excitation laser. This will typically wash out the Raman signal, resulting in an output where users will only be able to see the excitation frequency. Bandpass filtering is then employed, thereby reflecting this specific frequency, which will block the laser and allow focus on the Raman signal.
(E) Modular Detector (Camera): An off-the-shelf, modular, low-cost photodetector can be employed. Rather than rely on a camera incorporated in the smartphone for detection—which can be inherently expensive and required precise calibration to the phone in use—the proposed apparatus incorporates its own photodetector that can serve as a phone peripheral, allowing compatibility with any phone without requiring precise calibration. This approach reduces cost and complexity while increasing flexibility and usability. Multiple available models of photodetectors could be utilized. Non-limiting example photodetectors are the Sony imx219, imx708,imx462, or other image sensors compatible with Raspberry Pi cameras. Specifications of a photodetector could include a quantum efficiency (QE) for the wavelengths the users are interested in measuring (i.e., sensitive enough to detect those frequencies). For example, QE is expressed as a percentage, so that a QE of 75% means that 75% of photons are converted into electrons. Depending on the specific application for which the spectrometer apparatus is being used, a modular photoreceptor can be selected that has different semiconductor materials, thereby affecting the spectral response (which varies depending on wavelength). In different embodiments, a first photoreceptor can then be detached and a different, second photoreceptor attached as desired by the user.
(F) Modular Sample Holder: In different embodiments, a sample holder can be provided as an integrated part of the apparatus. In other cases, the sample holder can be configured with an attachment or connection/disconnection mechanism by which it can be removably mounted to the sidewall of the apparatus in which the collection lens is installed, permitting swapping in and out of modular sample holders configured for different vial sizes and shapes and/or microfluidic slides of varying dimensions. In addition, in some embodiments, the sample holder can feature an open well to prevent residual fuel from pooling. In this way, the holder facilitates is compatible with the adjoining compact spectrometer, allowing for easy insertion and analysis of samples. In different embodiments, the sample holder can further include provisions for integrating a SERS substrate to enhance trace contaminant detection and quantification. Furthermore, real-world testing with the sample holder involving various disposable pipettes showed there was no interference with the Raman spectra when transferring fuels. As a non-limiting example, a concave reflective diffraction grating, which would focus all of the diffracted wavelengths directly towards the photodetector could be used. Incorporating a rotating Powell lens can allow the system to cast the excitation laser as a line, as well as collect the radiation directly from that line. This would bring the performance of the device near to that offered by a conventional hyperspectral Raman spectrometer, by allowing the device to pick out specific particles and list their corresponding spectra.
(G) Housing: In different embodiments, the main housing could be composed of a rigid, robust, resin polymer mixture that is rated to withstand 450 degrees Fahrenheit. The individual components can be separated from the housing using an insulator of the same material, allowing for custom insulators to be made for each type of device the user would like to mount. The devices, and insulators, lend themselves very well to modularity and customization, and can be swapped out by hand. In some embodiments, the devices, and insulators, are mounted to the main housing by small metric screws, facilitating user access and repairs/replacements when desired.

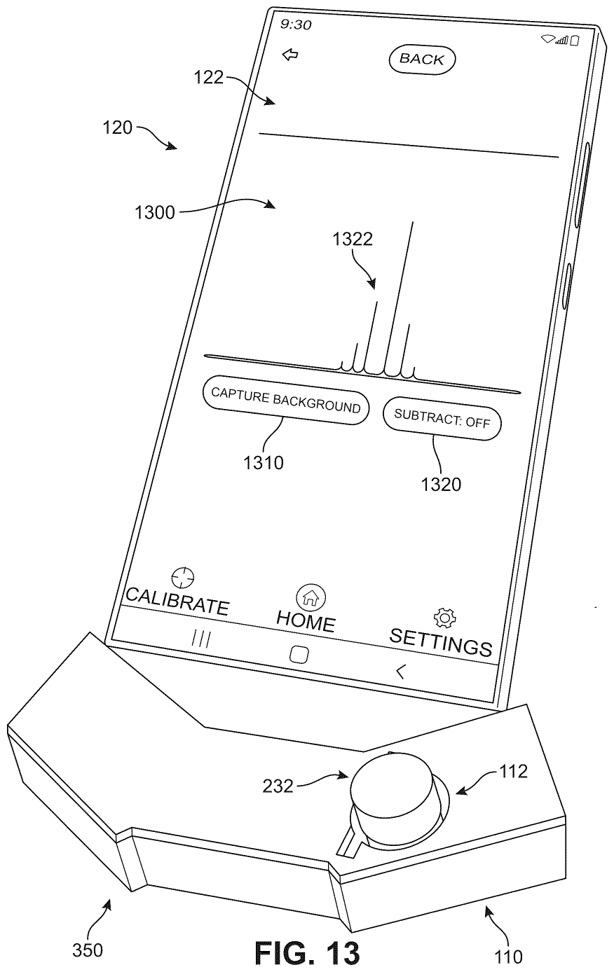

As noted above, in different embodiments, the apparatus is configured for use as an accessory with a smartphone or other mobile computing device, making it highly appropriate and practical for repeated use in the field. In FIG. 13, a real-world test scenario is illustrated in which the first spectrometer 110 is connected to mobile device 120, and a sample contained in the first vial 232 has been inserted into and received by receptacle 112. In different embodiments, the scanner can detect contaminants and live microbial pathogens including bacteria, mold, and fungi, using Raman Spectroscopy.

In some embodiments, the spectrometer's photodetector (camera) can be associated with a processor/memory component that can include or be otherwise connected to a mobile computing device adaptor that can connect directly into the power/data port of the device. For example, the images are transmitted to a smartphone, and received by a mobile phone application employing a trained Deep Neural Network (see below). The instrument, when connected to the smartphone, thereby provides users with a real-time adaptive, easily trainable, artificially intelligent handheld instrument for chemical and microbial point detection in the field.

In different embodiments, the apparatus can be plugged into a mobile phone, and draw power from the phone to an onboard battery, which is used to power the CPU, photodetector, and laser diode. In different embodiments, the processor could handle the controlling signal to and from the phone, and translating that into something that the photodetector can understand, and vice versa. As a non-limiting example, iOS® and Android® phones and tablets generally have one primary data port that is used for charging and for connecting to accessories. Thus, in different embodiments, the spectrometer apparatus can be configured with a modular adaptor that can provide a secure, stable connection to Type USB-C, micro-USB, and Lighting® connections, or other data port type that is developed.

In some embodiments, the apparatus can include multiple types of male adaptors (e.g., as part of a kit) for connecting the apparatus to a desired mobile computing device data port. In one embodiment, an adaptor can be rigid and resilient enough to support the mounting of the apparatus on the smartphone. In different embodiments, the adaptor can include a mechanism for decoupling the apparatus from the smartphone, such as a squeeze button or lock/unlock mechanism. Once the apparatus is linked to the data port, the spectrometer can be configured to operate as a “plug and play” device so that data collection can be performed with no further mechanical adjustments between the two parts. Additionally, a package on the device could allow users to plug it into the device and install the app from there. For example, the apparatus can be pre-calibrated to work with any type of smartphone, a feature that is possible due to the incorporation of an onboard photodetector (rather than relying on the smartphone's camera). In some embodiments, the apparatus can be powered through the data port. In one example, the apparatus can receive instructions or other control signals from the smartphone through the data port that allow the user to turn on the detector, turn off the detector, initiate a collection event from a sample, etc. These options can be provided via a GUI for a mobile application installed locally on the smartphone (e.g., a “Contaminant Recognition feature” provided via the app 122). In other embodiments, the apparatus itself can include a mechanical power on/off switch.

An example of a first graphical user interface (GUI) 1300 associated with the app 122 is shown in which incoming data collected via the first spectrometer 110 has been received by the app 122 and processed to generate and display an interactive spectral graph 1322. In this example, the spectral graph 1322 includes a plurality of “peaks” that correspond to the highest points on the graph, indicating the wavelengths or frequencies where the intensity of a signal is the strongest, signifying the dominant components within the signal data being analyzed, as visualized on a spectrum graph. In some embodiments, the spectral graph 1322 can include features whereby a user can increase or decrease magnification to view with more clarity the peaks, and/or interactive regions such that a user can tap to view the chemicals that have been identified and their relative amounts in the sample. In different embodiments, the first GUI 1322 can further include selectable options such as a first option 1310 to capture and remove the background, and a second option 1320 to “subtract”, or isolate specific features or patterns in the data. Other options can also be provided to enable navigation from the first GUI 1322 to other menu items.

It should be appreciated in observing the parts of FIG. 13 that the proposed systems are designed to further both structural robustness and device miniaturization. The proposed design is directed toward repeated use in high-stress, rugged environments (e.g., military applications) and rely on an integrated optical detector. The number of parts in the disclosed embodiments are minimized by leveraging dual-use components, maintaining affordability, and enabling a compact and miniaturized design. In contrast to conventional devices designed for laboratory use that are unable to withstand impacts or other stressors, the proposed embodiments offer a rugged, reliable, and portable system suitable for field operations, all while keeping costs significantly lower than those associated with conventional Raman spectrometers.

In different embodiments, the GUIs described herein can rely on open-source software and systems. In contrast to proprietary operating systems, which restricts their use to original equipment manufacturers' (OEM) hardware, and limits the use of the detector in the field, a smartphone-based Raman spectrometer as described herein can incorporate a modular and open-source approach. In one example, the embodiments can be configured to work in conjunction with an application providing users with a relatively simple GUI (e.g., under the SMC-S-023, Human Computer Interface Design Criteria for GUI development). In different embodiments, the software app, which can be built on an Android® Operating System (OS) or Apple® iOS, can employ an iterative testing approach with real end-user feedback to provide an intuitive use process requiring little to no prior instruction or manuals.

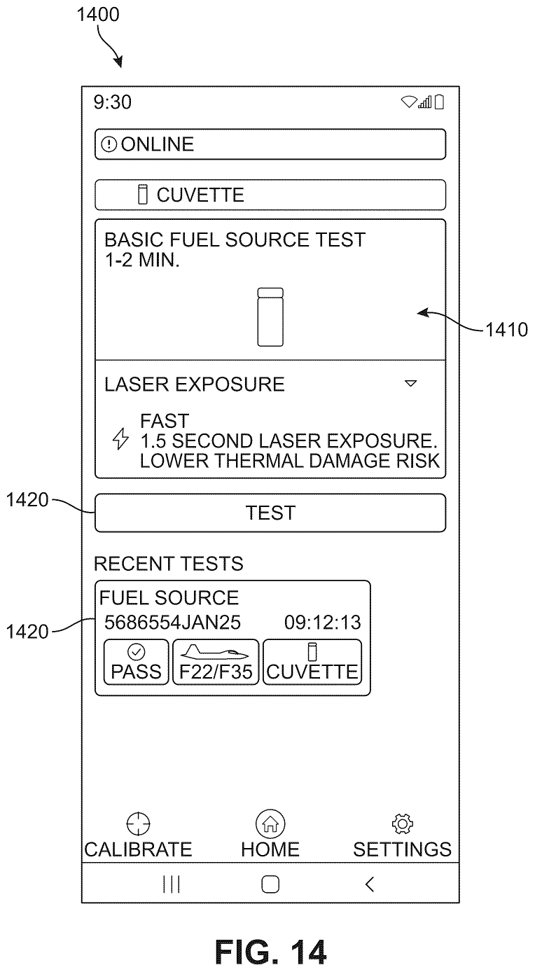

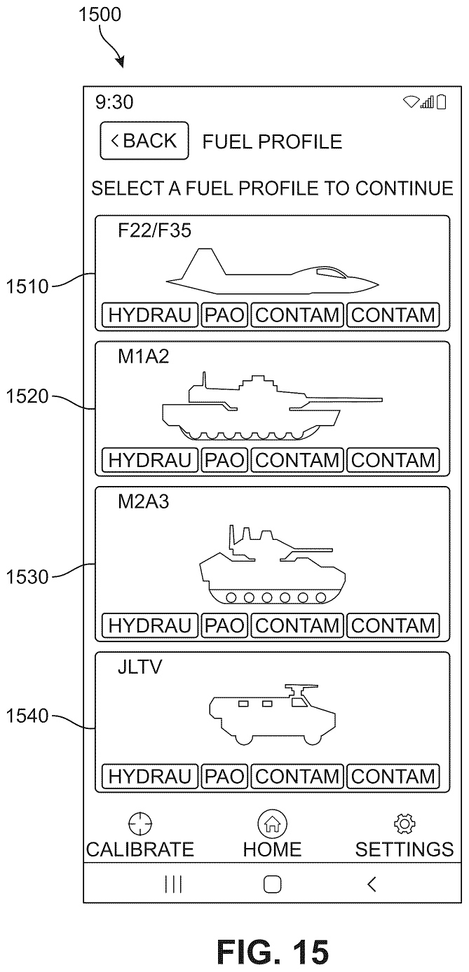

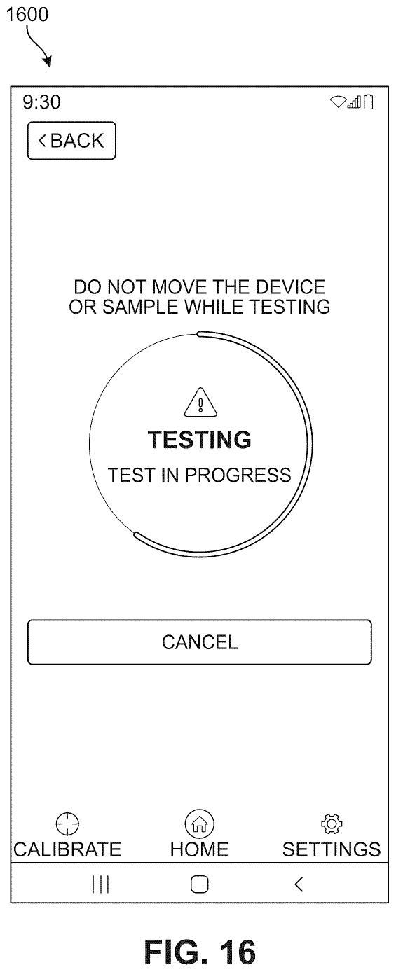

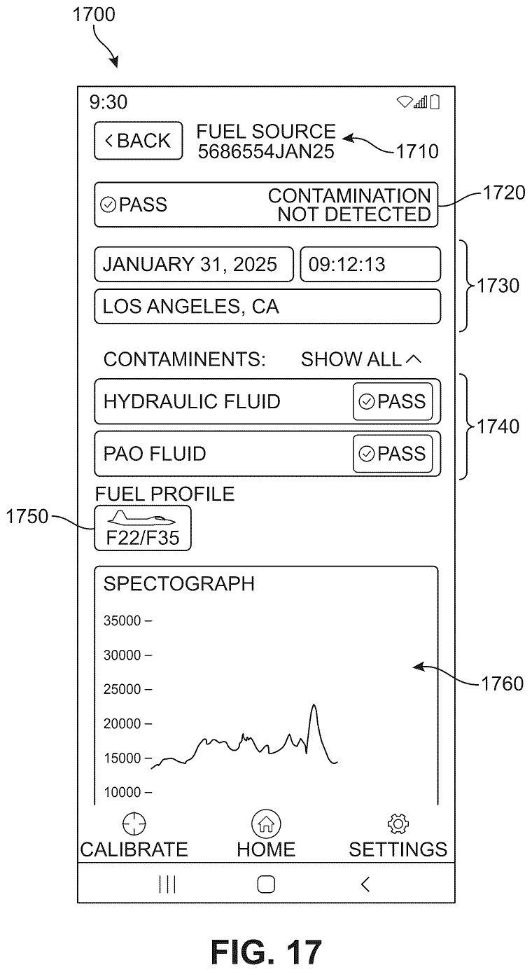

Some examples of GUIs for the app are depicted in FIGS. 14-18. FIGS. 14, 15, and 16 show an example sequence of GUIs by which a user can navigate from an initial test start screen to an active testing stage. More specifically, a second GUI 1400 of FIG. 14 is directed to performing a basic fluid source test 1410 of a sample submitted via cuvette. In some embodiments, the GUI can further include a first selectable option 1420 to initiate a new scan of a sample, as well as a second selectable option 1430 to view recent/previous test data. Moving to FIG. 15, in some embodiments, once a user has initiated a scan, a third GUI 1500 can be presented by which one or more chemical profile types are displayed for selection. In this specific case, the app is directed toward measuring contaminants in fuel; thus, the profile types include a first profile 1510 (e.g., fuel for a jet/aircraft), a second profile 1520 (e.g., fuel for a first type of tank), a third profile 1530 (e.g., fuel for a second type of tank), and a fourth profile 1540 (e.g., fuel for an all-terrain vehicle). In other embodiments, the app can be configured to present a wide range of other profiles, related to fuel and non-fuel compounds. For purposes of this scenario, the user selects the first profile 1510. In response, the app can cause a scanning operation at the connected spectrometer-dongle to begin, as illustrated by a fourth GUI 1600 (“Test in Progress”).

Upon completion of the scan, the app can automatically process and analyze the data captured by the spectrometer, and display a results screen. In some embodiments, this screen can immediately alert the user as to the presence of one or more pre-designated contaminants, or whether the sample has been determined to be uncontaminated. For example, in a fifth GUI 1700, a first test dashboard is presented. This dashboard can include an identifier label/file name 1710 for the sample for reference (automatically generated or inputted by the user), and data associated with the test, including but not limited to: (a) a summary message 1720 (“PASS: Contamination not detected”); (b) date, time, and location of the test 1730; (c) specific chemicals or contaminants 1740 that were searched for in the sample and whether they were present/detected (in this case, PASS indicates no such contaminant was detected); (d) which profile was selected 1750; and (e) a spectrograph 1760 of the data.

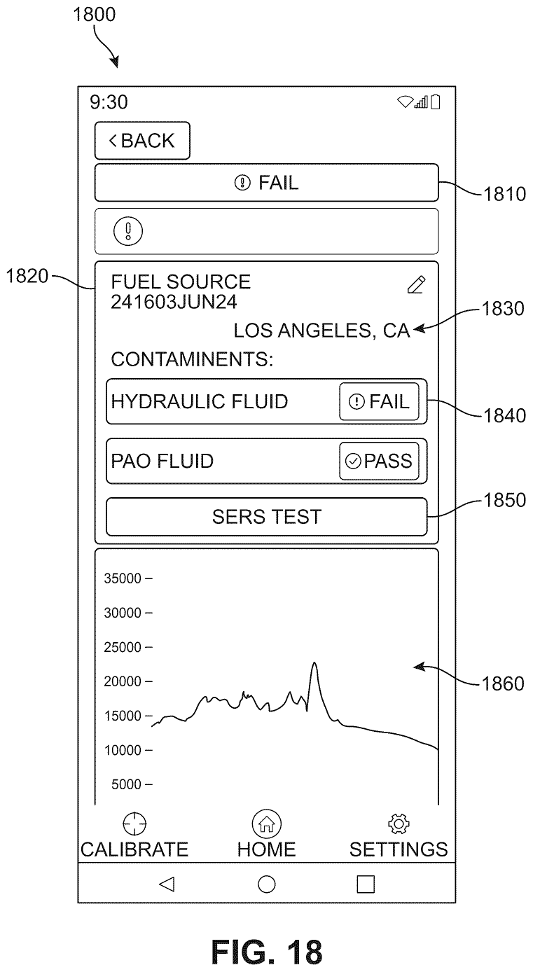

In contrast, by reference to FIG. 18, an alternate test scenario result is shown where contaminants were in fact found in the sample, triggering presentation of a sixth GUI 1800. In this case, a second test dashboard is presented. This dashboard can include an identifier label/file name 1820 for the sample for reference (automatically generated or inputted by the user), and data associated with the test, including but not limited to: (a) a summary message 1810 (“FAIL”) including a targeted recommendation (“Based on regulation 321 it is recommended to confirm contamination with SERS testing”); (b) date, time, and location of the test 1830; (c) specific chemicals or contaminants 1840 that were searched for in the sample and whether they were present/detected (in this case, FAIL indicates a particular contaminant was detected); and (d) a spectrograph 1860 of the data. Furthermore, in some embodiments, in response to the FAIL decision outputted by the system, the sixth GUI 1800 can include a quick-option 1850 to move directly to initiating the SERS test, as recommended.

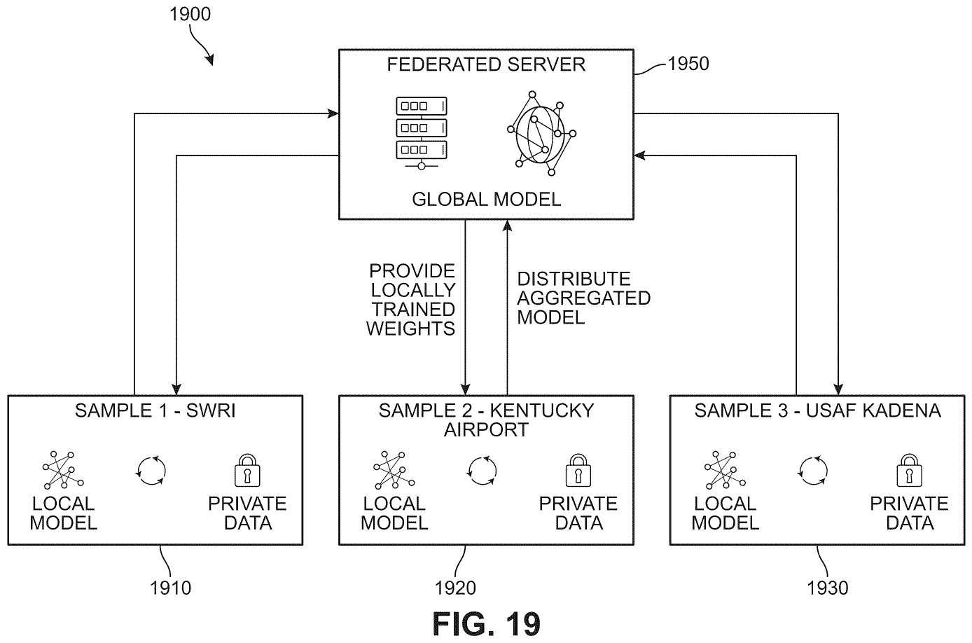

In different embodiments, the GUI can include different profile systems within the device (e.g., end-user, chemist, and administrator, etc.). The end-user profile could have the lowest number of permissions, preset laser and limited functionality controls, while the chemist's view could allow the adjustment of the laser strength and exposure time. The chemist's view could also be restricted from changing the any software presets or uploading data to a Federated Learning Platform (e.g., see FIG. 19 below). Furthermore, the administrator view could include unlimited access to the device's capabilities. The results screen would also depict an image of the spectra captured by the apparatus, as discussed above.

As presented herein, the proposed app interface is designed a simple, yet highly effective GUI tailored for minimally trained operators. This interface can thereby facilitate real-time fuel and propellant analysis by providing clear, step-by-step prompts and intuitive displays of critical parameters. The GUIs can present results with clear pass/fail indicators, ensuring rapid decision-making without requiring deep technical expertise.

As introduced earlier, in different embodiments, the proposed system includes not only a robust, powerful apparatus, but enterprise software integrated into the mobile application that employs an intelligent Deep Neural Network (DNN) algorithm. In different embodiments, the algorithm is configured to apply signals processing techniques (e.g. wavelet transform or Continuous Wavelet Transformation (CWT)) to detect and quantify aviation grade Polyalphaolefin (PAO), sulfur compounds, hydraulic fluid, and microbial contamination in jet fuel samples, as well as a wide range of other aberrations in samples. Advanced signal processing techniques such as CWT provide a more effective means of analyzing transient fuel properties in real-time without extensive sample preparation. Unlike traditional global transform techniques, CWT allows localized, multi-scale analysis of fuel samples, improving precision and robustness in field environments. The use of AI-driven chemometric modeling further enhances analytical accuracy, reducing the need for human interpretation and minimizing operator training requirements. These advancements collectively enable the development of a deployable, low-cost spectrometer capable of real-time, high-accuracy fuel and propellant analysis, addressing the deficiencies of previously tested method. In some embodiments, the algorithm is configured to provide a jet fuel thermal stability indication.

For purposes of reference, some details regarding an embodiment of the proposed AI model are provided. In different embodiments, the system can include a deep neural network (DNN), feed-forward neural network (FNN), and/or convolutional neural network (CNN) that can be trained to classify different levels of fuel contamination using Raman spectra. In one testing scenario, the training datasets included samples with contamination levels of 1%, 0.5%, 0.25%, 0.125%, 0.0625%, and 0%, using Paragon® and Marathon® jet A fuel samples. The training process involved using machine learning algorithms to analyze the Raman spectra and develop a model capable of accurately identifying and quantifying contaminants. Additional data from external entities were incorporated into the training process to enhance the model's accuracy and reliability. The DNN was thereby trained to achieve high accuracy in detecting and quantifying various levels of contaminants in jet fuel by collection and prepare training datapoints with varying levels of contamination using datapoints obtained from real-world testing samples. The model performance was then validated using additional samples from various fuel providers. The DNN demonstrated a high degree of accuracy in classifying fuel contamination levels using Raman spectra, successfully detecting contamination levels at 1%, 0.5%, 0.25%, 0.125%, and 0.0625%. The DNN can be continuously updated and improved using new data and feedback.

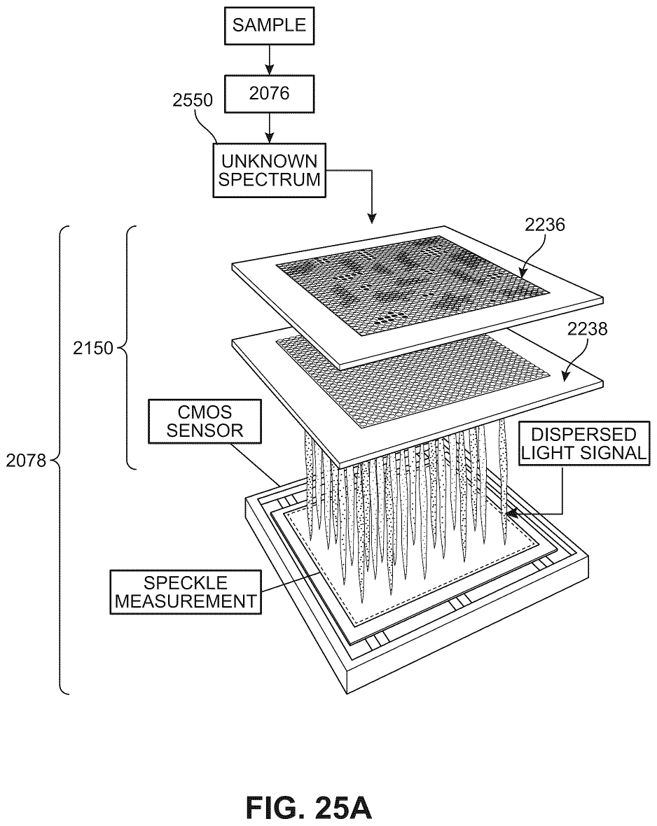

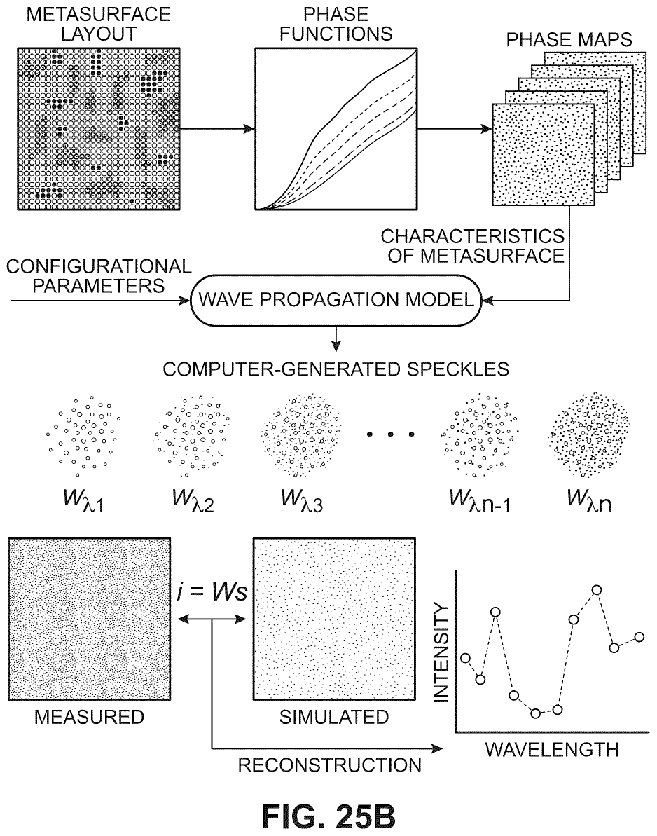

In some embodiments, the resultant AI model is able to take the photodetector's captured colors and their corresponding brightness and intuit what the sample is made up of. In contrast to reliance on a database of entries, which would be static and require a significant consumption of memory and processing, the AI model can be trained to inherently understand that “ingredient” list and immediately recognize the contaminant(s). In different embodiments, the AI model can also or alternatively be trained to recognize unique speckle patterns to recognize a sample, as discussed below with reference to FIGS. 25A and 25B.

In different embodiments, the system can be further refined to expand upon the AI neural networks described above to enhance its predictive analysis capabilities for Raman spectral data. For example, by leveraging advanced algorithms, the system can be trained to trends and anomalies, predict molecular compositions, and simulate macroscopic fuel properties. These models can evolve and refine their predictive accuracy using a combination of experimental and synthetic datasets, enabling robust analyses in real-time field conditions. Key parameters, including electrical conductivity and freezing points, traditionally requiring direct measurement under controlled conditions to ascertain such properties, can then be estimated with precision by correlating Raman spectral features to molecular structures and properties. In some embodiments, this process involves refinement of existing neural network architectures to process Raman spectral data for identifying molecular patterns and predicting chemical properties. In different embodiments, this process can incorporate both experimental and synthetic datasets (see below) that are used to extensively train the model to ensure adaptability across various fuel types and environmental conditions. To strengthen model performance, an advanced anomaly detection algorithm can also be integrated into the network, enabling the identification of outlier patterns that could indicate contaminants or unexpected chemical variations. In addition, the system can include rigorous validation processes that simulate extreme environmental conditions, allowing the system to sustain accuracy across a wide range of operational scenarios, from extreme cold to arid climates. Advanced adaptive algorithms can also continuously calibrate the spectrometer in real time, mitigating the effects of environmental factors such as temperature and humidity shifts. Furthermore, integrated anomaly detection and automated corrective actions prevent system failures, while user training modules ensure operators at all technical levels can effectively utilize the system with minimal error.

Furthermore, referring next to FIG. 19, in different embodiments, the system can include, employ, or access a Federated Learning (FL) marketplace 1400 for refining of the algorithm, employing a decentralized approach to training Machine Learning (ML) models. In such cases, raw data at the edge is used to train the model locally, which promotes and increases data privacy. In one example, the final model is generated via a shared learning pool, by aggregation of the local model outputs in different locations and/or facilities across the world (e.g., from a first local model 1410, a second local model 1420, and a third local model 1430). A larger, global FL model 1450 can thereby be trained, for example, to detect new contaminants from the provided Raman spectra. The production of data across multiple use-cases (e.g., Commercial Airline, US Coast Guard, US Air Force, Navy, US Marine Corps, NASA, etc.) at different locations can be brought together to enable a collaboration by which the deep learning model continues to be trained and improved over time to detect contaminants in aviation fuel. Each organization can have their own data, and yet can be granted the benefits of a larger data resource that be used to train a model on all of the data without directly sharing data with each other, or with a central entity, ensuring privacy and data protection. The DNN model can thereby be trained in a federated manner, where each entity could train a model on its own data, and the models could be aggregated to produce a final model.

In different embodiments, each individual device could receive or download a copy of the most recent/up-to-date version of the global FL model network. For example, when one of the devices connects to the network, the system can determine whether there are any updates available, and if so, the updated weights and biases within/for the model network are exchanged (e.g., the user device sends theirs, and they obtain the updated one from the network). However, in such cases, confidentiality of user data would be maintained, so that no readable data is exchanged (e.g., spectra measured, sample data, etc.). In some embodiments, this process would be a periodic or as-needed update definable by or otherwise scheduled by the user, or occur in response to a manual request by the user.

By incorporating Federated Learning (FL) into field-level fuel and propellant analysis systems, their adaptability and analytical precision are enhanced while maintaining robust data security. By leveraging a decentralized ML platform, the system can continuously improve and refine its neural networks used for analyzing complex chemical profiles in real-world operational environments (such as, but not limited to, US military and commercial aviation sources), to generalize effectively across various fuel types and contamination levels. In different embodiments, the system employs secure FL protocols and lightweight model architectures that can operate efficiently in bandwidth-constrained and remote conditions, ensuring state-of-the-art performance and reliability. The FL can further incorporate secure protocols that anonymize, encrypt and transmit the results of the local models, allowing devices to transmit model gradients, weights and performance metric updates to a central server without compromising user privacy. In some embodiments, the system can incorporate over-the-air update mechanisms to enable automated, real-time improvements to the models. These updates shall ensure that the analytical system evolves continuously based on data from diverse sources, including jet fuel, diesel, synthetic fuels, and contaminants, while adhering to stringent privacy regulations.

As noted earlier, in different embodiments, the system can benefit from the use of synthetic datasets for refining of its neural networks. In one embodiment, simulated Raman spectra data can be generated to direct the performance of the neural network toward a particular target. Traditionally, spectra are analyzed directly against a database for a match. If there is no match, the sample is unknown. Every analyzer will show a slightly different spectrum for each sample, and a user would traditionally want to build their database using their own samples and analyzer. However, by utilizing synthetic mathematical approximations of spectra, the system can simulate how the analyzer would evaluate unknown samples. By utilizing a cascade of millions of mathematical approximations, the system can recognize what specifically is resulting in these spectra from specific molecules, and enable users to translate the data back and forth.

In some embodiments, an automated Density Functional Theory (DFT) algorithm can be created to generate artificial Raman spectra, enabling the simulation of real-world data for improved analysis. For example, the system can employ DFT to generate artificial spectra (which is a mathematical approximation) for individual molecules and employ Mass Spectrometry to determine molecular concentrations within specific samples. By constructing a mixture of artificial spectra using a linear concentration model, insights from experimental Raman spectroscopy can be obtained with AI-driven spectral translation. In one embodiment, the AI model is trained to correlate experimental spectra with their artificial counterparts, enabling efficient qualitative and quantitative spectral deconvolution. This method streamlines the interpretation of complex spectra and enhances the accuracy of molecular analysis.

In one example, the method of producing this synthetic spectral data can involve a process comprising: (1) generating millions of Mass Spectrometry (MS)-spectra; (2) converting the MS spectra to Raman spectra; and (3) Training of a Deep Learning Algorithm to recognize the millions of generated MS-spectra available, where these spectra include mixes of chemicals (bulk matrix) that the Raman spectrometer has not yet been able to identify. Such an approach would enable conversion of existing Mass Spectrometer and NIR spectra to a format that Raman could understand/process, allowing low cost, portable RAMAN spectrometers as disclosed to offer far broader and comprehensive use across industries where mass spectrometry dominates. In this way, the system allows for manufacturing of training data. For example, neat jet fuel can be obtained, and the target contaminants intentionally added to the fuel. These samples can then be excited with a Raman laser, and the spectra captured. A deep learning algorithm can classify the spectra and contamination. Once the base model is developed, future users will be able to use their own algorithms/models and provide the model updates through the federated marketplace. In some embodiments, the marketplace can include an aggregator that will push out new models to all users globally.

In different embodiments, the synthetic spectral data generation can revolve primarily or entirely around DFT (deep functional theory) calculations, as networks can learn how to simulate DFT calculations much more accurately than a purely algorithmic approach. As a general matter, the DFT-based approach involves the application of algorithms and analytical processes focusing, in modeling, a molecule at the quantum level, simulating how photons interact with it, and how the molecule changes based on these photonic interactions. There are numerous algorithms and analytical processes available for this. The system will include a custom-developed neural network to help make this process much more seamless and less calculation-intensive.

As described herein, Raman spectroscopy serves as the primary technique for capturing vibrational signatures of hydrocarbons and aromatic compounds in jet fuel samples, while dielectric property measurements add another layer of molecular characterization, particularly concerning electronic polarizability and phase transition behavior. The synergistic use of these techniques facilitates a novel approach for predicting macroscopic fuel properties through inverse computational spectra generation. By correlating the acquired Raman spectral data and dielectric properties with composition databases, the system can benefit from reference to reconstructed molecular profiles that serve as predictive indicators for critical fuel performance metrics. For example, to estimate the net heat of combustion, a computational model will be trained on historical Raman spectral data and calorimetric measurements, establishing empirical correlations between molecular structures and energy release characteristics. The dielectric constant, when analyzed in conjunction with Raman-derived hydrocarbon chain distributions and aromatic content, would enable prediction of the freezing point by capturing phase transition behaviors. Additionally, flash point and smoke point predictions can be derived from spectral signatures of long-chain hydrocarbons, aromatics, and molecular weight distributions, facilitating accurate assessments of volatility and sooting tendencies. The identification of oxidation-sensitive functional groups, including peroxides, carbonyls, and unsaturated hydrocarbons, through Raman spectroscopy provides direct insight into thermal oxidation stability.

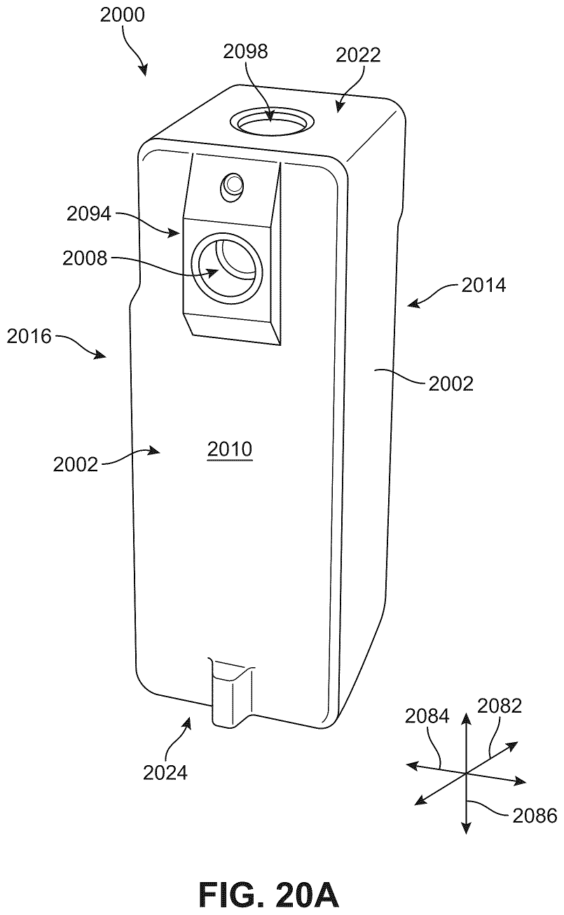

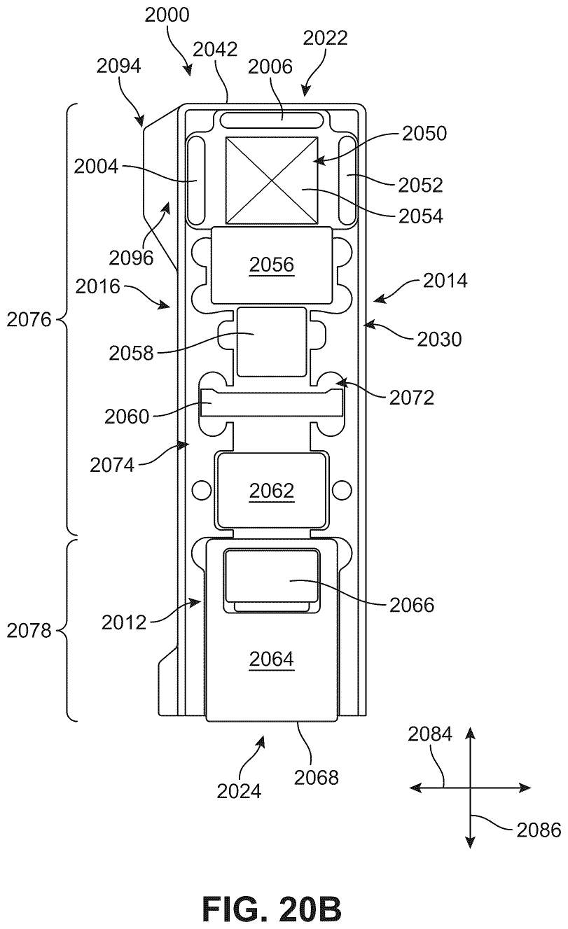

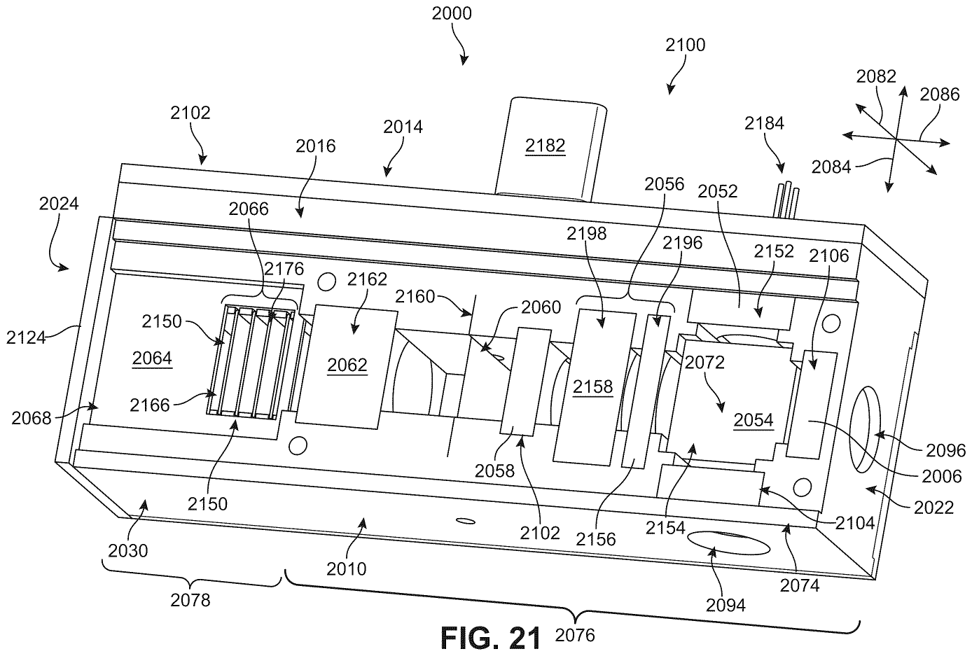

For purposes of illustration, an alternate embodiment of a spectrometer apparatus that can include some or all of the features described above is now presented in FIGS. 20A-31. In FIGS. 20A and 20B, a fourth spectrometer apparatus (“fourth spectrometer”) 2000 is depicted that includes several of the same optical components described earlier with reference to second spectrometer 800 in FIG. 8A and third spectrometer 1100 in FIG. 11. The fourth spectrometer 2000 is also man-portable and compact, being sized and dimensioned with a form factor and weight (e.g., under 50 grams) designed to be held in a human hand or palm on its own, or carried as part of a smartphone/tablet via its click-and-secure connection to the smartphone or tablet device's data transfer port, enabling easy transport and sampling sessions at any location. In other words, the spectrometer is small enough that a person holding and/or carrying their phone in the palm of one hand could also carry the fourth spectrometer 2000 connected to the phone—for example, in the form of a dongle (e.g., linked to the phone via a standard type connector/adaptor 2182 depicted in FIG. 21, protruding from the rearward side 2014). However, as will be discussed below, the fourth spectrometer 2000 can also include one or more components that differ and can significantly enhance its spectral resolution, operable range, and number of spectral channels.

FIGS. 20A and 20B present an introduction to the fourth spectrometer 2000. In FIG. 20A, the fourth spectrometer 2000 is shown fully assembled in a housing 2002 that securely encloses an assembly of components within. In some embodiments, the housing 2002 can include apertures, holes, or other openings to allow data from a sample to be captured via a collection lens, or a laser dump can be installed (e.g., a first opening 2008 and a second opening 2018), etc. In some embodiments, the housing 2002 can include a substantially rectangular prism-shape. In different embodiments, the shape can further include protruding portions such as a first protruding portion 2094 through which the first opening 2008 can be formed with a greater thickness, increasing protection of the lens within and facilitating sample capture, and a second protruding portion 2024 that can improve stability of the device.

For purposes of this application, the fourth spectrometer 2000 and each of its components thereof can be described by reference to a vertical axis 2086, a longitudinal axis 2082, and a lateral axis 2084. The term “longitudinal,” as used throughout this detailed description and in the claims, refers to a direction extending along the length of a component (from the rear of the component to the front), in this case aligned with the longitudinal axis 2082. For example, a longitudinal direction of the fourth spectrometer 2000 extends from a forward side 2010 to a rearward side 2014. The term “forward” or “front” is used to refer to the general direction which lies toward the forward side 2010, and the term “rearward” or “back” is used to refer to the opposite direction, i.e., the direction which lies toward the rearward side 2014. In addition, the term “lateral direction,” as used throughout this detailed description and in the claims, refers to a side-to-side direction extending along the width of a component (i.e., parallel to lateral axis 2084). In this case, the lateral direction may extend between a first side 2016 and a second side 2012 of the fourth spectrometer 2000, with the first side 2016 being disposed on one side of a longitudinal midline, and the second side 2012 being disposed on the opposite side of the same longitudinal midline.

Furthermore, the term “vertical,” as used throughout this detailed description and in the claims, refers to a direction generally perpendicular to both the lateral and longitudinal directions (i.e., aligned with vertical axis 2086). For example, in cases where a component is disposed on a ground surface, the vertical direction may extend from the ground surface upward. It will be understood that each of these directional adjectives may be applied to individual components of the fourth spectrometer 2000. For convenience, the term “upward” will refer to the vertical direction heading away from a ground surface (e.g., if the device were placed on the ground), while the term “downward” refers to the vertical direction heading toward the ground surface. Similarly, the terms “top,” “upper,” and other similar terms refer to the portion of an object substantially furthest from the ground in a vertical direction, and the terms “bottom,” “lower,” and other similar terms refer to the portion of an object substantially closest to the ground in a vertical direction. For example, a vertical direction may extend between a top side 2022 and a bottom side 2024.

For clarity, the description also makes reference to distal and proximal directions (or portions) in the context of the spectrometer and its components. As used herein, the distal direction is a direction oriented away from the center and toward the outermost surface of the housing 2002, while the proximal direction is an opposing direction that is oriented away from the outer housing and toward the center. In addition, the proximal direction can also be referred to as an “inward” direction, and distal direction can be referred to as “outward” direction.

It will be understood that the forward side 2010, rearward side 2014, first side 2016, second side 2012, top side 2022, and bottom side 2024 are only intended for purposes of description and are not intended to demarcate precise regions of the fourth spectrometer 2000 and its components thereof. Likewise, the first side and the second side and/or the top side and bottom side are each intended to represent generally two opposing sides of the spectrometer and each component, rather than precisely demarcating the fourth spectrometer 2000 or its components thereof into halves.

In FIG. 20B, for purposes of clarity, the fourth spectrometer 2000 is depicted without its outermost housing, thereby exposing its interior assembly. In different embodiments, spectrometer components can be mounted or installed within a chassis 2030 that is disposed in an interior space of the housing of the fourth spectrometer 2000. In one embodiment, some of the components can be arranged in a substantially linear or on-axis position relative to one another. In some embodiments, the chassis 2030 includes a substantially rectangular prism shape, including a set of outermost sidewalls 2074 that can substantially enclose or frame each of the top side 2022, forward side 2010, bottom side 2024, and/or rearward side 2014, as well as first side 2016 and second side 2012. In addition, in different embodiments, “behind” the sidewalls and formed in the interior of the chassis 2030 there can be a plurality of slots (“slots”) 2072 or grooved sections or other joinery-type trench cuts, that can each sized and dimensioned to receive a corresponding optical module, described in greater detail below.

As an overview for the reader, the component modules installed in the chassis 2030 are described with reference to FIG. 20B, where a top-down view of the device facing toward the (exposed) second side 2012 is depicted. The full chassis 2030 can in some embodiments include an overall shape that is substantially similar to the shape of the housing. In one embodiment, the chassis 2030 also includes a corresponding chassis protruding portion 2096 that can be snugly fitted into the slightly larger space formed by the protruding portion 2094 of housing 2002 that was shown in FIG. 20A.

In addition, in different embodiments, chassis protruding portion 2096 can include a chassis opening 2094 that is aligned with the first opening 2008 so that a through-hole/transparent passageway between the outside environment and a collection lens (e.g., provided by a first lens module 2004 or a second lens module 2006) can be maintained and light can travel without obstructions between a sample and the collection lens.

In different embodiments, embodiments of the proposed spectrometer can include an optimized internal geometric configuration and assembly to streamline the device and enhance its performance. As shown in FIG. 20B, first lens module 2004 is disposed adjacent to the chassis protruding portion 2096 formed along the forward side 2010. In some embodiments, first lens module 2004 can correspond to the collection lens component. Nearest to the top side 2022, adjacent to a top end 2042 of the chassis 2030, is a second lens module 2006. In addition, opposite to the first lens module 2004, and adjacent to a portion of the sidewall of the chassis 2030 along the rearward side 2014, is a third lens module 2052. Further “down” relative to vertical axis 286 is a fourth lens module 2058.

In different embodiments, each of the four lens modules can include individual lenses that are each secured in their own casing or block. In addition, in some embodiments, each of the four lens modules can be interchangeable with one another. For example, one or more of the lenses of each of first lens module 2004, second lens module 2006, third lens module 2052, and fourth lens module 2058 can include a plano-convex lens (e.g., 8.0 mm diameter×10.0 mm focal length, NIR|Coated). A plano-convex lens is an optical lens with one flat surface (plano) and one outward-curving (convex) surface, giving it a positive focal length that converges parallel light rays to a focal point.

In different embodiments, along an exterior of the chassis 2030, a laser diode (see for example laser diode 2184 in FIG. 21) can be directed through one side of the chassis 2030 (e.g., the rearward side 2014) so that, when activated, a laser can pass through the third lens module 2052, which collimates the laser emission from the diode and then focuses the collimated beam across to the first lens module 2004 (e.g., via beamsplitter 2054 situated centrally or medially between the two components) and into the sample. For example, in different embodiments, the beamsplitter 2054 can be used to split the collimated laser beam between one or more sample testing locations and to reflect the collected Raman signal “downward” toward a pinhole module (“pinhole”) 2060 and onward to optical compartment 2064. In some embodiments, the beamsplitter 2054 can comprise a cube beamsplitter (as shown in the present drawing) or a plate beamsplitter (as shown in earlier figures). In general, cube beamsplitters are constructed using two typically right-angle prisms, where the hypotenuse surface of one prism is coated, and the two prisms are cemented together so that they form a cubic shape. Furthermore, the beamsplitter can be dichroic, or in this case, non-polarizing and configured to split light into a specific R/T ratio while maintaining the incident light's original polarization state.

In some embodiments, the first lens module 2004 then collects or otherwise receives Raman-scattered light from the sample, which is passed back through the dichroic beamsplitter 2054 and re-directed orthogonally to the fourth lens module 2058. The collimated Raman signal can pass or travel through the beamsplitter 2054, which redirects the signal downward toward a filter module 2056 before arriving at a fourth lens module 2058. In one embodiment, the fourth lens module 2058 collimates the collected Raman signal, and then focuses the collimated Raman beam onward toward pinhole module 2060.

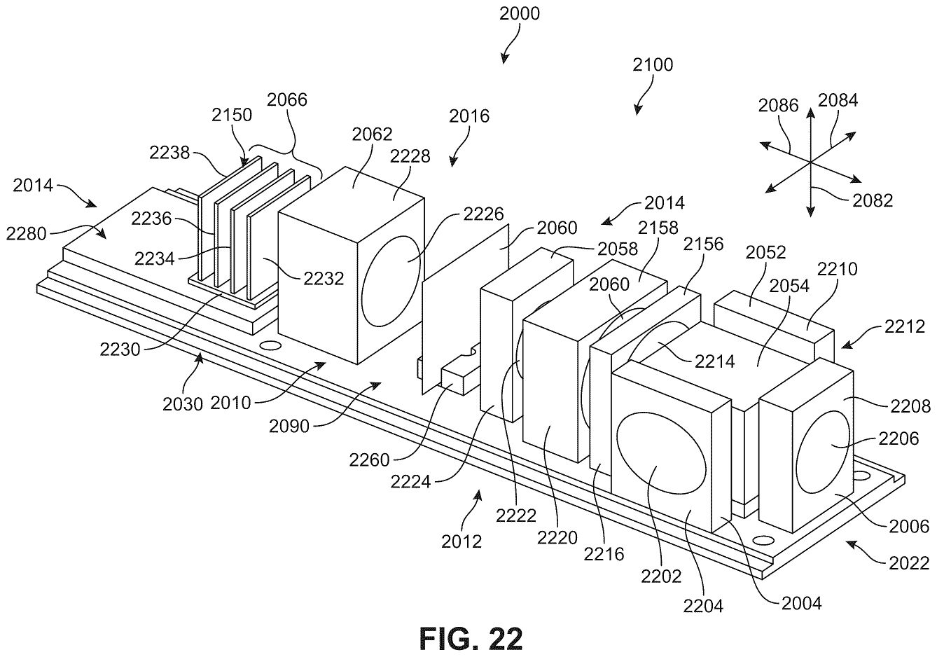

In different embodiments, the second lens module 2004 can serve as a secondary or alternative collection lens site. In other embodiments, the second lens module 2004 can be removed and the site used as a laser dump and/or as a port for a calibration laser. In different embodiments, the Raman-scattered light first passes through a filter module 2056 (e.g., see FIG. 21) that can comprise one or more filters. For example, as depicted in FIG. 22, the filter module 2056 can include two or more separate filters. In FIG. 21, there are two filters, identified as a first filter component 2156 and a second filter component 2158. In some embodiments, the first filter component 2156 can be used to reject ambient visible light and partially attenuate the excitation wavelength by blocking wavelengths below, for example, ˜830 nm, while transmitting Raman signals above ˜850 nm. As a non-limiting example, in one embodiment, first filter component 2156 can include a SCHOTT RG850 Longpass Filter. For example, the filter can include a diameter of or around 12.5 mm and a thickness of or around 2 mm. In one example, the filter includes colored glass. In addition, in different embodiments, the second filter component 2158 can be used to suppress the strong excitation laser signal at 808 nm while allowing the surrounding Raman-shifted wavelengths to pass. As a non-limiting example, in one embodiment, second filter component 2158 can include an 808 nm Notch Filter. In one example, the filter can include a diameter of 12.5 mm, and an average optical density (OD) of around 4.0.

After exiting the filter module 2056 the signal can travel onward and pass through the fourth lens module 2058 before arriving at pinhole module 2060. In one embodiment, the pinhole is positioned at the focal point of the final plano convex lens of fourth lens module 2058 to spatially filter the Raman signal. The pinhole can, for example, block out-of-focus and/or stray light, allowing only the focused Raman signal to pass. The size or diameter of the pinhole may be adjusted to balance signal throughput and optical resolution. In one embodiment, the pinhole has a diameter of approximately 100 μM.

Once the Raman signal passes through the pinhole formed in the pinhole module 2060, in some embodiments, the Raman signal can be received at and pass through an achromatic lens module 2062. In different embodiments, the achromatic lens module 2062 can capture and collimate the transmitted Raman signal while minimizing spherical and chromatic aberrations. In one embodiment, the achromatic lens module 2062 can include a lens of 9 mm diameter×12 mm focal length, NIR II Coated. In some embodiments, the achromatic lens module 2062 ensures a clean, well-collimated beam is outputted and then delivered to the adjacent optical compartment 2064 for spectral dispersion.

As shown in FIG. 20B, in different embodiments, the optical compartment 2064 can be disposed nearest to the bottom side 2024, and include a distal end 2068 that corresponds to the lowermost region of the assembly and will route the light signal to the photo detector or other sensor (e.g., see FIG. 21). In some embodiments, the distal end 2068 is flush with or protrudes slightly out of an opening formed in a bottom of the chassis 2030. In addition, as will be described in greater detail below, the fourth spectrometer 2000 can include one or more metasurfaces (not shown in FIG. 20B) installed in a dispersion unit 2066 formed in the optical compartment 2064. These metasurfaces can serve as the device's dispersive element, and offer an alternative to the grating described earlier.

With the incorporation of these metasurfaces, the proposed embodiments offer a significant technological shift forward from conventional spectrometers. For example, the embodiments described herein can replace costly optical components with engineered metasurfaces that bend and guide light at the nanoscale, eliminating bulk and expense without sacrificing performance. While traditional Raman spectrometers are massive, non-portable, and rely on a delicate alignment of lenses, gratings, and filters—each representing a potential point of failure and high-cost—the proposed devices introduce a metasurface architecture that integrates these functions into a single ultra-thin optical layer, reducing size and weight while boosting durability. Combined with custom built AI-driven noise reduction and spectral interpretation, the fourth spectrometer 2000 can be configured detect target signatures with sub-parts-per-million sensitivity, even in challenging real-world environments like a dusty farm, a humid clinic, or a bustling border crossing. These metasurface-based dispersion units will be discussed in greater detail below.

As demarcated in FIG. 20B, for ease of reference, the “upper” portion of the device that comprises all of the lenses and will be referred to as an optical routing portion 2076 and the remaining “lower” portion of the device (including the optical compartment 2064) will be referred to as the optical dispersive portion 2078. Collectively, the full chassis 2030 along with the interchangeable modules installed in the chassis 2030 will be referred to as a spectrometer assembly (“assembly”) 2100 of the fourth spectrometer 2000. In different embodiments, a kit of parts for the spectrometer can include the assembly 2100 installed in the outer housing, as well as a set of alternate modules that can be swapped for the modules currently slotted in the chassis 2030, and/or one or more modular photo detectors that can be attached to the end of the chassis.

In order to offer greater clarity to the reader, FIG. 21 illustrates a perspective view of the fourth spectrometer 2000. In this drawing, the device has been rotated so that it is primarily the second side 2016 of the device (exposed) is facing toward the reader (rather than the opposing view from the first side 2012 that was shown in FIG. 20B). In addition, for the sake of simplicity, the chassis protruding portion has been removed from sidewall 2074.

In FIG. 21, a portion of laser diode module 2184 as mounted or connected to the device along the rearward side 2014 can be observed. In different embodiments, a laser printed circuit board can be incorporated into the apparatus that is capable of turning the laser on, off, and adjusting the power of the laser, allowing advanced users to fine-tune operational settings for their own purposes. In some embodiments, the apparatus can include an onboard computing device that can run a local AI model for onboard compound identification. The laser diode module 2184 can comprise any of the laser diode instruments, emitters, or arrays, described herein.

In different embodiments, the proposed fourth spectrometer 2000 includes provisions for facilitating assembly of each module into the chassis 2030 as well as promoting the modular removal and replacement of these modules. For example, as noted earlier, chassis 2030 includes multiple slots 2072 of varying sizes, each slot sized and dimensioned to form a space of similar shape and size as a corresponding module.

More specifically, with respect to the components of optical routing portion 2076 shown in FIG. 21, the first lens module 2004 is slid into and received securely and snugly by a first slot 2104, the second lens module 2006 is slid into and received securely and snugly by a second slot 2106, the third lens module 2052 is slid into and received securely and snugly by a third slot 2152, the beamsplitter 2054 is slid into and received securely and snugly by a fourth slot 2154, the first filter component 2156 is slid into and received securely and snugly by a fifth slot 2196 and the second filter component 2158 is slid into and received securely and snugly by a sixth slot 2198, the fourth lens module 2058 is slid into and received securely and snugly by a seventh slot 2102, the pinhole module 2060 is slid into and received securely and snugly by an eighth slot 2160 (in this case, seventh slot 2160 is more of a narrow slit due to the narrow shape of the pinhole plate), and the achromatic lens module 2062 is slid into and received securely and snugly by a ninth slot 2162.

Furthermore, in different embodiments, the optical dispersive portion 2078 of fourth spectrometer 2000 can include provisions for securing and readily removing/replacing/adding individual metasurfaces from/to the device. In different embodiments, the optical compartment 2064 includes the dispersion unit 2066 which serves as a metasurface repository. In one embodiment, the dispersion unit 2066 can include provisions by which to securely hold each metasurface in the correct position. For example, in FIG. 21, a plurality of grooved slots or channels 2176 that extend in a direction aligned with the longitudinal axis 2082 can be seen. Each pair of channels are configured to receive and hold one metasurface. These channels 2176 can be provided in pairs, so that for each metasurface there are two channels, each channel disposed along an opposing side, allowing each plate comprising a metasurface to be easily slid into place and securely oriented in a direction aligned with the longitudinal axis 2082.

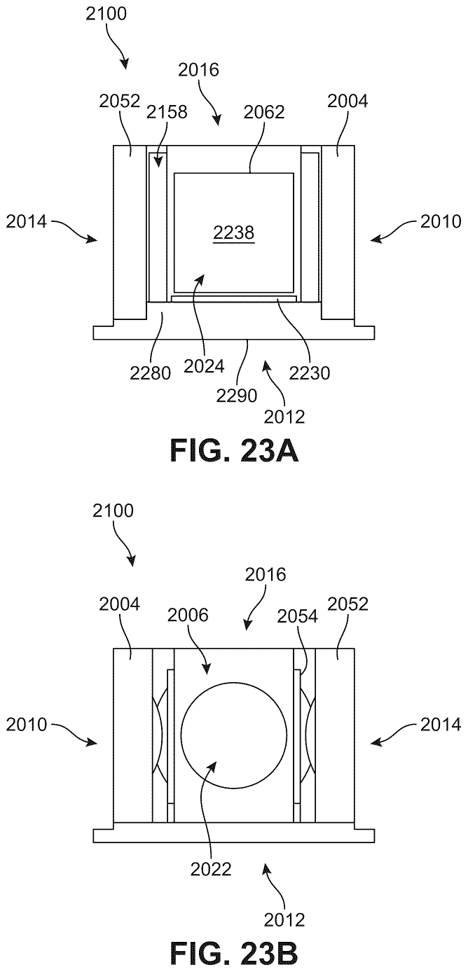

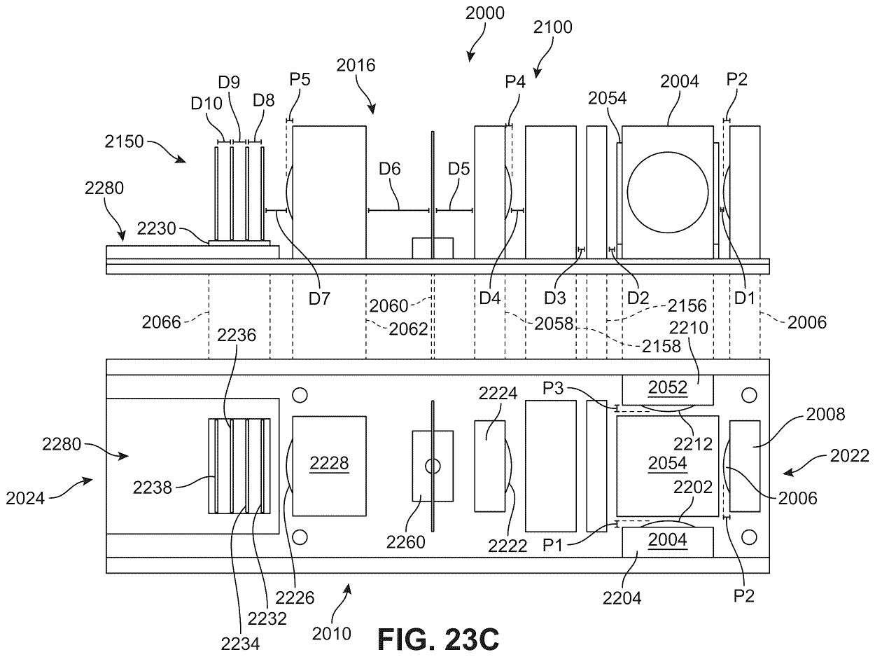

Once installed, one face (the “leading surface”) of each metasurface can be oriented toward the achromatic lens module 2062. in different embodiments, one or more metasurfaces 2150 are further secured in place from below, where the metasurface can drop into a groove formed along the base. Each groove can include a width that is sized and dimensioned to snugly receive the thickness of the metasurface. As shown in the example of FIG. 21, there are four pairs of channels 2176, enabling the installation of four individual metasurfaces 2150 at the desired distance from one another. Thus, between each pair of metasurfaces 2150, there is a gap 2166 to ensure the metasurfaces remained sufficiently spaced apart (e.g., see FIG. 23C) from one another to allow the signal to continue to travel unimpeded through the optical compartment 2064 for optimal dispersion.

In different embodiments, the metasurfaces described herein are used to introduce controlled multiple scattering of the incoming Raman signal and generate unique speckle patterns. The multi-layered disordered metasurfaces (in this case, four) increase dispersion, enhancing spectral resolution across the near-infrared range (850-1100 nm). Each layer can be air-spaced at or around 1.5 mm interval gaps to optimize interference and improve wavelength discrimination (e.g., see FIG. 23B below). A photodetector (not shown) can be mounted on a housing panel 2124 installed on the bottom side 2024. The photodetector's sensor face can be directed into the chamber of the optical compartment 2064, and receive the signal as it passes through the dispersion unit 2066 and exits the opening formed in the distal end 2060 of the optical compartment 2064. In one embodiment, the metasurfaces transform spectral information into spatial speckle features that can be computationally reconstructed into a Raman signal. In some embodiments, the metasurfaces enable sub-nanometer resolution at the on-axis (along the same axis) photo detector (e.g., an IMX462). In some embodiments, one or more of the metasurfaces can include a disordered TiO2-coated metasurface. In one example, a metasurface can be sized with a 9×9 mm BK7 substrate (“plate”).

Moving now to FIG. 22, additional portions of the chassis 2030 have been removed to expose and better illustrate the internal components/modules of the device. As noted earlier, the fourth spectrometer 2000 can include modular manufactured components and a corresponding chassis that form a sophisticated product. These pieces allow the spectrometer to operate using independent, interchangeable “modules” or blocks/units. These modules can be combined in various ways to create different configurations that meet specific needs, allowing for customization, flexibility, and efficiency.

In FIG. 22, these modules (e.g., comprising a lens and a frame or slide) can be observed more clearly by the reader. In some embodiments, the modules can be configured as a block. For example, it can be seen in FIG. 22 that the first lens module 2004 is comprised of a first lens 2202 that has been installed and secured in a first frame 2204, second lens module 2006 is comprised of a second lens 2212 that has been installed and secured in a second frame 2210, third lens module 2052 is comprised of a third lens 2206 that has been installed and secured in a third frame 2208, and fourth lens module 2058 is comprised of a fourth lens 2222 that has been installed and secured in a fourth frame 2224, and the achromatic lens module 2062 is comprised of a fifth lens 2226 that has been installed and secured in a fifth frame 2228.

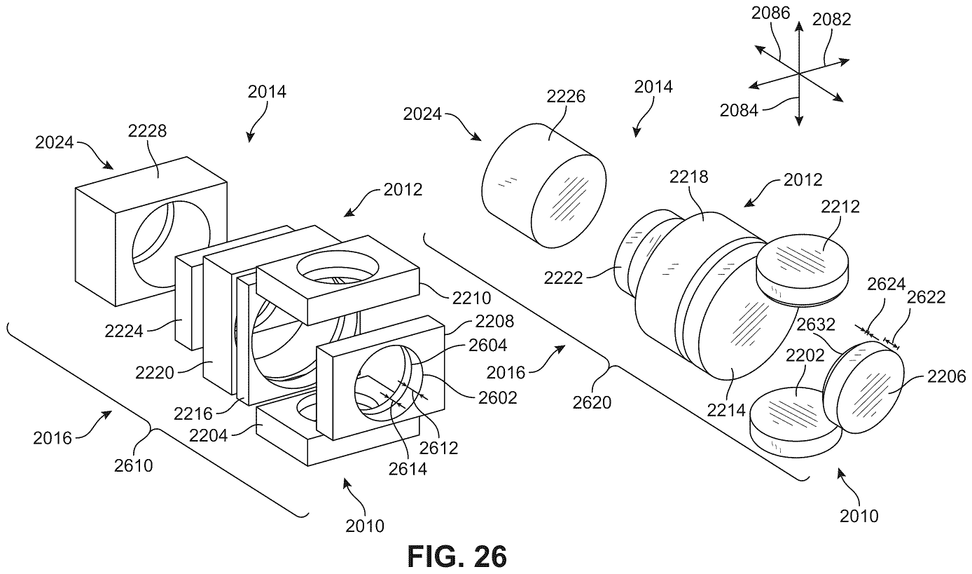

In different embodiments, each of the lens modules can take the form of a “lens block” that can be interchangeable with one another. In addition, each of the lens modules can be removed and replaced by simply sliding the block out of its associated slot and then inserting a new block into the same slot, so that any changes, swaps, repairs, etc. can occur in a few minutes. Once the housing has been removed and the sidewall of the chassis 2030 along the top side 2016, a swap can occur without any additional tools (e.g., replacement using hands/fingers only). Each block is robust and capable of withstanding repeated manual handling. In different embodiments, the device may be associated with or be part of a kit in which a variety of lens modules are included with differing specifications, size, and/or optical characteristics (e.g., collimating, chromatic/achromatic, etc.), allowing a user to readily modify the performance and output of the spectrometer as desired, update to a newer lens block model, or even simply remove a module if a particular block is undesirable. Additional details regarding these modular block units will be provided below with respect to FIG. 26.

In different embodiments, other components installed in the chassis 2030 of fourth spectrometer 2000 can be similarly modular. For example, the beamsplitter 2054 comprises a substantially solid or continuous block that can be dropped into a corresponding slot provided by the chassis 2030. The slot, comprised of a plurality of retaining ridges, can ensure the beamsplitter 2054 is mounted in its correct orientation and position relative to the surrounding lenses and filters.

In addition, the first filter component 2156, which includes a first filter 2214 mounted and secured in a sixth frame 2216, while second filter component 2158 includes a second filter 2218 mounted and secured in a seventh frame 2220. The filter components can also be formed as blocks that can be readily removed and re-slotted and/or replaced by filters with different characteristics as needed by the user for a particular testing scenario.

Similarly, in different embodiments, the pinhole module 2060 includes a plate or panel in which a pinhole is formed. The panel can be slotted and/or snugly installed into a grooved slit of a receiving block 2260 attached/secured to a base portion 2290 of the chassis 2030, where the base portion 2290 corresponds to the sidewall of the chassis 2030 that is provided along its second side 2012. This pinhole module 2060 can also be readily replaced.

Thus, while one assembly (such as assembly 2100) can include the same types of components, by enabling layperson-friendly interchangeability of parts, the user can repeatedly, safely, and on-the-spot (e.g., “outside of a laboratory” or in the field) remove and replace one module with a first set of characteristics with another module with a second (different) set of characteristics. This approach allows the performance of the spectrometer to be dynamically fine-tuned or tweaked to better accommodate the properties of the sample being tested and/or specific requirements of a particular test.

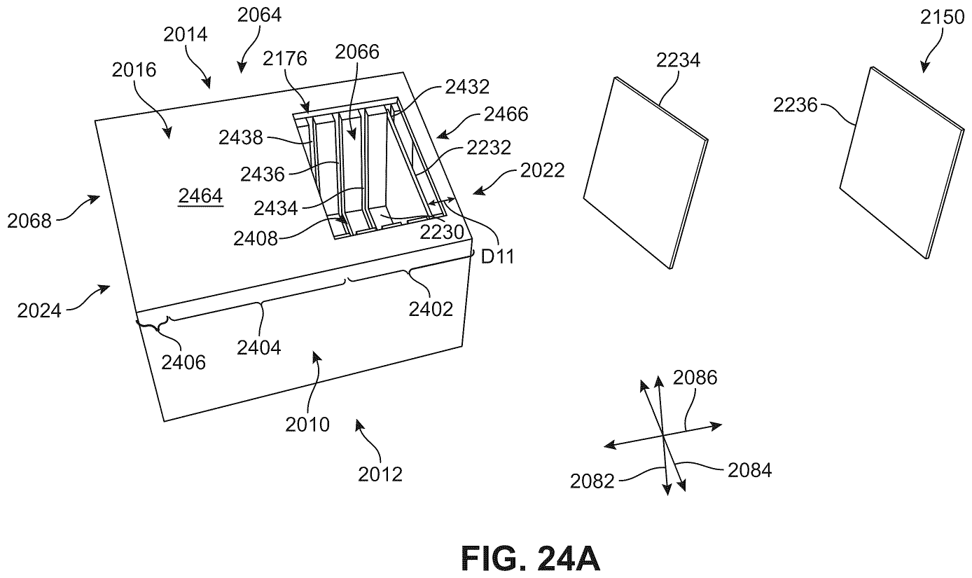

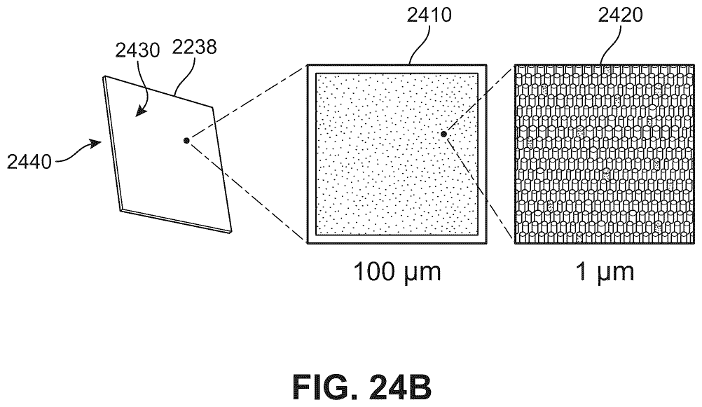

As introduced above, in different embodiments, the dispersion unit 2066 can also include provisions for modular interchangeability of the metasurfaces 2150. In the drawing of FIG. 22, four metasurfaces 2150 are included in the dispersion unit 2066, including a first metasurface 2232, a second metasurface 2234, a third metasurface 2236, and a fourth metasurface 2238. In some embodiments, each metasurface can be slotted into a corresponding groove formed in the thickness of a retaining portion 2230. In addition, each groove can be aligned with and extend between a pair of channels, thereby forming a continuous three-sided slot for receiving and securing individual metasurfaces. In some embodiments, the retaining portion 2230 can be mounted to a larger platform portion 2280 that is attached/secured to the base portion 2290 of the chassis 2030. Additional details regarding the metasurfaces will be provided with reference to FIGS. 24, 25A, and 25B below.

In order to better showcase the relative arrangement of the modules as installed in the chassis 2030, FIGS. 23A, 23B, and 23C depict a series of views of the assembly 2100 taken from different perspectives. In FIG. 23A, a direct bottom-side view is illustrated and in FIG. 23B, a direct top-side view is illustrated, where each of the bottom side 2024 and the top side 2022 represent opposing ends of the assembly 2100.

In the view of FIG. 23A, the metasurfaces 2238 are shown mounted on retaining portion 2230, which is disposed on the platform portion 2280, where the platform portion 2280 is secured to base portion 2290. In this embodiment, behind the metasurfaces 2238 is the achromatic lens module 2062, and behind the achromatic lens module 2062 is the second filter component 2158. Furthermore, the third lens module 2052 is visible, disposed along the rearward side 2014 (left of the metasurfaces 2238), and the first lens module 2004 is visible, disposed along the forward side 2010 (right of the metasurfaces 2238).

From the opposite end, shown in FIG. 23B, the second lens module 2006 can be understood to provide the top-most component of the assembly 2100 (relative to the vertical axis). In this embodiment, the beamsplitter 2054 is visible, disposed behind the second lens module 2006. In addition, the third lens module 2052 is visible, disposed along the rearward side 2014 (right of the second lens module 2006), and the first lens module 2004 is visible, disposed along the forward side 2010 (left of the second lens module 2006).

In FIG. 23C, a side-view more clearly illustrates the relative positioning of each module and the spacings (identified as “distances” herein) between one module with its neighboring modules, with reference to the vertical axis. More specifically, from the most medial portion of the second lens module 2006 (associated with outermost point of the lens as it bulges medially away from its block housing) to a surface of the beamsplitter 2054 there is a first distance D1. In addition, between the beamsplitter 2054 and the first filter component 2156 is a second distance D2. In the embodiment shown in FIG. 23B, D2 is greater than D1; however, in other embodiments, D2 can be substantially similar or equal to D1, or D1 can be greater than D2.

Similarly, between the first filter component 2156 and the second filter component 2158 is a third distance D3. In the embodiment shown in FIG. 23B, D3 is substantially similar or equal to D2; however, in other embodiments, D3 can be greater than D2, or D3 can be less than D2. Furthermore, between the second filter component 2158 and the fourth lens module 2058 is a fourth distance D4. In the embodiment shown in FIG. 23B, D4 is greater than D3; however, in other embodiments, D3 can be substantially similar or equal to D3, or D4 can be less than D3. Between the fourth lens module 2058 and the pinhole module 2060 is a fifth distance D5. In the embodiment shown in FIG. 23B, D5 is greater than D4; however, in other embodiments, D5 can be substantially similar or equal to D4, or D5 can be less than D4. In addition, between the pinhole module 2060 and the achromatic lens module 2062 is a sixth distance D6. In the embodiment shown in FIG. 23B, D6 is greater than D5; however, in other embodiments, D6 can be substantially similar or equal to D5, or D6 can be less than D5. Furthermore, between the achromatic lens module 2062 and the dispersion unit 2066 is a seventh distance D7. In the embodiment shown in FIG. 23B, D7 is less than D6, and also less than D5 or D4. However, in other embodiments, D7 can be substantially similar or equal to or less than D6, D5, D4, D3, and/or D1.

In addition, within the dispersion unit 2066 itself, each metasurface of metasurfaces 2150 can be spaced apart from another neighboring or adjacent metasurface within the set. More specifically, the first metasurface 2232 and the second metasurface 2234 are spaced apart by an eighth distance D8, the second metasurface 2234 and the third metasurface 2236 are spaced apart by a ninth distance D9, and the third metasurface 2236 and the fourth metasurface 2238 are spaced apart by a tenth distance D10. In the embodiment shown in FIG. 23B, each of the distances D8, D9, and D10 are substantially similar or equal. In other embodiments, these distances can differ from one another, so that for example, D8 is greater than or less than D9, D9 is greater than or less than D10, and/or D8 is greater than or less than D10.

In different embodiments, the distances between two metasurfaces and/or a metasurface and the achromatic lens module can be fine-tuned to produce a particular type of speckle pattern by the local device or to improve structural integrity between the components. For example, the distance between the achromatic lens module and the first metasurface can be approximately 2 mm, or at least 1.5 mm. In some embodiments, a minimum distance between each set of two neighboring metasurfaces can be approximately 1.5 mm. In addition, the photo detector (sensor) that will be disposed at the end of the optical compartment can be spaced apart from the final metasurface to minimize spectral interference. It can be appreciated that no additional lens is required to focus the signal onto the photo detector once the signal passes through the metasurfaces. In other words, in different embodiments, there are no additional components disposed between the last (most distal) metasurface disposed nearest to the sensor and the receptor of the sensor.

In different embodiments, the photo detector's receiving area can be sized as large as possible so there is an optimal use of the sensor for increasing or maximining resolution, and/or the number of metasurfaces can be greater, thereby increasing spectral resolution and accuracy. In some embodiments, compensation for intensity loss for spectral dissipation can include increasing exposure time (e.g., ten seconds versus five seconds). In one example, the proposed quadruple-layer metasurface assembly enables a spectral resolution over nearly every one of the wave numbers (e.g., over 80-90%), and in some cases to a thousandth of a wave number.

The proposed on-sensor configuration, consisting of the dispersive element (e.g., quadruple-layer disordered metasurfaces) accompanied by an on-axis image sensor, helps achieve robust spectrum reconstruction performance in a cost-effective manner. As one non-limiting example, in contrast to the capacity associated with conventional spectrometer (e.g., 1080×1920) which are limited to 1920 maximum points (because the grating breaks it up into a linear map), the metasurface approach described herein can take the 1920 points of measurability (i.e., those wavelengths and the intensity) and multiply it by 1080. This results in 2,073,600 points of reference, or three orders of magnitude (1000-fold) greater increase in information that can now be captured, even while continuing to measure the individual levels of intensity for each one of those pixels.

The drawings of FIG. 23C also allow the reader a better perspective from which to observe how, in different embodiments, the convex lens installed in each block protrudes or bulges outward relative to the periphery of the block. For example, in FIG. 23C, which presents the side-view of the assembly 2100 as well as a top-down view of the first side 2016 of the assembly 2100, the first lens 2202 protrudes outward (medial direction) from its first frame 2204 by a distance P1, the second lens 2206 protrudes outward (medial direction) from its second frame 2208 by a distance P2, the third lens 2212 protrudes outward (medial direction) from its third frame 2210 by a distance P3, the fourth lens 2222 protrudes outward (top-wise direction) from its fourth frame 2224 by a distance P4, and the fifth lens 2226 protrudes outward (bottom-side direction) from its fifth frame 2228 by a distance P5.

It can be appreciated that slots will be manufactured in the chassis that ensure the modules are inserted in the correct or desired spacing/distances between one another. In other words, each slot is carefully manufactured and placed to ensure the modules are oriented correctly when the user drops them in. It should further be appreciated that the distance by which a lens extends outward can contribute to its relative distance from a neighboring module, and in different embodiments, this will be accounted for when designing and manufacturing the slots in each location along the chassis. In some embodiments, this is because the slot geometry will generally be sized and dimensioned to receive a particular block size, regardless of whether the lens bulges outward from either side. In other words, when designing and manufacturing the chassis and its slot arrangement, each slot's relative position along the base portion and its distance to a neighboring slot can be adjusted to accommodate variations in the selected lens shapes and sizes, and more specifically to account for the extent or distance that a lens will bulge outward relative to the block in which it is secured, to help ensure the desired target optical characteristics/focal length, spectral resolution, and wavelength discrimination are achieved. Thus, in some embodiments, the chassis may be longer along the vertical axis to accommodate a greater distance between slots.

FIGS. 24A and 24B offer further detail regarding the metasurfaces described herein. In FIG. 24A, an isolated view of the optical compartment 2064 is shown. In some embodiments, the optical compartment 2064 can include a plurality of substantially planar surfaces or sidewalls that collectively form a shape of a rectangular prism. In different embodiments, the interior of the compartment can be mostly or completely hollow and both the proximal end and the distal end include openings that allow clear, unobstructed access into and out of the hollow interior.

For reference, the optical compartment 2064 can include a first region 2402, a second region 2404, and a third region 2406. When installed in the chassis, the first region 2402 is most medial, the third region 2406 the most distal, while the second region 2404 extends between the first region 2402 and the third region 2406. In this embodiment, the first region 2402 corresponds to the part or portion of the compartment where the dispersion unit 2066 is formed, while the distal most end of the third region 2406 can be where a sensor may be disposed/mounted (e.g., image sensor, CMOS sensor, or other sensor that can receive the signal that travels through the metasurfaces and from which speckle measurements can be obtained). The portion of the optical compartment 2064 that is most medial can be seen to include an opening or port 2466 that allows light signals to travel from the achromatic lens module and pass into the interior of the compartment where the metasurfaces are installed.

For purposes of illustration, the dispersion unit 2066 shown in FIG. 24A includes capacity for holding four metasurfaces. As noted above, the dispersion unit 2066 includes pairs of channels 2176 formed in at least two sidewalls of the optical compartment 2064, as well as a groove running along the bottom. Each pair of channels and associated groove can receive one metasurface. In other words, a first peripheral edge of the metasurface can be slid into or snugly received by a first channel formed along a first sidewall, and a second peripheral edge (on the opposite side from the first peripheral edge) can be slid into or snugly received by a first channel formed along a second sidewall that is opposite to and faces the first sidewall. Furthermore, a third peripheral edge running orthogonally between the first peripheral edge and the second peripheral edge can be slid into or snugly received by a groove formed in the retaining portion below.

In this drawing, second metasurface 2234, third metasurface 2236, and fourth metasurface 2238 (see FIG. 24B) have been removed from the compartment to better reveal the interior configuration of the optical compartment 2064. More specifically, in this example, there is a first pair of channels 2432 (currently holding the first metasurface 2232), as well as a second pair of channels 2434 configured to receive a metasurface, a third pair of channels 2436 configured to receive metasurface, and a fourth pair of channels 2438 configured to receive a metasurface. A set of parallel grooves (which can be oriented along the longitudinal axis 2082) running across the width of the retaining portion 2230 at the bottom connect or join together each of the two channels in a pair to one another, and can be seen in this drawing (e.g., a first groove 2408).

As noted earlier, in different embodiments, the number of metasurfaces can be changed and/or individual metasurfaces removed and/or replaced. In one embodiment, this can be accomplished simply by increasing or reducing the number of metasurfaces in the dispersion unit 2066. However, in some cases additional metasurfaces (greater than four) may be desirable. In such instances, the optical compartment can be manufactured or modified so that some or all of the second region 2404 can be merged with the first region 2402, and the retaining portion 2230 extended or elongated. Additional channels and grooves can be formed in this expanded section for receiving a greater number of metasurfaces. In other words, the second region 2404 can serve as a reserved area set aside in the case that more metasurfaces are to be added to the dispersion unit 2066. In some embodiments, this expansion of the dispersion unit 2066 can take up to the entire volume of the second region 2404. However, it should be understood that in different embodiments, the third region 2406 may remain empty or cannot be adapted for metasurface installation/expansion of the dispersion unit 2066, due to the need for a minimum spacing between the sensor and the most distally placed metasurface so that a signal can be captured by the sensor.

Furthermore, in different embodiments, the distance between the first metasurface 2232 and the achromatic lens module can be larger than the seventh distance D7 (see FIG. 23A), due to the additional spacing provided within the optical compartment 2064 from its port 2466 to the first metasurface 2232.

In order to better illustrate some of the features and performance characteristics associated with metasurfaces, FIG. 24B presents an isolated view of the fourth metasurface 2238. More specifically, the fourth metasurface 2238 includes a medial side 2430 that receives incoming light signals from the lenses, and an opposing or opposite-facing distal side 2440 from which the light signal is passed onward toward the sensor. To better appreciate the scale of the disordered structure formed on the medial side 2430, a first section of the medial side 2430 is shown at a first magnification level 2410, and a smaller second section taken from within the first section is shown at a second magnification level 2420, revealing an array of fabricated perturbations and disorder (“nanopost array”). It should be appreciated that in different embodiments, only one side (in this case, the medial side 2430) includes these disordered physical characteristics (e.g., an array of nanoposts), while the opposite side (in this case, the distal side 2440) can remain substantially smooth or lack such perturbations. In other words, only the very leading surface of a metasurface can include a disordered coating (e.g., of titanium dioxide), but not the back surface.

Within these magnified views, the disordered attributes of the metasurface become more apparent. In different embodiments, the disordered metasurfaces can serve as a spatio-spectral mixer, providing a versatile and complex mapping characteristic of high spectral sensitivity within a small footprint (e.g., 1 cm). By incorporating at least two of these metasurfaces into the optical system (thereby forming a “double-layer” or “stacked” arrangement of disordered metasurfaces), the system can provide two features: (a) predictability and (b) definitive mapping. The spectral response of the double-layer (or triple, quadruple, quintuple, and more, etc.) disordered metasurfaces may be seemingly random but they remain uniquely and accurately describable on the basis of the preconfigured design of disordered meta-atoms and a set of configurational parameters.

Additional details and features of the multi-layer disordered multisurfaces and reconstructive spectrometric techniques can be found in Dong-gu Lee et al., Reconstructive spectrometer using double-layer disordered metasurfaces. Sci. Adv.11, eadv2376(2025) (DOI:10.1126/sciadv.adv2376) which is incorporated by reference herein in its entirety.

In different embodiments, using a multi-layered metasurface configuration to form a thin, forward-scattering medium for spectral-to-spatial mapping allows what might otherwise be a prohibitive calibration process to be relatively simplified on the basis of a chromato-axial memory effect where the same speckle pattern magnifies or demagnifies depending on the incoming wavelength. Thus, unlike conventional spectrometers that rely on a one-to-one mapping where each sensor element directly measures the intensity of a specific spectral band, the fourth spectrometer can incorporate a reconstructive approach involving a complex spectral-to-spatial mapping where the entire spectral information is sampled with a sensor array on a random basis and is subsequently decoded on the basis of the linear mapping relation.

In other words, the engineering domain of the disordered metasurface platform can be extended into the spatio-spectral domain, resolving the major challenges of conventional reconstructive spectrometers (e.g., the need for exhaustive calibration of output speckles for all independent spectral inputs). With the proposed arrangement of two or more metasurfaces, the characterization of absolute incoming wavelength and the reconstruction of continuous spectra can be achieved by feeding the output to an AI reconstruction module (e.g., running on an on-site or local mobile computing device) that can search/recognize a specific speckle pattern regardless of the constituent wavelengths of those individual speckle patterns. In different embodiments, because the disorder associated with each of the four (or more) metasurfaces will be random and different, there will be an AI-based customized calibration process performed for the individual spectrometer. The AI reconstruction module allows for the outputs from each individual spectrometer device—with its inherently different lens structure and metasurface dispersal—to be independently calibrated (i.e., AI-based local “self-calibration”). In one embodiment, an AI model of the AI reconstruction module can teach itself to recognize the speckle patterns being produced at the particular device. Furthermore, if at any point one or more modular components are replaced, one or more metasurface are removed, or additional metasurfaces added, an AI engine can automatically perform a recalibration to adapt to the impact on the speckle patterns and ensure they continue to be correctly recognized. This calibration can thereby be readily performed by a layperson, in the field, without any calibration experience.

In some embodiments, the calibration process can involve using a known pure sample of a certain chemical (such as but not limited to JP1 jet fuel). This pure sample (“reference sample”) can be provided with the device or obtained separately. The pure sample is then tested with the selected device and the collected pattern is calibrated with the identity of the chemical already known (e.g., assigning the speckle pattern generated as JP1 jet fuel). The AI engine can enter a calibration mode where it is understood that the data collected by the device at this time is part of a calibration step, and a pure sample is being used.

It can be appreciated that beyond the marked improvements in spectral resolution, this approach is robust against fabrication imperfections, as well as mechanical and thermal fluctuations. Unlike resonance-based approaches, the location of the correlation peak between the measured and computer-generated speckle maps (i.e., estimated wavelength) remains unaffected by fabrication errors in individual meta-atoms on the scale of tens of nanometers. In addition, the quadruple-layer (or more) configurations are characterizable with a handful of nondegenerate parameters, enabling seamless incorporation with computational optimization techniques. Unlike conventional spectrometers, which can be associated with ambiguity between free-space distance and incoming wavelength that necessitates frequent calibration of the one-to-one mapping relation between spectral and spatial domains to ensure diffraction-limited performance, the use of stacked disordered multi-layer metasurfaces can eliminate the need for frequent physical calibration of spectrometers that would require additional sources with known wavelengths. Because each device will have inherently different (unique) disordered patterns on each of metasurface in the stack of metasurfaces, the two-dimensional speckle patterns for a given chemical will be different from each other from one device to another, but will be predictable and consistent for each device, and the calibration (via local on-device AI self-teaching algorithms) will thereby be device-specific. No remote library of speckle patterns need be used as a reference, as the resultant speckle patterns and their meaning/chemical correspondence will be bound to the individual device itself.

In different embodiments, the AI reconstruction module can be fed with vast spectral libraries of biological and chemical signatures, and can be trained to transform raw photon scattering into plain-language identifications in seconds, without access to the cloud. While conventional spectrometer equipment typically output a cryptic spectrum for later analysis, the proposed spectrometer offers an instant verdict: for example, whether there is a pathogen present, at what concentration, and whether it is a lethal or non-lethal strain, etc.

For clarity, additional details regarding the metasurfaces and the reconstructive approach are provided by reference to FIGS. 25A and 25B. In these two drawings, the optical dispersive portion 2078 that includes the disordered metasurfaces 2150 and a CMOS sensor is presented in an exploded view. For convenience, only two of the metasurfaces (third metasurface 2236 and fourth metasurface 2238) are shown here, but it should be understood by the ellipses ( . . . ) that additional metasurfaces can be disposed above (e.g., the first metasurface and second metasurface). In this example, the disordered double-layer metasurfaces serve as a random dispersive element that generates wavelength-specific speckle patterns. For example, as a sample is tested using the fourth spectrometer and its light signal is passed through the optical routing portion 2076 of the spectrometer, it can arrive at the optical compartment carrying an as-yet unknown spectrum 2550. The signal can then travel through the random dispersive element corresponding to the spaced apart stack of metasurfaces 2150. The metasurfaces 2150 transform the signal into wavelength-specific speckle patterns, which can be detected and measured by the on-axis sensor (e.g., disposed/installed at the most distal end of the optical compartment and being aligned with the center or main line of the metasurface's distal surface).

In different embodiments, the sensor can comprise of a monochrome photo detector that can offer higher quantum efficiency as well as eliminate ambiguous bare layer interaction within the individual pixels. A monochrome photo detector may be appropriate because the system is configured to look specifically for a particular speckle pattern, regardless of the constituent wavelengths of those individual speckle patterns. In other embodiments, a chromatic photo detector can be used.

In different embodiments, the measured intensity map can thus be represented as the superposition of speckle patterns on the basis of independent spectral channels. For example, in some embodiments, the design of the disordered metasurfaces and the configurational parameters are used to construct a local-device-specific based computer-generated speckle library. In such cases, this custom library cannot be generalized for use by other devices, as it will be based on calibration that occurs at the local device. In some embodiments, this local library can then be subsequently used to reconstruct the spectrum by solving the inverse problem represented as matrix-vector multiplication, i=Ws, where i is the vectorized measured intensity, W is spectral response matrix, and s is the input spectrum.

In some embodiments, a disordered metasurface can be fabricated with silicon nitride (SiNₓ) or other similar material that is used to form nanoposts of randomized widths across one surface, with associated phase delay values ranging from 0 to 2π at the design wavelength (e.g., 532 nm). As a non-limiting example, fabrication can begin where, on one side of the substrate, a pattern is formed on a fused silica substrate by transferring the pattern using photolithography and lift-off techniques (e.g., with layers of 10 nm Cr and 100 nm Au). A 60-nm-thick aluminum oxide (Al₂O₃) layer is deposited onto a fused silica substrate through e-beam evaporation. The resist can then be stripped using resist remover. The resulting Al₂O₃ pattern on SiNₓ can be transformed into a SiNₓ nanopost array by inductively coupled plasma reactive ion etching (ICP-RIE) using a mixture of C₄F₈ and SF₆ gases. The residual Al₂O₃ mask can be removed using a mixture of NH₄OH and H₂O₂. In some embodiments, to configure multi-layer metasurfaces, the space between each metasurface substrate and the next can be filled with 3D-printed spacer molds and fixed using ultraviolet-cured resin. In other embodiments, the channels formed in the sidewalls and grooves formed in the retaining portion for receiving each metasurface can be sufficient to hold and fix the metasurfaces in the target configuration.

When stacking two metasurfaces in front of an image sensor, there are two major variables, T and L, the thickness of the random dispersive element composed of the two metasurfaces and the element-to-sensor distance, respectively. Those two variables determine the spectral resolution, δλ, and the sampling condition for speckles in conjunction with the additional variables such as the aperture size of disordered metasurfaces, D, and the pixel size of the image sensor, Δp. A disordered metasurface can be considered as a random spatial mixer that simultaneously generates many plane wave components within a confined spatial frequency range. Because of the angular dispersion effect, the interfering plane waves with random phases generate a wavelength-dependent speckle pattern when given sufficient propagation distance. Then, the spectral resolution, δλ, can be defined as the full-width at half maximum (FWHM) of the spectral correlation profile for the generated speckle patterns. In different embodiments, the speckle output at a specific wavelength and configuration can then be predicted through a parameterized wave propagation model, as shown in FIG. 25B.

Additional information regarding the use of modular blocks for the spectrometer will be now be presented with reference to FIGS. 26, 27, 28, and 29. In FIG. 26, an exploded view of an embodiment of a plurality of frames 2610 that can be installed in a chassis is depicted, alongside an exploded view of an embodiment of a plurality of lenses 2620 that can be mounted in each frame. In FIG. 26, the modularity of the block units can be better appreciated, here comprising discrete two-piece components (i.e., where the lens is mounted within and retained by a protective frame).

For example, in FIG. 26, an interior surface of a tunnel 2602 formed in the second frame 2208 can be observed. In different embodiments, the tunnel 2602 is sized and dimensioned to snugly receive a lens. In some embodiments, the interior can include a lens plano body sleeve portion 2612 and a convex lens retaining portion 2614. Between the two portions can be a retaining rim 2604 that extends around the circumference of the interior of the tunnel. The retaining rim 2604 can slightly reduce the size of the tunnel by providing a ridge that extends radially-inward, and is configured to prevent the plano body portion of the lens from moving further out of the tunnel 2602 once it is slide into the tunnel, while at the same time permitting the convex portion to bulge outward from the other side of the tunnel.

For example, the corresponding lens for the second frame 2208, shown here as the second lens 2206, can include a plano body portion 2622 and a bulging convex portion 2624 joined along an intermediate zone 2632. When inserted into the tunnel 2602 from the end that is facing top side 2022, the entire lens can move or be pushed in a direction aligned with vertical axis 2086 (toward bottom side 2024) until the intermediate zone 2632 (signaling the transition point between the convex portion 2624 and the plano body portion 2622) contacts the retaining rim 2604, which stops further movement in that direction and holds the lens in place.

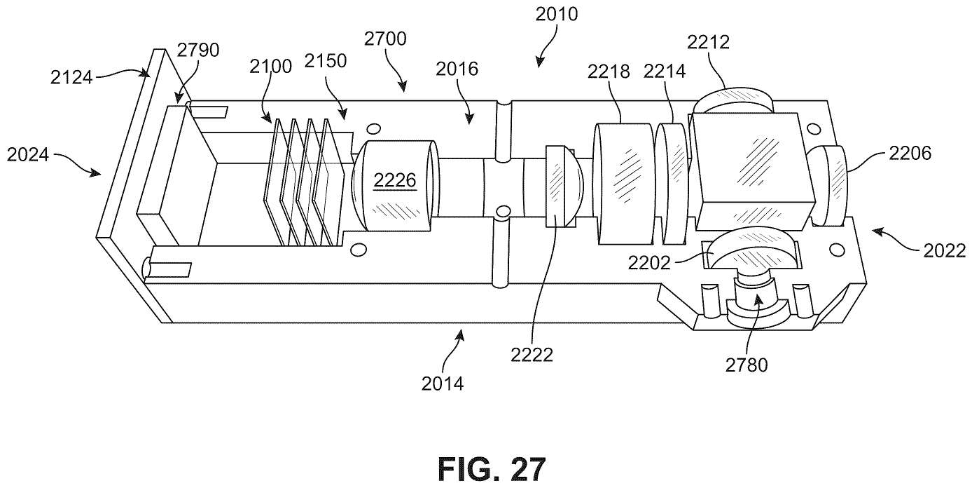

For clarity, FIG. 27 presents an example of an assembly 2700 in which only the lenses are shown in their associated slots that are formed in the chassis 2010. In other words, for each module, the outermost frame has been removed to reveal the lens that is mounted within. In different embodiments, these components are formed only of glass, as represented by the series of lines drawn across the surfaces of the components. In other embodiments, the components can include another monolithic or polymer optical lens material. In this view, the housing panel 2124 to which an embodiment of a photodetector 2790 is mounted can also be observed, as well as a portion of a laser diode receiving compartment 2780.

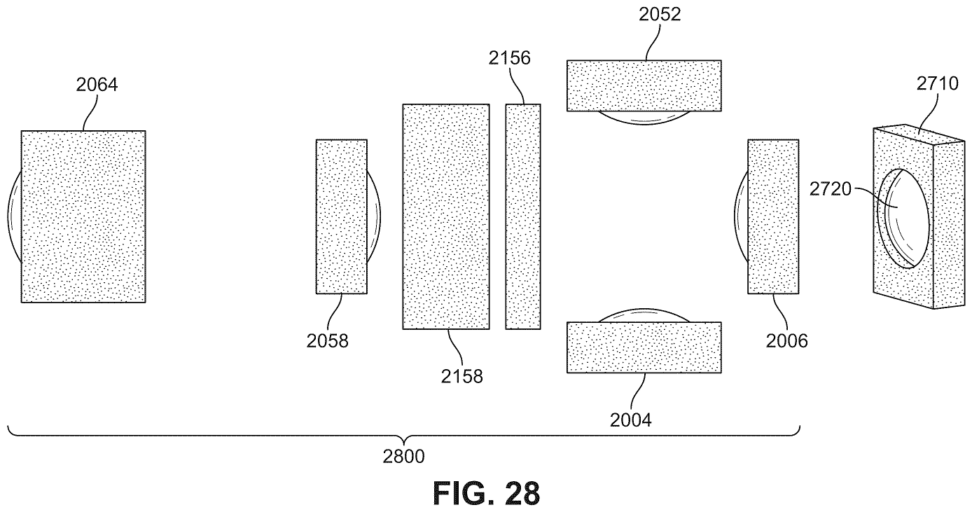

Thus, as shown in FIG. 28, a first group 2700 of block units can be installed in a chassis, where each block unit comprises of an outer frame 2710 and a lens 2720 that has been mounted inside of the frame 2710. The outer frame 2710 and the lens 2720 can be comprised of two different materials (e.g., glass in the lens and non-glass in the frame).

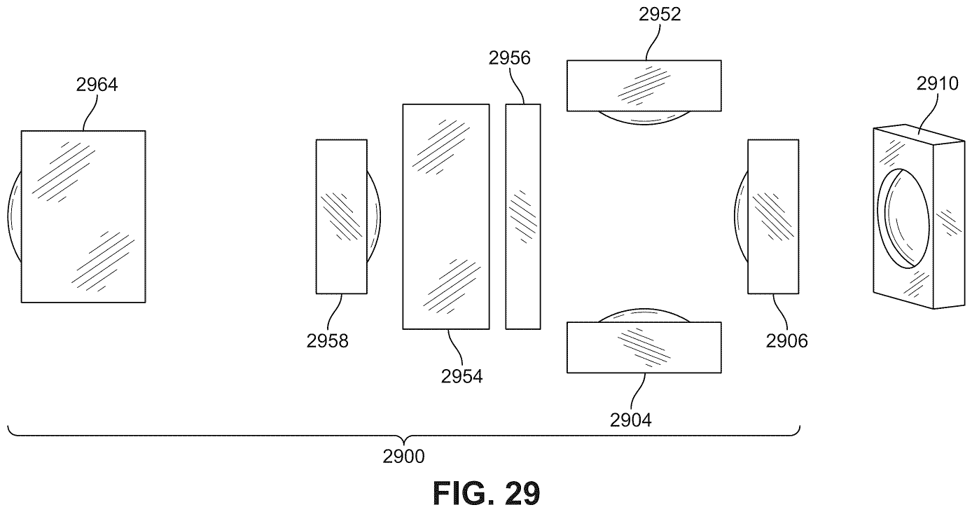

It can be appreciated that in some embodiments, the manufacture of a two-piece unit may be more complex than that of a one-piece unit. In some embodiments, the spectrometer can alternatively include modular units that are formed as monolithic objects. In other words, the entire module can be manufactured as a single, continuous, unbroken object comprising only one type of material. This material can be the same material that is used in making the desired lens (e.g., glass). In such cases, as shown in FIG. 29, the assembly for a modular spectrometer can include a chassis as described herein but with a different, second group 2900 of module blocks. In different embodiments, these modules can be installed in the same chassis and offer the same functionality as the first group 2800 of FIG. 28, with significantly less cost and complexity in their manufacture. Furthermore, the precision associated with each unit can be increased as there is no longer a mechanical insertion process of the lens into the frame, the retaining rim will no longer be required, and the size and dimensions of the convex portion relative to the plano portion and where they meet can be built with much more exacting specification.

For example, in different embodiments, each full or complete block unit/module can instead be made of a single, solid, seamless piece 2810, comprising the same material (such as, but not limited to, glass or polycarbonate). In different embodiments, each of a first monolithic lens module 2904, second monolithic lens module 2906, third monolithic lens module 2952, fourth monolithic lens module 2958, monolithic achromatic lens module 2964, first monolithic filter component 2956, and second monolithic filter component 2954 can be used interchangeably with the blocks of the first group 2700 in the same chassis. In one embodiment, the assembly of the device can include a step of simply dropping, inserting, or sliding each of these monolithic modules into their associated respective slot formed in the chassis as a set of whole, solid, continuous, and/or one-piece units.

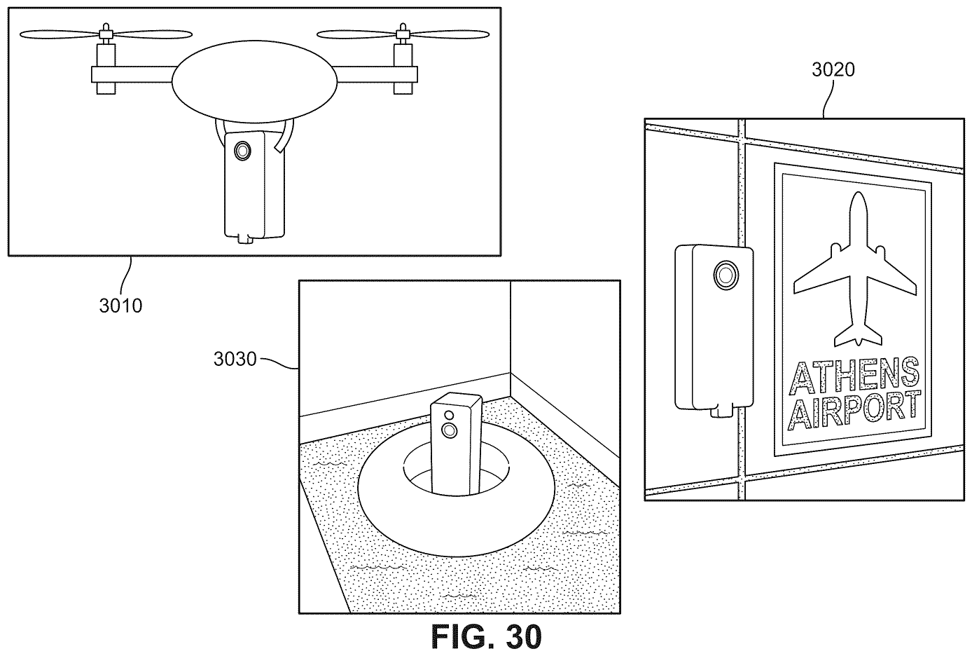

Turning to FIG. 30, in order to offer a broader context to the reader, several use-case scenarios employing an embodiment of the spectrometer described herein are depicted. A first example 3010 shows how the spectrometer, with an embedded AI system, is both lightweight and small enough to be mounted on and transported by medium or large (e.g., 5-7 inches) drones that can then travel to dangerous areas to perform testing or other environmental monitoring. A second example 3020 shows how the spectrometer can serve as wall-mounted sentinels, such as in hospitals and transportation hubs, for continuous monitoring of airborne pathogens, enabling detection of outbreaks before symptomatic cases present. Such a sentinel can be compact and easy to mount and/or remove from the wall. A third example 3030 depicts a spectrometer that has been placed in a sewer for bio-surveillance. In still other examples, the spectrometer can be integrated into water-testing stations for continuous monitoring of pathogens and toxins in drinking water, and deep-sea gas monitoring. In another example, the spectrometer may be handheld and carried by health workers for rapid pathogen identification at point-of-care and/or rapid differentiation of bacterial strains. In some cases, the spectrometer may be handheld and carried by agriculturists or food health and safety personnel to perform non-destructive detection of any contaminants and pesticide residues.

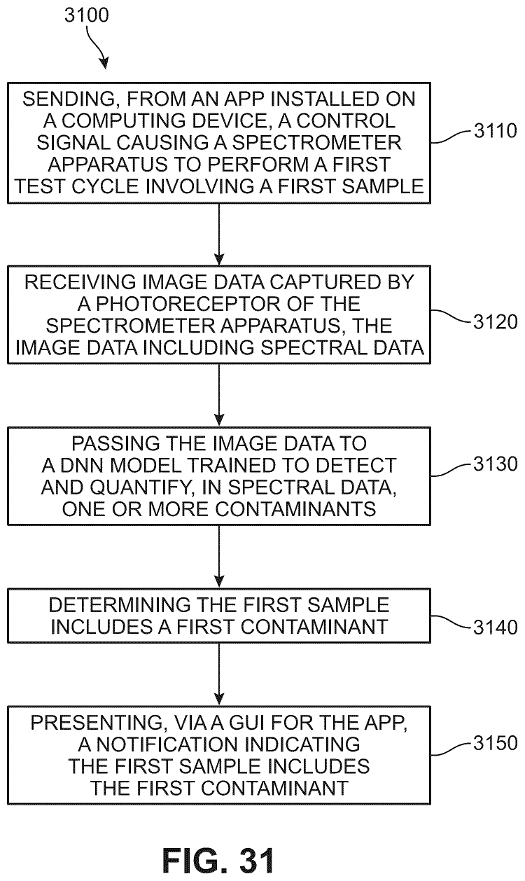

FIG. 31 is a flow chart illustrating an embodiment of a method 3100 of detecting contaminants in a chemical sample. The method 3100 includes a first step 3110 of sending, from a chemical analysis application (“app”) installed on a mobile computing device, a control signal to a handheld spectrometer apparatus connected to the mobile computing device that causes the spectrometer apparatus to perform a first test cycle involving a first sample. A second step 3120 includes receiving, at the app and from the spectrometer apparatus, first image data captured by a photoreceptor of the spectrometer apparatus, the first image data including spectral data for the first sample. In a third step 3130, the method includes passing the first image data to a deep neural network (DNN) model that is trained to detect and quantify, in spectral data, one or more contaminants of a plurality of potential contaminants. In different embodiments, these potential contaminants can include Polyalphaolefin (PAO), sulfur compound(s), synthetic fuel additive(s), hydraulic fluid(s), and microbial compound(s). A fourth step 3140 includes determining, via the DNN model and based on the first image data, the first sample includes a first contaminant, and a fifth step 3150 includes presenting, via a graphical user interface (GUI) for the app, a notification indicating the first sample includes the first contaminant.

In different embodiments, the method 3100 may include additional steps or aspects. In some embodiments, the method also includes receiving, at the app, a first input from a user selecting a first sample profile, wherein the control signal is sent in response to receiving the first input. In another embodiment, the method also includes presenting, via the GUI, a plurality of selectable options, each selectable option identifying a different sample profile, where the first input corresponds to a selection of one of the plurality of selectable options. In some embodiments, determining the first sample includes the first contaminant is based on the user selection of the first sample profile. In one embodiment, the method further includes receiving, at the app, a first input from a user selecting a first sample profile, where selection of a sample profile is used by the app to limit detection to a subset (less than the total that can be tested by the system) of the plurality of potential contaminants. In other words, in some embodiments, the pre-configured profile that is selected by the user defines which contaminants should be flagged if detected in the sample. In another embodiment, the method includes presenting, via the GUI, a spectral graph plotting an intensity of scattered light versus a frequency of light as characterized by the first image data.

As described herein, some of the proposed embodiments can also be understood to include a man-portable apparatus for identification of compounds. The apparatus can include: (a) a housing including a first compartment and a second compartment; (b) a light source that directs light into the first compartment; and (c) an optical system including a dichroic beamsplitter and a collection lens, wherein the collection lens is oriented along a first axis, and the dichroic beamsplitter is oriented along a second axis that is at a 45-degree angle relative to the first axis.

In other embodiments, the apparatus may include additional features, components, or aspects. In some embodiments, the housing further includes a slit portion disposed between the first compartment and the second compartment, and light reflected from the dichroic beamsplitter in the first compartment passes through the slit portion and into the second compartment. In another embodiment, the light source includes a laser diode oriented along a third axis that is at a 45-degree angle relative to the second axis. In different embodiments, the apparatus further includes a grating in the second compartment oriented at an acute angle relative to the third axis. In one embodiment, the apparatus also includes a Raleigh filter installed along a sidewall of the second compartment, where light reflected from the grating passes through the Raleigh filter. In some embodiments, the apparatus further includes a photoreceptor mounted on an exterior of the sidewall of the second compartment adjacent to the Raleigh filter, and the light exiting the Raleigh filter is captured by the photoreceptor. In different embodiments, the apparatus also includes a computer processor that is configured to share image data captured by the photodetector to a mobile computing device. In some embodiments, the apparatus includes a connector element protruding from an exterior of the housing, the connector element being configured to connect the apparatus to a data port of a mobile computing device.

In different embodiments, some of the proposed embodiments can also be understood to include a kit of parts for performing chemical analyses. The kit can include a handheld spectrometer apparatus and a mobile computing device. The spectrometer apparatus can include an optical system comprising a dichroic beamsplitter and a collection lens. In some embodiments, the collection lens is oriented along a first axis, and the dichroic beamsplitter is oriented along a second axis that is at a 45-degree angle relative to the first axis. The spectrometer apparatus can also include a male connector element. In addition, the mobile computing device can include a female data port that is configured to connect to the male connector element and enable communication between the spectrometer apparatus and the mobile computing device.

In other embodiments, the kit of parts may include additional features, components, or aspects. In some embodiments, the kit also includes a chemical analysis software application (“app”) installed on the mobile computing device, the app being configured to receive spectral data for a sample from the spectrometer apparatus and predict chemical properties of the sample based on the spectral data using an artificial intelligence (AI) neural network. In one embodiment, the spectrometer apparatus includes a photoreceptor, and the spectral data is conveyed by images captured by the photoreceptor. In some embodiments, the app includes a Deep Neural Network (DNN) model that is trained to detect contaminants in a test sample based on the image data. In different embodiments, the kit also includes a vial for holding a sample to be tested, and the spectrometer apparatus further includes a cylindrical receptacle that is sized and dimensioned to snugly receive the vial. In some embodiments, the cylindrical receptacle is adjacent to the collection lens, and a center of the vial is disposed at a distance of between 15 mm and 25 mm when the vial is inserted into the receptacle. In different embodiments, the kit can also include a microfluidic slide for holding a sample to be tested, and the spectrometer apparatus further includes a slot that is sized and dimensioned to snugly receive the slide. In some embodiments, the spectrometer apparatus receives power from the mobile computing device when the spectrometer apparatus is connected to the mobile computing device.

In different embodiments, the kit also includes a first modular sample holder that can be removably attached to a first portion of a housing of the spectrometer apparatus adjacent to the collection lens, the first modular sample holder including a first receptacle for receiving a first vial of a first size, and a second modular sample holder that can be removably attached to the first portion of the housing and includes a second receptacle for receiving a second vial of a second size, the first size being smaller than the second size. In other embodiments, the kit includes a first modular sample holder that can be removably attached to a first portion of a housing of the spectrometer apparatus adjacent to the collection lens, the first modular sample holder including a first cylindrical receptacle for receiving a vial; and a second modular sample holder that can be removably attached to the first portion of the housing and includes a second slotted receptacle for receiving a microfluidic slide.

In different embodiments, some of the proposed embodiments can also be understood to include a microfluidic chip for use with a handheld spectrometer apparatus. The microfluidic chip includes (a) a substantially planar substrate; (b) an optical window integrated into the substrate; (c) a filter embedded in a center of the optical window; (d) a sample port formed at a lower end of the substrate; and (e) a plurality of reaction wells etched or molded into the substrate, each reaction well extending independently from the optical window before merging and connecting to the sample port.

In other embodiments, the microfluidic chip may include additional features, components, or aspects. In some embodiments, the optical window is formed with quartz and is configured to enhance a Raman signal for clarity in trace chemical detection by the spectrometer apparatus. In different embodiments, one or more of the reaction wells of the plurality of reaction wells includes colorimetric compounds. In some embodiments, the microfluidic slide causes preprocessing chemical interactions in a sample that enable the spectrometer apparatus to test a sample for one or more of total acid number, viscosity, density, cetane index, distillation fractions, freezing point, flash point, smoke point, cloud point, neat heat of combustion, MSEP rating, copper strip corrosion, thermal oxidation stability, electrical conductivity, existent gum content, fuel lubricity, and/or carbon residue. In different embodiments, the optical window is disposed in a central region of the substrate so that the optical window aligns with a focal point of the spectrometer apparatus when the microfluidic chip is inserted into the spectrometer apparatus.

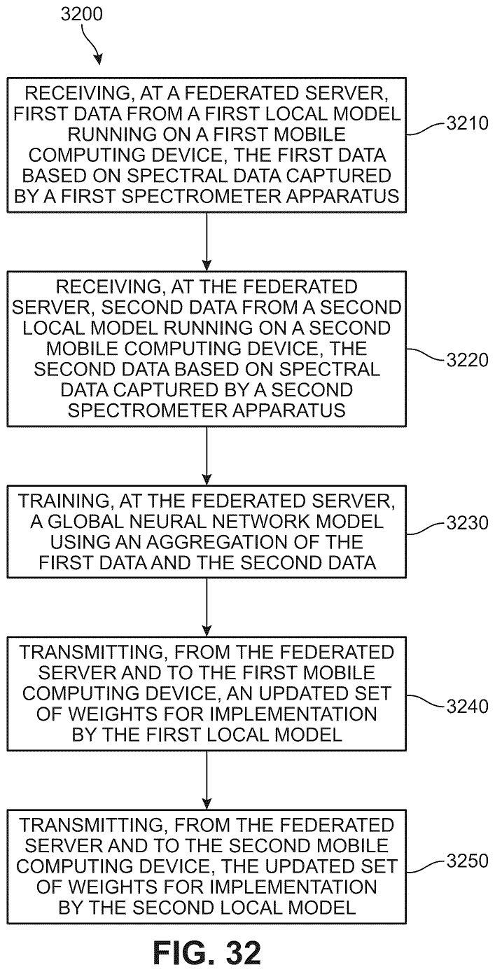

Other methods may be contemplated within the scope of the present disclosure. For example, referring to FIG. 32, in some embodiments, a method 3200 of refining a global neural network model for performing chemical analyses of spectral data is provided. The method can include a first step 3210 of receiving, at a federated server, first data from a first local model running on a first mobile computing device at a first location, the first data generated based on spectral data captured by a first spectrometer apparatus connected to the first mobile computing device. The method 3200 can also include a second step 3220 of receiving, at the federated server, second data from a second local model running on a second mobile computing device at a second location, the second data generated based on spectral data captured by a second spectrometer apparatus connected to the second mobile computing device. A third step 3230 includes training, at the federated server, the global neural network model using an aggregation of the first data and the second data. In addition, a fourth step 3240 includes transmitting, from the federated server and to the first mobile computing device, an updated set of weights for implementation by the first local model. Furthermore, a fifth step 3250 includes transmitting, from the federated server and to the second mobile computing device, the updated set of weights for implementation by the second local model.

In other embodiments, the method may include additional steps or aspects. In some embodiments, the first data includes one or more of gradients, weights, and performance metrics from the first local model. In one embodiment, the first data is anonymized and encrypted at the first local model before transmission to the federated server. In different embodiments, the global neural network model is a deep neural network (DNN) that applies Continuous Wavelet Transformation (CWT) to detect and quantify one or more of Polyalphaolefin (PAO), sulfur compounds, synthetic fuel additives, hydraulic fluid, and microbial contamination in a sample. In some embodiments, the method further includes training the global neural network model using synthesized training data. In different embodiments, generation of the synthesized training data involves converting mass spectrometry (MS) data to Raman spectrometry data. In some embodiments, the synthesized training data is generated via an automated Density Functional Theory (DFT) algorithm that can create artificial Raman spectra. In one embodiment, the global neural network model includes an anomaly detection algorithm for identifying outlier patterns indicating contaminants in jet fuels.

Other methods may be contemplated within the scope of the present disclosure. For example, in some embodiments, a method performing spectral collection and analysis in a field setting is provided. The method can include a first step of connecting a handheld spectrometer apparatus to a mobile computing device, and a second step of connecting a first modular sample holder to the spectrometer apparatus. A third step includes inserting a first vial containing a first sample into an aperture formed in the first modular sample holder, the aperture sized and dimensioned to snugly receive the first vial, and the aperture being disposed adjacent to a collection lens of the spectrometer apparatus. In addition, a fourth step can include initiating, via a chemical analysis software application (“app”) installed on the mobile computing device, a first test cycle, thereby causing the spectrometer apparatus to pass light from a laser diode to a dichroic beamsplitter with a face oriented at a 45-degree excitation angle relative to both the laser diode and the collection lens. Furthermore, a fifth step can include receiving, via a graphical user interface (GUI) provided by the app, a chemical and structural characterization of the first sample.

In other embodiments, the method may include additional steps or aspects. In some embodiments, the method can include: disconnecting the first modular sample holder from the spectrometer apparatus; connecting a second modular sample holder to the spectrometer apparatus; and inserting a first microfluidic chip containing a second sample into a slot formed in the second modular sample holder, the slot sized and dimensioned to snugly receive the first microfluidic chip, and the slot being disposed adjacent to a collection lens of the spectrometer apparatus. In some embodiments, the method can include steps of initiating, via the app, a second test cycle, thereby causing the spectrometer apparatus to pass light from a laser diode to a dichroic beamsplitter with a face oriented at a 45-degree excitation angle relative to both the laser diode and the collection lens; and receiving, via the GUI, a chemical and structural characterization of the second sample.

In different embodiments, the method can include inserting, into a housing of the spectrometer apparatus, a first transmission grating with a first wavelength range for use during the first test cycle. In some embodiments, the method also includes removing the first transmission grating from the spectrometer apparatus; and inserting, into the spectrometer apparatus, a second transmission grating with a second wavelength range for use during the second test cycle, the second wavelength range differing from the first wavelength range. In some embodiments, the method can include selecting, via the app and before the first test cycle, a first fuel profile that targets detection of a first contaminant, wherein any contaminants identified in the chemical and structural characterization of the first sample are based on the selection of the first fuel profile.

In different embodiments, the method can include connecting, to a housing of the spectrometer apparatus, a first photoreceptor with a first quantum efficiency for use during the first test cycle. In some embodiments, the method can further include steps of: removing the first photoreceptor from the spectrometer apparatus; and connecting, to the spectrometer apparatus, a second photoreceptor with a second quantum efficiency for use during the second test cycle, the second quantum efficiency differing from the first quantum efficiency.

In different embodiments, some of the proposed embodiments can also be understood to include a man-portable spectrometer system. The man-portable spectrometer system includes (a) an optical routing portion including a first lens; (b) an optical dispersive portion including a dispersion unit, wherein the dispersion unit is configured to receive an incoming light signal associated with a sample that is routed from the optical routing portion to the optical dispersive portion, and includes a plurality of disordered metasurfaces; (c) a photo detector configured to receive an output of the light signal as a wavelength-dependent speckle pattern as the light signal exits the optical dispersive portion; and (d) an artificial intelligence (AI) spectrum reconstruction model configured to receive the speckle pattern and automatically recognize one or more chemical compounds in the sample based on the speckle pattern.

In other embodiments, the spectrometer system may include additional features, components, or aspects. In some embodiments, the plurality of disordered metasurfaces includes a first metasurface with a proximal surface oriented toward the optical dispersive portion and an opposite-facing distal surface oriented toward the photo detector. In one embodiment, the proximal surface includes a nanopost array of randomized widths that serve as a random spatial mixer for the incoming light signal. In one embodiment, the distal surface of the first metasurface is substantially smooth.

In different embodiments, the optical routing portion includes a first lens that is oriented toward the proximal surface of the first metasurface. In some embodiments, the optical routing portion includes a first filter that is oriented toward the proximal surface of the first metasurface. In one embodiment, the plurality of disordered metasurfaces includes at least three metasurfaces that are on-axis with respect to one another. In some embodiments, the photo detector is on-axis with respect to each metasurface of the plurality of disordered metasurfaces. In different embodiments, the dispersion unit is housed within an optical compartment, the optical compartment includes a first sidewall, and the first sidewall includes a plurality of channels, wherein each channel of the plurality of channels is sized and dimensioned to snugly receive a peripheral edge of one metasurface of the plurality of disordered metasurfaces.

In different embodiments, some of the proposed embodiments can also be understood to include a modular assembly for a spectrometer. The assembly includes (a) a chassis including a plurality of slots, the plurality of slots including a first slot and a second slot; (b) a plurality of interchangeable modules including a first module and a second module, where the first slot is sized and dimensioned to snugly receive the first module and the second slot is sized and dimensioned to snugly receive the second module; and (c) where the first module is one of a lens, an optical compartment, a beamsplitter, a pinhole panel, and a filter.

In other embodiments, the spectrometer system may include additional features, components, or aspects. In some embodiments, the first module and second module are interchangeable with one another, such that the first slot is also sized and dimensioned to snugly receive the second module and the second slot is sized and dimensioned to snugly receive the first module. In another embodiment, the first module includes a lens mounted within an opening formed in a block. In different embodiments, the first module is a monolithic object comprising a glass lens formed within (as part of/integral with) a glass block.

In some other embodiments, the second module is a pinhole panel and the second slot comprises a groove formed within two sides of the chassis that receives two opposing edges of the pinhole panel. In some embodiments, the second slot further comprises a slit formed in a retaining block secured to a base of the chassis, and the slit receives a third edge of the pinhole panel running orthogonal to the two opposing edges. In different embodiments, the first module is the optical compartment, and the optical compartment includes an interior space configured to hold a plurality of disordered metasurfaces. In some embodiments, the plurality of disordered metasurfaces include a first metasurface and a second metasurface, and the interior space includes a first pair of channels and a second pair of channels, and the first pair of channels is sized and dimensioned to snugly receive the first metasurface and the second pair of channels is sized and dimensioned to snugly receive the second metasurface. In different embodiments, the first metasurface and second metasurface are interchangeable with one another, such that the first pair of channels is also sized and dimensioned to snugly receive the second metasurface and the second pair of channels is sized and dimensioned to snugly receive the first metasurface.

In some embodiments, the first module includes a filter mounted within an opening formed in a block. In another embodiment, the first module is a monolithic object comprising a filter formed within a block, and the filter and block are made of the same material

Other methods may be contemplated within the scope of the present disclosure. For example, in some embodiments, a method of performing on-device calibrations of a spectrometer device that includes a plurality of disordered metasurfaces is provided. The method can include a first step of testing a reference sample using the spectrometer device, wherein the reference sample consists of a pre-identified first chemical; a second step of capturing a first speckle pattern via a photo detector of the spectrometer device; and a third step of characterizing, by a local artificial intelligence (AI) spectrum reconstruction engine, the first speckle pattern as representative of the first chemical.

In other embodiments, the method may include additional steps or aspects. In some embodiments, the method can include switching operations of the spectrometer device to its calibration mode before testing the reference sample occurs. In different embodiments, testing of the reference sample further includes operations of: receiving, at an optical routing portion of the spectrometer device, a light signal emitted from the reference sample; and transmitting the light signal from the optical routing portion to an optical dispersive portion that includes the plurality of disordered metasurfaces. In some embodiments, the first speckle pattern is generated as a result of the light signal passing through the plurality of disordered metasurfaces.

In different embodiments, any changes to the modules or elements thereof can require or necessitate a re-calibration session. For example, in different embodiments, where the plurality of disordered metasurfaces is ordered in a first configuration, the method can further include rearranging the plurality of disordered metasurfaces to a different, second configuration; and then (in response to the rearrangement) performing another calibration session by: retesting the reference sample using the spectrometer device; capturing a second speckle pattern via the photo detector; and characterizing, by the local AI spectrum reconstruction engine, the second speckle pattern as representative of the first chemical.

In some embodiments, the plurality of disordered metasurfaces includes a first metasurface, and the method further includes: replacing the first metasurface with a different, second metasurface; and then (in response to replacing any of the metasurfaces with a different metasurface) performing another calibration session by: retesting the reference sample using the spectrometer device; capturing a second speckle pattern via the photo detector; and characterizing, by the local AI spectrum reconstruction engine, the second speckle pattern as representative of the first chemical.

In another embodiment, the plurality of disordered metasurfaces includes three or more metasurfaces, and the method further includes: removing one metasurface from the three or more metasurfaces; and then (in response to removing a metasurface) performing another calibration session by: retesting the reference sample using the spectrometer device; capturing a second speckle pattern via the photo detector; and characterizing, by the local AI spectrum reconstruction engine, the second speckle pattern as representative of the first chemical.

In some embodiments, the method can also include: increasing the number of metasurfaces of the spectrometer device; and then (in response to adding one or more additional metasurfaces) performing another calibration session by: retesting the reference sample using the spectrometer device; capturing a second speckle pattern via the photo detector; and characterizing, by the local AI spectrum reconstruction engine, the second speckle pattern as representative of the first chemical. Thus, with each change, the output from the dispersion unit will shift, and local calibration must be performed again for the device to ensure the test results continue to be correctly characterized by the AI model.

As described herein, the proposed systems, kits, methods, and apparatuses are configured to offer optimized real-time analysis capabilities through advanced signal processing techniques, including multivariate chemometric modeling and machine learning algorithms. The implementation of sensor fusion in the system provides a complementary approach, where the use of GC enables hydrocarbon separation and quantification, and Raman spectroscopy enables rapid molecular identification. By integrating these techniques with CWT signal processing and AI-based analytical techniques, the systems will mitigate environmental noise, improve detection limits, and facilitate real-time American Society for Testing and Materials (ASTM) International-compliant fuel analysis. By manifesting the system as a compact, field-deployable system capable of real-time fuel and propellant analysis in challenging operational environments, laymen will be able to perform rapid, accurate assessments of critical chemical properties, including sulfur content, cetane number, water contamination, and molecular composition. In cases where aircraft and other fuel-propelled vehicles are to be monitored, this field portable device can significantly enhance mission readiness by eliminating the delays associated with laboratory-based testing, which often require extensive logistical support, or other conventional testing equipment which are bulky, complex, and limited in their analytical capabilities.

Furthermore, in different embodiments, the proposed devices can incorporate a modular system for performing spectroscopy, including interchangeable “blocks” that can be dropped into corresponding slots formed in the housing, and in some cases using monolithic lens-only “glass blocks” (no outer casing) for insertion into a device, helping to overcome significant manufacturing challenges that may be otherwise associated with the production of the device.

By enabling ASTM-compliant, real-time testing in the field, the system will mitigate risks associated with fuel contamination and quality failures, enhancing both safety and operational success. The device will also yield significant cost savings by reducing reliance on centralized laboratory testing and streamlining logistics. Expanded capabilities will also include measurements such as total acid number, viscosity, density, cetane index, distillation fractions, freezing point, flash point, smoke point, cloud point, neat heat of combustion, MSEP rating, copper strip corrosion, thermal oxidation stability, electrical conductivity, existent gum content, fuel lubricity, and carbon residue. These expansions will build on the same core principles while integrating new technologies to enhance analytical versatility.

It is to be appreciated that methods in accordance with the present disclosure can include any combination of the aspects and features described herein. That is, methods and systems in accordance with the present disclosure are not limited to the combinations of aspects and features specifically described herein, but also include any combination of the aspects and features provided.

Throughout this application, an “interface” may be understood to refer to a mechanism for communicating content through a client application to an application user. In some examples, interfaces may include pop-up windows that may be presented to a user via native application user interfaces (UIs), controls, actuatable interfaces, interactive buttons or other objects that may be shown to a user through native application UIs, as well as mechanisms that are native to a particular application for presenting associated content with those native controls. In addition, the terms “actuation” or “actuation event” refers to an event (or specific sequence of events) associated with a particular input or use of an application via an interface, which can trigger a change in the display of the application. This can include selections or other user interactions with the application, such as a selection of an option offered via a native control, or a ‘click’, toggle, voice command, or other input actions (such as a mouse left-button or right-button click, a touchscreen tap, a selection of data, or other input types). Furthermore, a “native control” refers to a mechanism for communicating content through a client application to an application user. For example, native controls may include actuatable or selectable options or “buttons” that may be presented to a user via native application UIs, touch-screen access points, menus items, or other objects that may be shown to a user through native application UIs, segments of a larger interface, as well as mechanisms that are native to a particular application for presenting associated content with those native controls. The term “asset” refers to content that may be presented in association with a native control in a native application. As some non-limiting examples, an asset may include text in an actuatable pop-up window, audio associated with the interactive click of a button or other native application object, video associated with a teaching/tutorial user interface, or other such information presentation.

The processes and methods of the embodiments described in this detailed description and shown in the figures can be implemented using any kind of computing system having one or more central processing units (CPUs) and/or graphics processing units (GPUs). The processes and methods of the embodiments could also be implemented using special purpose circuitry such as an application specific integrated circuit (ASIC). The processes and methods of the embodiments may also be implemented on computing systems including read only memory (ROM) and/or random access memory (RAM), which may be connected to one or more processing units. Examples of computing systems and devices include, but are not limited to: servers, cellular phones, smart phones, tablet computers, notebook computers, e-book readers, laptop or desktop computers, all-in-one computers, as well as various kinds of digital media players.

The processes and methods of the embodiments can be stored as instructions and/or data on non-transitory computer-readable media. The non-transitory computer readable medium may include any suitable computer readable medium, such as a memory, such as RAM, ROM, flash memory, or any other type of memory known in the art. In some embodiments, the non-transitory computer readable medium may include, for example, an electronic storage device, a magnetic storage device, an optical storage device, an electromagnetic storage device, a semiconductor storage device, or any suitable combination of such devices. More specific examples of the non-transitory computer readable medium may include a portable computer diskette, a floppy disk, a hard disk, magnetic disks or tapes, a read-only memory (ROM), a random access memory (RAM), a static random access memory (SRAM), a portable compact disc read-only memory (CD-ROM), an erasable programmable read-only memory (EPROM or Flash memory), electrically erasable programmable read-only memories (EEPROM), a digital versatile disk (DVD and DVD-ROM), a memory stick, other kinds of solid state drives, and any suitable combination of these exemplary media. A non-transitory computer readable medium, as used herein, is not to be construed as being transitory signals, such as radio waves or other freely propagating electromagnetic waves, electromagnetic waves propagating through a waveguide or other transmission media (e.g., light pulses passing through a fiber-optic cable), or electrical signals transmitted through a wire.

Instructions stored on the non-transitory computer readable medium for carrying out operations of the present invention may be instruction-set-architecture (ISA) instructions, assembler instructions, machine instructions, machine dependent instructions, microcode, firmware instructions, configuration data for integrated circuitry, state-setting data, or source code or object code written in any of one or more programming languages, including an object oriented programming language such as Smalltalk, C++, or suitable language, and procedural programming languages, such as the “C” programming language or similar programming languages.

Aspects of the present disclosure are described in association with figures illustrating flowcharts and/or block diagrams of methods, apparatus (systems), and computing products. It will be understood that each block of the flowcharts and/or block diagrams can be implemented by computer readable instructions. The flowcharts and block diagrams in the figures illustrate the architecture, functionality, and operation of possible implementations of various disclosed embodiments. Accordingly, each block in the flowchart or block diagrams may represent a module, segment, or portion of instructions. In some implementations, the functions set forth in the figures and claims may occur in an alternative order than listed and/or illustrated.

The embodiments may utilize any kind of network for communication between separate computing systems. A network can comprise any combination of local area networks (LANs) and/or wide area networks (WANs), using both wired and wireless communication systems. A network may use various known communications technologies and/or protocols. Communication technologies can include, but are not limited to: Ethernet, 802.11, worldwide interoperability for microwave access (WiMAX), mobile broadband (such as CDMA, and LTE), digital subscriber line (DSL), cable internet access, satellite broadband, wireless ISP, fiber optic internet, as well as other wired and wireless technologies. Networking protocols used on a network may include transmission control protocol/Internet protocol (TCP/IP), multiprotocol label switching (MPLS), User Datagram Protocol (UDP), hypertext transport protocol (HTTP), hypertext transport protocol secure (HTTPS) and file transfer protocol (FTP) as well as other protocols.

Data exchanged over a network may be represented using technologies and/or formats including hypertext markup language (HTML), extensible markup language (XML), Atom, JavaScript Object Notation (JSON), YAML, as well as other data exchange formats. In addition, information transferred over a network can be encrypted using conventional encryption technologies such as secure sockets layer (SSL), transport layer security (TLS), and Internet Protocol security (Ipsec).

The computing devices and systems described herein may include one or more processors, a memory, one or more storage devices, and one or more input/output (I/O) devices controllable via one or more I/O interfaces. The various components may be interconnected via at least one system bus, which may enable the transfer of data between the various modules and components of the system.

The processor(s) may be configured to process instructions for execution within the system. The processor(s) may include single-threaded processor(s), multi-threaded processor(s), or both. The processor(s) may be configured to process instructions stored in the memory or on the storage device(s). The processor(s) may include hardware-based processor(s) each including one or more cores. The processor(s) may include general purpose processor(s), special purpose processor(s), or both. The memory may store information within the system. In some implementations, the memory includes one or more computer-readable media. The memory may include any number of volatile memory units, any number of non-volatile memory units, or both volatile and non-volatile memory units. The memory may include read-only memory, random access memory, or both. In some examples, the memory may be employed as active or physical memory by one or more executing software modules.

The storage device(s) may be configured to provide (e.g., persistent) mass storage for the system. In some implementations, the storage device(s) may include one or more computer-readable media. For example, the storage device(s) may include a floppy disk device, a hard disk device, an optical disk device, or a tape device. The storage device(s) may include read-only memory, random access memory, or both. The storage device(s) may include one or more of an internal hard drive, an external hard drive, or a removable drive.

One or both of the memory or the storage device(s) may include one or more computer-readable storage media (CRSM). The CRSM may include one or more of an electronic storage medium, a magnetic storage medium, an optical storage medium, a magneto-optical storage medium, a quantum storage medium, a mechanical computer storage medium, and so forth. The CRSM may provide storage of computer-readable instructions describing data structures, processes, applications, programs, other modules, or other data for the operation of the system. In some implementations, the CRSM may include a data store that provides storage of computer-readable instructions or other information in a non-transitory format. The CRSM may be incorporated into the system or may be external with respect to the system. The CRSM may include read-only memory, random access memory, or both. One or more CRSM suitable for tangibly embodying computer program instructions and data may include any type of non-volatile memory, including but not limited to: semiconductor memory devices, such as EPROM, EEPROM, and flash memory devices; magnetic disks such as internal hard disks and removable disks; magneto-optical disks; and CD-ROM and DVD-ROM disks. In some examples, the processor(s) and the memory may be supplemented by, or incorporated into, one or more application-specific integrated circuits (ASICs).

The system may include one or more I/O devices. The I/O device(s) may include one or more input devices such as a keyboard, a mouse, a pen, a game controller, a touch input device, an audio input device (e.g., a microphone), a gestural input device, a haptic input device, an image or video capture device (e.g., a camera), or other devices. In some examples, the I/O device(s) may also include one or more output devices such as a display, LED(s), an audio output device (e.g., a speaker), a printer, a haptic output device, and so forth. The I/O device(s) may be physically incorporated in one or more computing devices of the system, or may be external with respect to one or more computing devices of the system.

The system may include one or more I/O interfaces to enable components or modules of the system to control, interface with, or otherwise communicate with the I/O device(s). The I/O interface(s) may enable information to be transferred in or out of the system, or between components of the system, through serial communication, parallel communication, or other types of communication. For example, the I/O interface(s) may comply with a version of the RS-232 standard for serial ports, or with a version of the IEEE 1284 standard for parallel ports. As another example, the I/O interface(s) may be configured to provide a connection over Universal Serial Bus (USB) or Ethernet. In some examples, the I/O interface(s) may be configured to provide a serial connection that is compliant with a version of the IEEE 1394 standard. The I/O interface(s) may also include one or more network interfaces that enable communications between computing devices in the system, or between the system and other network-connected computing systems. The network interface(s) may include one or more network interface controllers (NICs) or other types of transceiver devices configured to send and receive communications over one or more networks, such as the network(s), using any network protocol.

Computing devices of the system may communicate with one another, or with other computing devices, using one or more networks. Such networks may include public networks such as the internet, private networks such as an institutional or personal intranet, or any combination of private and public networks. The networks may include any type of wired or wireless network, including but not limited to local area networks (LANs), wide area networks (WANs), wireless WANs (WWANs), wireless LANs (WLANs), mobile communications networks (e.g., 3G, 4G, Edge, etc.), and so forth. In some implementations, the communications between computing devices may be encrypted or otherwise secured. For example, communications may employ one or more public or private cryptographic keys, ciphers, digital certificates, or other credentials supported by a security protocol, such as any version of the Secure Sockets Layer (SSL) or the Transport Layer Security (TLS) protocol.

The system may include any number of computing devices of any type. The computing device(s) may include, but are not limited to: a personal computer, a smartphone, a tablet computer, a wearable computer, an implanted computer, a mobile gaming device, an electronic book reader, an automotive computer, a desktop computer, a laptop computer, a notebook computer, a game console, a home entertainment device, a network computer, a server computer, a mainframe computer, a distributed computing device (e.g., a cloud computing device), a microcomputer, a system on a chip (SoC), a system in a package (SiP), and so forth. Although examples herein may describe computing device(s) as physical device(s), implementations are not so limited. In some examples, a computing device may include one or more of a virtual computing environment, a hypervisor, an emulation, or a virtual machine executing on one or more physical computing devices. In some examples, two or more computing devices may include a cluster, cloud, farm, or other grouping of multiple devices that coordinate operations to provide load balancing, failover support, parallel processing capabilities, shared storage resources, shared networking capabilities, or other aspects.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products, i.e., one or more modules of computer program instructions encoded on a computer readable medium for execution by, or to control the operation of, data processing apparatus. The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a standalone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any appropriate kind of digital computer. Generally, a processor may receive instructions and data from a read only memory or a random access memory or both. Elements of a computer can include a processor for performing instructions and one or more memory devices for storing instructions and data. Generally, a computer may also include, or be operatively coupled to receive data from or transfer data to, or both, one or more mass storage devices for storing data, e.g., magnetic, magneto optical disks, or optical disks. However, a computer need not have such devices. Moreover, a computer may be embedded in another device, e.g., a mobile telephone, a personal digital assistant (PDA), a mobile audio player, a GPS receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in, special purpose logic circuitry.

To provide for interaction with a user, implementations may be realized on a computer having a display device, e.g., a CRT (cathode ray tube) or LCD (liquid crystal display) monitor, for displaying information to the user and a keyboard and a pointing device, e.g., a mouse or a trackball, by which the user may provide input to the computer. Other kinds of devices may be used to provide for interaction with a user as well; for example, feedback provided to the user may be any appropriate form of sensory feedback, e.g., visual feedback, auditory feedback, or tactile feedback; and input from the user may be received in any appropriate form, including acoustic, speech, or tactile input.

Implementations may be realized in a computing system that includes a back end component, e.g., as a data server, or that includes a middleware component, e.g., an application server, or that includes a front end component, e.g., a client computer having a graphical user interface or a web browser through which a user may interact with an implementation, or any appropriate combination of one or more such back end, middleware, or front end components. The components of the system may be interconnected by any appropriate form or medium of digital data communication, e.g., a communication network. Examples of communication networks include a local area network (“LAN”) and a wide area network (“WAN”), e.g., the Internet. The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some examples be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

While various embodiments of the invention have been described, the description is intended to be exemplary, rather than limiting, and it will be apparent to those of ordinary skill in the art that many more embodiments and implementations are possible that are within the scope of the invention. Accordingly, the invention is not to be restricted except in light of the attached claims and their equivalents. Also, various modifications and changes may be made within the scope of the attached claims.

We claim:

1. A man-portable apparatus for identification of compounds, the apparatus comprising:
a housing including a first compartment and a second compartment;
a light source that directs light into the first compartment; and
an optical system including a dichroic beamsplitter and a collection lens, wherein the collection lens is oriented along a first axis, and the dichroic beamsplitter is oriented along a second axis that is at a 45-degree angle relative to the first axis.

2. The apparatus of claim 1, wherein the housing further includes a slit portion disposed between the first compartment and the second compartment, and light reflected from the dichroic beamsplitter in the first compartment passes through the slit portion and into the second compartment.

3. The apparatus of claim 1, wherein the light source includes a laser diode oriented along a third axis that is at a 45-degree angle relative to the second axis.

4. The apparatus of claim 3, further comprising a grating in the second compartment oriented at an acute angle relative to the third axis.

5. The apparatus of claim 1, further comprising a Raleigh filter installed along a sidewall of the second compartment, wherein light reflected from the grating passes through the Raleigh filter.

6. The apparatus of claim 5, further comprising a photoreceptor mounted on an exterior of the sidewall of the second compartment adjacent to the Raleigh filter, and the light exiting the Raleigh filter is captured by the photoreceptor.

7. The apparatus of claim 6, further comprising a computer processor that is configured to share image data captured by the photodetector to a mobile computing device.

8. The apparatus of claim 1, further comprising a connector element protruding from an exterior of the housing, the connector element being configured to connect the apparatus to a data port of a mobile computing device.

9. A method of detecting contaminants in a chemical sample, the method comprising:
sending, from a chemical analysis application (“app”) installed on a mobile computing device, a control signal to a handheld spectrometer apparatus connected to the mobile computing device that causes the spectrometer apparatus to perform a first test cycle involving a first sample;
receiving, at the app and from the spectrometer apparatus, first image data captured by a photoreceptor of the spectrometer apparatus, the first image data including spectral data for the first sample;
passing the first image data to a deep neural network (DNN) model that is trained to detect and quantify, in spectral data, one or more contaminants of a plurality of potential contaminants that include Polyalphaolefin (PAO), sulfur compound(s), synthetic fuel additive(s), hydraulic fluid(s), and microbial compound(s);
determining, via the DNN model and based on the first image data, the first sample includes a first contaminant; and
presenting, via a graphical user interface (GUI) for the app, a notification indicating the first sample includes the first contaminant.

10. The method of claim 9, further comprising receiving, at the app, a first input from a user selecting a first sample profile, wherein the control signal is sent in response to receiving the first input.

11. The method of claim 10, further comprising presenting, via the GUI, a plurality of selectable options, each selectable option identifying a different sample profile, wherein the first input corresponds to a selection of one of the plurality of selectable options.

12. The method of claim 10, wherein determining the first sample includes the first contaminant is based on the user selection of the first sample profile.

13. The method of claim 9, further comprising receiving, at the app, a first input from a user selecting a first sample profile, wherein selection of a sample profile is used by the app to limit detection to a subset of the plurality of potential contaminants.

14. The method of claim 9, further comprising presenting, via the GUI, a spectral graph plotting an intensity of scattered light versus a frequency of light as characterized by the first image data.

15. A system for detecting contaminants in a chemical sample, the system comprising a processor and machine-readable media including instructions which, when executed by the processor, cause the processor to:
send, from a chemical analysis application (“app”) installed on a mobile computing device, a control signal to a handheld spectrometer apparatus connected to the mobile computing device that causes the spectrometer apparatus to perform a first test cycle involving a first sample;
receive, at the app and from the spectrometer apparatus, first image data captured by a photoreceptor of the spectrometer apparatus, the first image data including spectral data for the first sample;
pass the first image data to a deep neural network (DNN) model that is trained to detect and quantify, in spectral data, one or more contaminants of a plurality of potential contaminants that include Polyalphaolefin (PAO), sulfur compound(s), synthetic fuel additive(s), hydraulic fluid(s), and microbial compound(s);
determine, via the DNN model and based on the first image data, the first sample includes a first contaminant; and
present, via a graphical user interface (GUI) for the app, a notification indicating the first sample includes the first contaminant.

16. The system of claim 15, wherein the instructions further cause the processor to receive, at the app, a first input from a user selecting a first sample profile, wherein the control signal is sent in response to receiving the first input.

17. The system of claim 16, wherein the instructions further cause the processor to present, via the GUI, a plurality of selectable options, each selectable option identifying a different sample profile, wherein the first input corresponds to a selection of one of the plurality of selectable options.

18. The system of claim 16, wherein determining the first sample includes the first contaminant is based on the user selection of the first sample profile.

19. The system of claim 15, wherein the instructions further cause the processor to receive, at the app, a first input from a user selecting a first sample profile, wherein selection of a sample profile is used by the app to limit detection to a subset of the plurality of potential contaminants.

20. The system of claim 15, wherein the instructions further cause the processor to present, via the GUI, a spectral graph plotting an intensity of scattered light versus a frequency of light as characterized by the first image data.
